(19) United States
(12) Patent Application Publication
(10) Pub. No.: US 2026/0269283 A1
(43) Pub. Date: Sep. 10, 2026

(54) BALANCE-OF-PLANT FOR ELECTRO-SYNTHETIC OR ELECTRO-ENERGY LIQUID-GAS CELLS OR CELL STACKS

(71) Applicant: Hysata Pty Ltd, Port Kembla, New South Wales (AU)

(72) Inventors: Adam WARBURTON, Port Kembla, New South Wales (AU); Gerhard Frederick SWIEGERS, North Wollongong, New South Wales (AU); David John COX, Northbridge, New South Wales (AU); Paul Soo-Hock KHOO, Castle Hill, New South Wales (AU); Nicholas RICE, Port Kembla, New South Wales (AU); Dominic TIER, Port Kembla, New South Wales (AU)

(21) Appl. No.: 19/164,365

(22) PCT Filed: Feb. 16, 2024
(86) PCT No.: PCT/AU2024/050104

§ 371 Date: Sep. 11, 2025

(30) Foreign Application Priority Data
Mar. 13, 2023 (AU) 2023900672

(51) Int. Cl. H01M 8/04089; C25B 9/05; C25B 15/08; H01M 8/04082; H01M 8/04186; H01M 8/04746; H01M 8/08; H01M 8/2455; H01M 8/2457

(52) U.S. Cl. CPC H01M 8/04104; C25B 9/05; C25B 15/083; H01M 8/04186; H01M 8/04201; H01M 8/04783; H01M 8/08; H01M 8/2455; H01M 8/2457

(57) ABSTRACT

Gas pressure equalisation systems, and method of operation, for an electro-synthetic or electro-energy liquid-gas cell or cell stack. The gas pressure equalisation systems includes a first pressure equalisation tank for partially containing a first liquid and a first gas. The first gas is positioned above a liquid first level. A first gas conduit is provided for the transfer of the first gas between the cell or cell stack and the first pressure equalisation tank. In another aspect, a second pressure equalisation tank may be additionally provided for partially containing a second liquid and a second gas positioned above a liquid second level. A second gas conduit is then provided for the transfer of the second gas between the cell or cell stack and the second pressure equalisation tank.

### TECHNICAL FIELD

The invention broadly relates to electro-synthetic or electro-energy liquid-gas cells, cell stacks, and/or systems or methods for use with or operation of electro-synthetic or electro-energy liquid-gas cells or cell stacks. Example embodiments relate to the engineering systems, apparatus, arrangements or methods, referred to as the ‘balance-of-plant’, that support and manage electro-synthetic or electro-energy liquid-gas cells or cell stacks.

### BACKGROUND

An electro-energy cell is an electrochemical cell that generates electrical power over sustained periods of time, for use outside of the cell. Electro-energy cells are distinguished from other galvanic cells in that they require a constant external supply of reactants. The products of the electrochemical reaction must also be constantly removed from such cells. Unlike a battery, an electro-energy cell does not store chemical or electrical energy within the electro-energy cell.

Examples of electro-energy cells include but are not limited to Polymer Electrolyte Membrane (PEM) hydrogen-oxygen fuel cells, hydrogen-oxygen alkaline fuel cells, ammonia fuel cells, and the like.

An electro-synthetic cell is, similarly, an electrochemical cell that manufactures one or more chemical materials over sustained periods of time, for use outside of the cell. The chemical materials may be in the form of a gas, liquid, or solid. Like an electro-energy cell, an electro-synthetic cell also requires a constant supply of reactants and a constant removal of products. Electro-synthetic cells may generally further require a constant input of electrical energy.

Examples of electro-synthetic cells include but are not limited to electrochemical cells for manufacturing hydrogen (‘water electrolyzers’), chlorine (‘chlor-alkali’ cells), hydrogen peroxide, formic acid, ammonia, and a host of other industrial products.

Many electro-synthetic and electro-energy cells are also ‘liquid-gas’ cells, which are cells wherein at least one reactant or product is in the liquid-phase, and at least one reactant or product is in the gas-phase. Examples of electro-synthetic cells that are also liquid-gas cells include but are not limited to water electrolyzers that produce hydrogen gas and oxygen gas from liquid water, and chlor-alkali cells that produce chlorine gas from liquid brine, when electrical energy is applied to the cell. Examples of electro-energy cells that are also liquid-gas cells include but are not limited to hydrogen-oxygen fuel cells, in which hydrogen and oxygen gas are converted into liquid water with accompanying production of electrical energy.

Another feature of electro-synthetic or electro-energy cells is the large quantities of reactants and products that are typically involved in their operation. Such cells typically need to be constantly fed with substantial amounts of reactants, whilst significant volumes of products must be, simultaneously, constantly removed.

Because large quantities of electrical energy may also be involved in operating electro-synthetic or electro-energy cells, a key challenge in their development is to make them as energy efficient as possible during operation. This may be achieved, in part, by minimizing their electrical impedance. Impedance is the opposition that a cell circuit presents to an electrical current. One well-known method of minimizing impedance is to employ a cell architecture in which the anode and cathode electrodes of the cell are placed facing each other, as close as possible to each other, without touching (which would create a short circuit). The gap between the two electrodes should then, ideally, also be occupied by an electrolyte having the highest possible conductivity. In general, liquid electrolytes, as a class, have the highest conductivities of any electrolyte. An inter-electrode membrane/ionomer/diaphragm (also called a ‘separator’) may typically also be placed between the electrodes to prevent the electrodes from touching and to maintain the reactants consumed by and/or the products generated by each electrode separate from each other. The separator may also impede gas produced or consumed on one side of the separator from migrating through the separator, to the other side of the separator, where it may mix with another gas produced or consumed by the other electrode. Such migration is termed ‘gas crossover’ and it may constitute a safety hazard, for example where the one gas is hydrogen and the other gas is oxygen. A mixture of more than ~4% oxygen in a body of hydrogen, or of more than ~4% hydrogen in a body of oxygen, may, at 80° C., constitute an explosive mixture that would be a safety hazard.

Another feature of industrial electro-synthetic and electro-energy liquid-gas cells is that they may often be ‘stacked’ in electrical series with other cells to thereby create a ‘cell stack’. This is commonly achieved within a so-called ‘filter-press’ arrangement (also known as a ‘plate-and-frame’ ‘filter press’ arrangement). In such a configuration, individual cells having a substantially flat profile may be stacked between two endplates that are compressed toward each other. This causes the intervening, stacked cells to: (i) make and maintain electrical contact with each other (in electrical series), (ii) be securely held within the stack, to thereby: (iii) form a single electro-synthetic or electro-energy device, namely, a filter-press-type cell stack. The resulting cell stack is then, effectively, a single device that has the product output from all of the incorporated cells, as well as their combined reactant consumption. In this way, large quantities of reactants and products may be accumulated into single, external, product and/or reactant streams, that are more easily managed than multiple smaller streams.

The engineering system, apparatus or arrangement that supports, manages, and/or controls such single, external, reactant and products streams, as well as the electrical current through the cell or cell stack, is known as or may be referred to as the ‘balance-of-plant’, or ‘balance-of-system’.

The balance-of-plant of an electro-synthetic or electro-energy liquid-gas cell or cell stack may comprise a significant process engineering apparatus that consumes considerable energy, thereby affecting the overall energy efficiency of the overall system. Moreover, the balance-of-plant may be more costly than the cells and cell stacks themselves, making it an economically important component of the overall electro-synthetic or electro-energy system. The balance-of-plant may, additionally, be critically important to ensuring that the cells/cell stacks operate reliably and safely and achieve their specified outputs.

Accordingly, there is a need to optimise or improve such balance-of-plants, and/or methods for operation of electro-synthetic or electro-energy liquid-gas cells or cell stacks, in terms of, for example, the components employed and their engineering architecture, as well as their simplicity, efficiency, cost, reliability, and/or safety, amongst others.

In many electro-energy liquid-gas cells, a three-way liquid-gas-solid boundary may be present in or on the electrodes during operation. This allows for gaseous reactants to be fed directly into the cell, where they are converted at the three-way liquid-gas-solid interface to, for example, liquid products that cross the boundary and enter the liquid phase. That is, in many electro-energy liquid-gas cells, the liquid and gas phases of the materials present in the cell may be relatively well and clearly separated.

By contrast, in many electro-synthetic liquid-gas cells, gases are present in a form that is intermingled with the liquid reactants. For example, gases may be produced as bubbles of gas within a liquid phase reactant, for example in the form of a ‘froth’ or ‘foam’-type mixture of intermingled gas phase and liquid phase substances. This necessitates removal of the intermingled two-phase mixture from the cell and separation of the two phases (i.e. liquid and gas) elsewhere. Such separation is typically carried out within separation tanks or engineering structures that are specifically designed to allow such two-phase, liquid-gas mixtures to fractionate into discrete and separate gas and liquid phases. Discrete and separate gas or liquid phases may also be termed ‘bulk’ gas or liquid phases, where the term ‘bulk’ indicates that the substance in question is substantially in a single phase, for example in the gas phase (‘bulk gas’) or in the liquid phase (‘bulk liquid’). The balance-of-plant normally plays a key role in such separation processes.

However, in recent years, electro-synthetic liquid-gas cells have been developed that maintain a clear separation of the liquid and gas phases present. For example, electro-synthetic gas-liquid systems have been developed that directly convert liquid-phase reactants into gas phase products in the cell. That is, the products are generated in the form of ‘bulk gases’ that are substantially separate from the liquid phase substances in the cell, without the need for separation tanks and the like. A three-way liquid-gas-solid boundary may be present at the electrodes in such cells in the same way that such boundaries may exist in many electro-energy liquid gas cells. Examples of such systems are described in the scientific publication “The prospects of developing a highly energy-efficient water electrolyser by eliminating or mitigating bubble effects”, Swiegers et al., published 10 Feb. 2021 in Sustainable Energy and Fuels, 2021, Vol. 5, pp. 1280-1310 (DOI: 10.1039/d0se01886d). Another example is described in the later scientific publication “A high-performance capillary-fed electrolysis cell promises more cost-competitive renewable hydrogen”, Hodges et al., published 15 Mar. 2022 in Nature Communications, 2022, Vol. 13, page 1304 (DOI: 10.1038/s41467-022-28953-x).

Such electro-synthetic liquid-gas systems may require a different balance-of-plant than conventional systems, with the associated potential for higher energy efficiency, lower cost, and/or improved reliability and safety. In such cases, where the engineering arrangement of the balance-of-plant has not yet been established or is immature, there is a need for a new and/or improved balance-of-plant.

Another recent development has involved removably combining individual electro-synthetic liquid-gas cell stacks into modular ‘arrays’ that provide the reactants, remove the products, and/or help create the electrical connections for each of the cell stacks. International Patent Publication No. WO2022195021 A2 for a “Modular Electrochemical System” published 22 Sep. 2022 describes such arrays of water electrolysis cell stacks. In such cases also, where the overall process engineering arrangement of the balance-of-plant has not yet been established or is still immature, there is a need for a new and/or improved balance-of-plant.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

### SUMMARY

This Summary is provided to introduce a selection of concepts in a simplified form that are further described below in the Detailed Description. This Summary is not intended to identify all of the key features or essential features of the claimed subject matter, nor is it intended to limit the scope of the claimed subject matter.

In various example aspects, embodiments relate to balance-of-plants, and methods of operation, for electro-synthetic or electro-energy liquid-gas cells or cell stacks that provide new and/or improved operation in respect of:
(1) Gas management, including:
   i. Gas pressure management;
   ii. Gas pressure equalisation;
   iii. Gas pressure control; and/or
   iv. Gas circulation or re-circulation, including during ‘stand-by’;
(2) Liquid management;
(3) Stack cooling management;
(4) Cell condition monitoring and management;
(5) Cell stack arrangement and management; and/or
(6) Load following and/or grid balancing.

Preferably but not exclusively, all of the following embodiments relate to balance-of-plants, or methods of operation, that are automated in their operation, for example by being computer-controlled by one or more programmable logic controllers (PLCs) that may utilise sensors, valves, pumps, and other process engineering components to operate the balance-of-plant without need for human intervention.

In one example aspect, there is provided a gas pressure equalisation system or method for an electro-synthetic or electro-energy liquid-gas cell or cell stack, wherein the cell or cell stack is configured to keep separate a first gas in bulk form within the cell or cell stack. In a further example aspect, there is provided a gas pressure equalisation system or method for an electro-synthetic or electro-energy liquid-gas cell or cell stack, wherein the cell or cell stack is configured to keep separate a first gas in bulk form from a second gas in bulk form within the cell or cell stack.

In another example aspect, there is provided a gas pressure control system or method for an electro-synthetic or electro-energy liquid-gas cell or cell stack, wherein the cell or cell stack is configured to keep separate a first gas in bulk form within the cell or cell stack. In a further example aspect, there is provided a gas pressure control system or method for an electro-synthetic or electro-energy liquid-gas cell or cell stack, wherein the cell or cell stack is configured to keep separate a first gas in bulk form from a second gas in bulk form within the cell or cell stack.

In another example aspect, there is provided a gas circulation or re-circulation system or method for an electro-synthetic or electro-energy liquid-gas cell or cell stack, wherein the cell or cell stack is configured to keep separate a first gas in bulk form within the cell or cell stack. In a further example aspect, there is provided a gas circulation or re-circulation system or method for an electro-synthetic or electro-energy liquid-gas cell or cell stack, wherein the cell or cell stack is configured to keep separate a first gas in bulk form from a second gas in bulk form within the cell or cell stack.

In another example aspect, there is provided a liquid management system or method for an electro-synthetic or electro-energy liquid-gas cell or cell stack, wherein the cell or cell stack is configured to keep separate a first gas in bulk form within the cell or cell stack. In a further example aspect, there is provided a liquid management system or method for an electro-synthetic or electro-energy liquid-gas cell or cell stack, wherein the cell or cell stack is configured to keep separate a first gas in bulk form from a second gas in bulk form within the cell or cell stack.

In another example aspect, there is provided a cooling management system or method for an electro-synthetic or electro-energy liquid-gas cell or cell stack, wherein the cell or cell stack is configured to keep separate a first gas in bulk form within the cell or cell stack. In a further example aspect, there is provided a cooling management system or method for an electro-synthetic or electro-energy liquid-gas cell or cell stack, wherein the cell or cell stack is configured to keep separate a first gas in bulk form from a second gas in bulk form within the cell or cell stack.

In another example aspect, there is provided a monitoring or management system or method for an electro-synthetic or electro-energy liquid-gas cell or cell stack, the monitoring or management system employing a computer chip, or one or more computer chips, within the cell or within one or more individual cells in the cell stack.

In another example aspect, there is provided an electro-synthetic or electro-energy liquid-gas cell stack arrangement, wherein the cell stack is configured to keep separate a first gas in bulk form within the cell stack. In a further example aspect, there is provided an electro-synthetic or electro-energy liquid-gas cell stack arrangement, wherein the cell stack is configured to keep separate a first gas in bulk form from a second gas in bulk form within the cell stack.

In another example aspect, there is provided a load following or grid balancing system or method for an electro-synthetic or electro-energy liquid-gas cell or cell stack, wherein the cell or cell stack is configured to keep separate a first gas in bulk form within the cell or cell stack. In a further example aspect, there is provided a load following or grid balancing system or method for an electro-synthetic or electro-energy liquid-gas cell or cell stack, wherein the cell or cell stack is configured to keep separate a first gas in bulk form from a second gas in bulk form within the cell or cell stack.

In various example aspects, embodiments relate to balance-of-plants, or methods of operation, for electro-synthetic or electro-energy liquid-gas cells, cell stacks, and/or systems, with new and/or improved gas pressure management.

In one example aspect, there is provided a balance-of-plant for electro-synthetic or electro-energy liquid-gas cells or cell stacks that can produce or consume gases having a high absolute pressure, despite the external walls of the cells or cell stacks being capable of only withstanding a small internal-to-external pressure differential.

In an example aspect, there is provided an electro-synthetic or electro-energy liquid-gas cell or cell stack that is incorporated within a pressure vessel, wherein the cell or cell stack is surrounded by a liquid-phase or gas-phase fluid that exerts a pressure upon the external walls of the cell or cell stack. Preferably, the liquid-phase or gas phase fluid is pressurised to, and/or has a pressure that is comparable to the pressure of the gases and/or liquids inside the cell or cell stack. Preferably, during operation, the liquid-phase or gas-phase fluid is always maintained at a pressure that is comparable to, close to, or slightly above the pressure of the gases and/or liquids within the cell or cell stack. Preferably but not exclusively, the pressure differential between the inside of the cell or cell stack and the surrounding liquid-phase or gas-phase fluid outside the cell or cell stack, is low in absolute terms and/or low relative to the absolute pressure of the gases and/or liquids within the cell or cell stack. The pressure vessel can surround the cell or cell stack.

Preferably, the cell or cell stack is sealed to exclude the liquid-phase or gas-phase fluid so that the liquid-phase or gas-phase fluid does not penetrate the cell or cell stack, nor come into direct contact with the electrodes within the cell or cell stack. Preferably, but not exclusively, the liquid-phase or gas-phase fluid is passed continuously through the space between the cell or cell stack and the walls of the pressure vessel. Optionally, the liquid-phase or gas-phase fluid is cooled or heated prior to passing through the space between the cell or cell stack and the walls of the pressure vessel, to thereby manage the temperature of the cell or cell stack. Preferably, but not exclusively, the liquid-phase or gas-phase fluid is not significantly electrically conductive. Preferably, but not exclusively, the liquid-phase or gas-phase fluid is not significantly chemically corrosive.

In another example aspect, wherein the fluid surrounding the cell stack is a liquid-phase fluid (an ‘annular liquid’), the liquid-phase fluid is pressurised using a pump prior to being passed through the pressure vessel. In this example aspect, the pump may be controlled by a programmable logic controller (PLC) that may utilise pressure sensors to monitor the pressure in the liquid-phase fluid and inside the cell or cell stack. The PLC may, preferably, turn the pump on and off to thereby ensure the liquid-phase fluid is pressurised to, and/or has a pressure that is comparable to the pressure of the gases and/or liquids within the cell or cell stack.

In a further example aspect, wherein the fluid surrounding the cell stack is a liquid-phase fluid, the liquid-phase fluid within the pressure vessel is pressurised by a gas within an attached expansion vessel. Optionally, that gas may be a gas produced by or used by the cell or cell stack. In so doing, the liquid-phase fluid is pressurised to, and/or has a pressure that will necessarily be comparable to the pressure of the gases and/or liquids within the cell or cell stack (provided only that, if there are more than one gas within the cell stack, they are maintained at near to equal pressures).

In one non-limiting example, wherein the fluid surrounding the cell stack is a liquid-phase fluid, the liquid-phase fluid is water, for example, de-ionized water. Preferably but not exclusively, the water entering the pressure vessel is at ambient temperature, for example at room temperature, and is heated by the cell stack in the pressure vessel, which may be at a higher operating temperature, for example, at 80° C. Preferably, in so doing, the water cools the cell stack. Preferably, in passing through and out of the pressure vessel the water removes heat from the cell stack. Preferably, the removed heat is carried away elsewhere to be released when the water cools back down to ambient temperature. Preferably, the flow of water through the pressure vessel is regulated to maintain the temperature of the cell stack at or about a target operating temperature. Preferably, the cell stack has a low cooling requirement, so that this cooling mechanism is sufficient to manage and maintain the temperature of the cell stack.

Preferably but not exclusively, in the case of an electro-synthetic liquid-gas cell or cell stack wherein the liquid-phase fluid surrounding the cell stack is water, the water is make-up water that is later, separately added to the system to replenish water that has been consumed during operation. Preferably but not exclusively, in the case of an electro-energy cell or cell stack, the water is water that is produced by the cell or cell stack during operation and that has earlier been separately removed from the cell or cell stack.

In a further example aspect, wherein the fluid surrounding the cell or cell stack in the pressure vessel is a gas-phase fluid (an ‘annular gas’), the gas-phase fluid is, preferably but not exclusively, an inert gas such as nitrogen or argon in a suitably pure and dry form. Preferably but not exclusively, the annular gas is continually, continuously, or periodically passed through, preferably slowly passed through, the space between the cell or cell stack and the walls of the pressure vessel. Preferably but not exclusively, the annular gas exiting the pressure vessel is monitored to detect the presence of one or more contaminant gases that may have escaped from the cell or cell stack into the annular gas, thereby alerting the safety system of the balance of plant to the presence of a gas leak from the inside to the outside of the cell or cell stack. That is, optionally, the annular gas exits the pressure vessel and the exiting annular gas is monitored to detect a presence of one or more contaminant gases. Preferably but not exclusively, where a product of the electrochemical reaction is a gas, that product gas is monitored in the balance of plant for contamination by the above inert annular gas to thereby alert the safety system to a gas leak from the outside to the inside of the cell or cell stack. Preferably but not exclusively, a condensate trap or similar liquid capture device is affixed to the bottom of the pressure vessel or to the outlet of the annular gas from the pressure vessel, to thereby detect and capture liquid that may have leaked out of the cell or cell stack into the annular gas. In this way, the safety system may be alerted to the presence of a leak of liquid from the inside to the outside of the cell or stack into the annular gas. Moreover, such a leak may, thereby, also be restricted and contained within the condensate trap or liquid capture device. Optionally, the annular gas is a reactant or product gas of the electrochemical reaction.

Preferably, the cell or cell stack is capable of withstanding an internal-to-external pressure differential over its walls that is less than 0.1 bar, less than 0.15 bar, less than 0.2 bar, less than 0.3 bar, less than 0.4 bar, less than 0.5 bar, less than 0.75 bar, less than 1 bar, less than 1.5 bar, less than 2 bar, less than 3 bar, less than 4 bar, less than 5 bar, less than 7.5 bar, less than 10 bar, or less than 20 bar.

Preferably, the difference in pressure between the pressure of the liquid-phase fluid and the pressure of the gases and/or liquids within the cell or cell stack during operation is less than 0.001 bar, less than 0.002 bar, less than 0.003 bar, less than 0.005 bar, less than 0.010 bar, less than 0.020 bar, less than 0.040 bar, less than 0.050 bar, less than 0.075 bar, less than 0.100 bar, less than 0.125 bar, less than 0.150 bar, less than 0.200 bar, less than 0.300 bar, less than 0.400 bar, less than 0.500 bar, less than 0.750 bar, less than 1 bar, less than 2 bar, less than 5 bar, or less than 10 bar.

In various example aspects, embodiments relate to balance-of-plants, or methods of operation, for electro-synthetic or electro-energy liquid-gas cells or cell stacks with new and/or improved means of equalising or substantially equalising two or more gas pressures within the cell or cell stack.

In one example aspect, there is provided a pressure equalisation system for a balance-of-plant of an electro-synthetic or electro-energy liquid-gas cell or a cell stack that contains within it, two or more distinct and separate gases, each in ‘bulk’ form and each occupying its own separate and distinct volume within the cell or cell stack.

In an example of another embodiment, the balance-of-plant includes a single pressure equalisation tank wherein the tank is partially filled with a liquid. Preferably, the single pressure equalisation tank has a headspace above the liquid, which is occupied by one of the gases present, in bulk form, within the cell or cell stack. Preferably, the gas in the headspace of the single pressure equalisation tank is connected, via a gas conduit, to the volume containing its corresponding bulk gas within the cells or cell stack. Preferably but not exclusively, the gas may pass through the headspace of the single pressure equalisation tank on its way to or from the volume within the cell or cell stack that contains its corresponding bulk gas. Preferably, the pressure of the gas is managed using a backpressure valve, where the headspace of the single pressure equalisation tank and the gas conduit lie between the backpressure valve and the volume of the corresponding bulk gas within the cell or cell stack. Preferably, the pressures of each of the other bulk gases within the cell or cell stack are individually managed by additional backpressure valves that are located on gas conduits through which each of these gases separately pass into or out of the cell or cell stack. Preferably, the pressures of the two or more separate and distinct gases, each in bulk form, within the cell or cell stack are equalised or substantially equalised by adjusting the backpressure valves of each relative to the others. Preferably, the headspace of the single pressure equalisation tank provides a buffer volume that makes it significantly easier to equalise or substantially equalise the gas pressures of the two or more bulk gases within the cell or cell stack. Preferably, more easy, more ready, more reliable, more stable (over time), and/or more rapid equalisation of the pressures of the two or more bulk gases within the cell or cell stack is achieved.

In another example embodiment, the balance-of-plant includes two or more pressure equalisation tanks—wherein each tank is partially filled with a liquid, which may be different liquids in each tank or may be the same liquid in each tank. Preferably, the headspace above the liquid in each pressure equalisation tank is occupied by a different gas selected from those gases present, in bulk form, within the cell or cell stack. Preferably, the gas in the headspace of each pressure equalisation tank is connected, via a gas conduit, to the volume containing its corresponding bulk gas within the cells or cell stack. Preferably but not exclusively, each gas may pass through the headspace of its corresponding pressure equalisation tank on its way to or from its volume within the cell or cell stack. Preferably, the pressure of each gas is managed using a backpressure valve, where the headspace of the each pressure equalisation tank and its gas conduit lie between the backpressure valve and the volume of the corresponding bulk gas within the cell or cell stack. Preferably, the pressures of the separate and distinct gases, each in bulk form, within the cell or cell stack are equalised or substantially equalised by adjusting the backpressure valves of each relative to the others. Preferably, the headspace of each pressure equalisation tank provides a buffer volume that makes it significantly easier to equalise or substantially equalise the gas pressures of the bulk gases present within the cell or cell stack. Preferably, more easy, more ready, more reliable, more stable (over time), and/or more rapid equalisation of the pressures of the bulk gases within the cell or cell stack is achieved.

In another example embodiment, the balance-of-plant includes two or more pressure equalisation tanks—wherein each tank is partially filled with a liquid, which may be different liquids in each tank or may be the same liquid in each tank. Preferably, the headspace above the liquid in each pressure equalisation tank is occupied by a different gas selected from those gases present, in bulk form, within the cell or cell stack. Preferably, the gas in the headspace of each pressure equalisation tank is connected, via a gas conduit, to the volume containing its corresponding bulk gas within the cells or cell stack. Preferably but not exclusively, each corresponding bulk gas may pass through the headspace of each pressure equalisation tank on its way to or from the corresponding volume of bulk gas in the cell or cell stack. Preferably, the pressure equalisation tanks are connected to each other via a liquid-filled ‘connecting pipe’ that allows the liquid in each pressure equalisation tank to readily and rapidly move to the other tank/s without hindrance. Preferably, liquid spontaneously moves between the pressure equalisation tanks, via the connecting pipe, to balance out and equalise or substantially equalise the pressures of each headspace gas. Preferably, each pressure equalisation tank has a well-defined and unambiguous liquid level, at which the liquid interfaces with its gas in the headspace of that tank. Preferably, the liquid in the pressure equalisation tanks has a well-defined and essentially unchanging density and compressibility during operation, e.g. the liquid has a substantially constant density during operation.

In all of the above embodiments of gas pressure equalisation systems:
Preferably but not exclusively, the pressure equalisation tanks are ‘infra’-tanks; that is, they lie below (i.e. are positioned below, underneath or under) the level of the cells or cell stacks, relative to gravity. Preferably, the pressure equalisation tanks are located or positioned to be wholly below, underneath or under the cells or cell stacks, relative to gravity.
Preferably, each of the bulk gases is only sparingly (i.e. moderately or partially) soluble in the liquid in the pressure equalisation tanks.
Preferably, the liquid in each pressure equalisation tank has a large volume relative to the volume of its gas in the cells or cell stack and the remainder of the balance-of-plant, to thereby provide for rapid equilibration of, even, large gas pressure differentials.
If the liquids in the pressure equalisation tanks are also liquid electrolytes that are circulated into the cell or cell stack, then those liquid electrolytes will, preferably, have the same or substantially the same pressure as each of the bulk gases. That is, preferably but not exclusively, the pressure equalisation systems equalise or substantially equalise the pressures of multiple separate and distinct bulk gases, as well as the pressures of one or more liquid electrolytes within the cell or cell stack.

In one example aspect, there is provided a gas pressure equalisation system for an electro-synthetic or electro-energy liquid-gas cell or cell stack, wherein the cell or cell stack is configured to keep separate a first gas in bulk form within the cell or cell stack. The gas pressure equalisation system comprises a first pressure equalisation tank for at least partially containing a first liquid having a liquid first level and for partially containing the first gas in bulk form. The first gas is positioned above the liquid first level. A first gas conduit is provided for transfer of the first gas in bulk form between the cell or cell stack and the first pressure equalisation tank.

In another example aspect, there is provided a gas pressure equalisation system for an electro-synthetic or electro-energy liquid-gas cell or cell stack, wherein the cell or cell stack is configured to keep separate a first gas in bulk form from a second gas in bulk form within the cell or cell stack. The gas pressure equalisation system comprises a first pressure equalisation tank for at least partially containing a first liquid having a liquid first level and for partially containing the first gas in bulk form. The first gas is positioned above the liquid first level. A first gas conduit is provided for transfer of the first gas in bulk form between the cell or cell stack and the first pressure equalisation tank.

In another example aspect, the cell or cell stack is configured to keep separate a first gas in bulk form from a second gas in bulk form within the cell or cell stack, and a second pressure equalisation tank is additionally provided for at least partially containing a second liquid having a liquid second level and a second gas, the second gas positioned above the liquid second level, wherein the second gas comprises a bulk gas also present within the cell or cell stack. A second gas conduit is provided for the transfer of the second gas in bulk form between the cell or cell stack and the second pressure equalisation tank.

In another example aspect, a connecting pipe is provided for the transfer of the liquid between the first pressure equalisation tank and the second pressure equalisation tank. The first pressure equalisation tank and the second pressure equalisation tank are positioned below the cell or cell stack, preferably wholly below the cell or cell stack, relative to gravity.

In another example aspect, there is provided a method of operating a gas pressure equalisation system for an electro-synthetic or electro-energy liquid-gas cell or cell stack. The method comprising operating the cell or cell stack to produce or consume a first gas, wherein the cell or cell stack is configured to keep separate the first gas in bulk form within the cell or cell stack. The method also comprising the first gas flowing, in bulk form, into or out of a first pressure equalisation tank via a first gas conduit. The first pressure equalisation tank at least partially containing a first liquid having a liquid first level, and the first gas positioned above the liquid first level.

In another example aspect, there is provided a method of operating a gas pressure equalisation system for an electro-synthetic or electro-energy liquid-gas cell or cell stack. The method comprising operating the cell or cell stack to produce or consume a first gas and a second gas, wherein the cell or cell stack is configured to keep separate the first gas in bulk form from the second gas in bulk form within the cell or cell stack. The method also comprising the first gas flowing, in bulk form, into or out of a first pressure equalisation tank via a first gas conduit. The first pressure equalisation tank at least partially containing a first liquid having a liquid first level, and the first gas positioned above the liquid first level.

In another example aspect, the first gas flows, in bulk form, into or out of a first pressure equalisation tank via a first gas conduit connected to the cell or cell stack. The first pressure equalisation tank at least partially containing a first liquid having a liquid first level, the first gas positioned above the liquid first level. The volume of the headspace of the first pressure equalisation tank providing a buffer volume to facilitate equalisation or substantial equalisation of the pressures of the first gas within the cell or cell stack. Preferably, the first liquid in the first pressure equalisation tank has a large volume relative to the volume of its bulk gas (the first gas) in the cells or cell stack and the remainder of the balance-of-plant, to thereby provide for rapid equilibration of, even, large gas pressure differentials.

In another example aspect, the method comprising operating the cell or cell stack to produce or consume the first gas and to produce or consume a second gas, wherein the cell or cell stack is configured to keep separate the first gas in bulk form from the second gas in bulk form within the cell or cell stack. There is additionally provided the second gas flowing, in bulk form, into or out of a second pressure equalisation tank via a second gas conduit connected to the cell or cell stack. The second pressure equalisation tank at least partially containing a second liquid having a liquid second level, the second gas positioned above the liquid second level. The second gas flowing, in bulk form, into or out of the second pressure equalisation tank via a second gas conduit connected to the cell or cell stack. The volume of the headspace of the second pressure equalisation tank providing a buffer volume to facilitate equalisation or substantial equalisation of the pressures of the first and second gas within the cell or cell stack. Preferably, the second liquid in the second pressure equalisation tank has a large volume relative to the volume of its bulk gas in the cells or cell stack and the remainder of the balance-of-plant, to thereby provide for rapid equilibration of, even, large gas pressure differentials. Preferably, the first liquid in the first pressure equalisation tank is the same liquid as the second liquid in the second pressure equalisation tank. Optionally, the first liquid in the first pressure equalisation tank may be a different liquid to the second liquid in the second pressure equalisation tank.

In another example aspect, there is additionally provided a liquid-filled connecting pipe between the pressure equalisation tanks. The first liquid/second liquid flowing between the first pressure equalisation tank and the second pressure equalisation tank via a connecting pipe when a pressure of the first gas in the first pressure equalisation tank is different to a pressure of the second gas in the second pressure equalisation tank. Preferably, the connecting pipe is positioned below, preferably wholly below, the liquid first level and the liquid second level during operation. Preferably, the connecting pipe allows for transfer of the first liquid or the second liquid between the first pressure equalisation tank and the second pressure equalisation tank. Preferably, pressure differentials between the distinct gases in the cell or cell stack are compensated by spontaneous flows of the liquid between the two pressure equalisation tanks until the gas pressures are equal. Preferably, the well-defined and unambiguous level of the first liquid/second liquid in each pressure equalisation tank provides for precise and rapid equilibration of the gas pressures. Preferably, the well-defined and essentially unchanging density and compressibility of the first liquid/second liquid in the two pressure equalisation tanks provides for precise and rapid equilibration of the gas pressures. Preferably, the surface area of the first liquid/second liquid, at its interface with its corresponding gas in each pressure equalisation tank, is large relative to the volume of its corresponding gas in the cells or cell stack and the remainder of the balance-of-plant. Such an arrangement is desirable as it provides for minimal perturbation of the system, with associated rapidity of action, during equilibration of the gas pressures.

In a further example aspect related to the utilisation of two pressure equalisation tanks with a liquid-filled connecting pipe between them, the pressures of two or more gases in an electro-synthetic or electro-energy liquid-gas cell or cell stack are, preferably, maintained equal by maintaining the levels of the liquid in their respective pressure equalisation tanks at equal heights.

In a further example aspect related to the utilisation of two pressure equalisation tanks, the pressures of the two or more gases in an electro-synthetic or electro-energy liquid-gas cell or cell stack are, preferably, maintained at a fixed differential by maintaining a fixed height differential in the levels of the liquid in their pressure equalisation tanks.

In various example aspects, embodiments relate to balance-of-plants, or methods of operation, for electro-synthetic or electro-energy liquid-gas cells or cell stacks with new and/or improved gas pressure control.

In one example aspect, there is provided a gas pressure control system for the balance-of-plant of an electro-synthetic or electro-energy liquid-gas cell or cell stack, which employs two valves located sequentially (in series) in a gas pipe to manage the gas pressure in an attached cell or cell stack. Preferably but not exclusively, the valves are back-pressure control valves. Preferably, one valve is designated a ‘coarse’ control valve and is used to make relatively larger adjustments in gas pressure. Preferably, the other valve is designated a ‘fine’ control valve and is used to make relatively smaller adjustments in gas pressure. Preferably but not exclusively, the fine control valve is located closer along the gas pipe to the cell or cell stack than the coarse control valve. Preferably but not exclusively, the coarse control valve is located at or near to the external end of the gas pipe. Preferably but not exclusively, a buffer volume is included between the coarse and the fine control valves. Preferably but not exclusively, the coarse and fine control valves are managed by a programmable logic controller (PLC) that monitors pressure detectors/sensors located in at least the following locations: (1) the gas pipe between the fine and coarse control valves, (2) the gas pipe between the fine control valve and the cell or cell stack, and (3) within the cell or cell stack.

Preferably, the gas pipe between the fine control valve and the cell or cell stack is managed to have a pressure P_{fine} that is close to or identical to the pressure within the attached cell or cell stack, P_{stack}. Preferably, the gas pipe between the fine control valve and the coarse control valve is managed to have a pressure P_{coarse} that may be somewhat, but not very different to P_{fine}. That is, preferably, the pressures in the gas pipes are managed so that the pressure difference across the fine control valve, namely, ΔP=P_{coarse}-P_{fine}, is small. Preferably, the fine control valve has the property that small pressure differences (ΔP) across it allow for more precise and accurate adjustments of the pressure P_{fine} than is possible with a larger pressure difference ΔP. That is, preferably, the fine control valve can open and close in a more controlled and precise way with a small pressure difference (ΔP) across it than with a large pressure difference across it. Preferably, the more precise adjustments of the pressure P_{fine} also provides for more precise adjustments of the pressure P_{stack} in the cell or cell stack. Preferably but not exclusively, a buffer volume is included between the coarse and the fine control valves to thereby provide for better control of the fine control valve and thereby provide for better control of the gas pressure within the cell or cell stack.

Preferably, the pressure difference across the fine control valve, namely, ΔP=P_{coarse}-P_{fine}, is less than 0.001 bar, less than 0.002 bar, less than 0.003 bar, less than 0.005 bar, less than 0.010 bar, less than 0.020 bar, less than 0.040 bar, less than 0.050 bar, less than 0.075 bar, less than 0.100 bar, less than 0.125 bar, less than 0.150 bar, less than 0.200 bar, less than 0.300 bar, less than 0.400 bar, less than 0.500 bar, less than 0.750 bar, less than 1 bar, less than 2 bar, less than 5 bar, less than 10 bar, or less than 20 bar.

Preferably, the pressure difference between P_{fine} and P_{stack} is less than 0.001 bar, less than 0.002 bar, less than 0.003 bar, less than 0.005 bar, less than 0.010 bar, less than 0.020 bar, less than 0.040 bar, less than 0.050 bar, less than 0.075 bar, less than 0.100 bar, less than 0.125 bar, less than 0.150 bar, less than 0.200 bar, less than 0.300 bar, less than 0.400 bar, less than 0.500 bar, less than 0.750 bar, less than 1 bar, less than 2 bar, less than 5 bar, less than 10 bar, or less than 20 bar.

In various example aspects, embodiments relate to balance-of-plants, or methods of operation, for electro-synthetic or electro-energy liquid-gas cells or cell stacks capable of circulating or re-circulating gases through a cell or cell stack, including but not limited to the purpose of maintaining a ‘standby’ state, also called a ‘hot standby’ state. A ‘standby’ state is an operational condition or state of an electro-synthetic or electro-energy liquid-gas cell or cell stack wherein the cell or cell stack is disengaged from the electrical power connection/s and therefore unable to carry out the liquid-gas reaction. The cell or cell stack is, however, maintained in a physical condition that allows it to commence operation and properly carry out the reaction immediately the electrical power connection is re-established. A standby state is therefore a state that allows for an immediate operational start of the cells or cell stacks without going through the steps and processes normally required during a ‘startup’ procedure.

In one example aspect, there is provided a balance-of-plant for an electro-synthetic or electro-energy liquid-gas cell or cell stack that has a standby state in which a gas in the cell or cell stack is occasionally, continually, or continuously re-circulated in bulk form, from out of the cell or cell stack, through a ‘de-contamination’ unit, and back into the cell or cell stack. A de-contamination unit is a process engineering device that removes contaminant gas from the re-circulating gas, where the build up of such contaminant gases over time may constitute a safety hazard or make it impossible to immediately operationally start the cell or cell stack without going through the steps normally required during a ‘startup’ procedure. In some embodiments, such contaminant gases may migrate into the gas body by ‘gas crossover’ through the separator/s between electrodes in the cell or cell stack. In some embodiments, the de-contamination unit may comprise a porous, packed bed of catalyst that transforms contaminant gases in re-circulating gases passing through it, into water vapour.

Preferably but not exclusively, the gas circulation out of the cell or cell stack to the de-contamination unit is at least partially produced by an ejector, which is a device that uses a higher-pressure fluid source (the motive fluid) to generate a region of lower pressure that induces movement in a fluid. An ejector may also be termed an evactor, eductor, aspirator, vacuum ejector, venturi, venturi pump, jet pump, or exhauster. Preferably but not exclusively, the gas circulation into the cell or cell stack from the de-contamination unit may be created by a fan, a blower, a compressor, or similar component capable of moving a gas-phase fluid. Optionally, in the case where the cell or cell stack contains two or more separate gas streams, the balance-of-plant may provide for two or more separate re-circulation loops, each of which incorporates a de-contamination unit appropriate to the contaminants involved. In such a case, both re-circulation loops may be activated when the level of a contaminant gas within the gas bodies risk them becoming hazardous, for example when the electrical power connection of the cell or cell stack is disengaged. Preferably but not exclusively, both recirculation loops are halted when the electrical power connection of the cell or cell stack is engaged or when the level of a contaminant gas within the gas bodies declines sufficiently.

In one example, the electro-synthetic or electro-energy liquid-gas cell or cell stack is that of a water electrolyzer or a hydrogen-oxygen fuel cell, which involves two separate gas streams in bulk form entering or leaving the cell or cell stack, namely, an oxygen stream and a hydrogen stream. In cells of a water electrolyzer or a hydrogen-oxygen fuel cell ‘gas crossover’ may occur between the two gas streams, hydrogen and oxygen, at a fixed rate. Such gas crossover may typically continue even when the electrical power connection to the cell or cell stack is disengaged. Ongoing, uncontrolled gas crossover may lead to the creation within the cell or cell stack, of an oxygen body containing more than about 4% hydrogen, or a hydrogen body containing more than about 4% oxygen, both of which would then constitute explosive mixtures at the normal operating temperature of 80° C. Preferably, occasional, continual, or continuous re-circulation of the separate gas bodies through their respective de-contamination units may maintain each gas stream safe by removing the contaminant oxygen from the hydrogen body and the contaminant hydrogen from the oxygen body. Preferably but not exclusively, the de-contamination unit that removes the contaminant hydrogen from the oxygen gas body during the standby state, is a ‘recombiner’, which converts the contaminant hydrogen into water vapour. Preferably but not exclusively, the de-contamination unit that removes the contaminant oxygen from the hydrogen gas body during the standby state, is a ‘de-oxo’ unit, which converts the contaminant oxygen into water vapour.

Preferably but not exclusively, the standby state is used in the water electrolyzer or hydrogen-oxygen fuel cell during ‘load following’ or ‘grid balancing’ of intermittent renewable energy sources as described below.

In various example aspects, embodiments relate to balance-of-plants, or methods of operation, for electro-synthetic or electro-energy liquid-gas cells or cell stacks with new and/or improved liquid management.

In one example aspect, there is provided a balance-of-plant for an electro-synthetic or electro-energy liquid-gas cell or cell stack incorporating a liquid circulation system through the cell or cell stack, in which liquid is drawn out of the cell stack by an ejector or similar component. That is, a liquid outlet pipe of the cell or cell stack is connected to a liquid circulation tank and a liquid is drawn out of the cell or cell stack via the liquid outlet pipe by an ejector. The liquid drawn out of the cell or cell stack may be a liquid electrolyte or a cooling liquid. Preferably but not exclusively, gravity may assist the ejector or similar component to draw the liquid out of the cell or cell stack. In other examples, liquid may be pumped out of the cell or cell stack by a pump.

Preferably but not exclusively, the liquid circulation system may also include a liquid circulation tank, into which liquid, drawn out by the ejector, pump, or similar component, is deposited. Preferably but not exclusively, the liquid circulation tank is an ‘infra’-tank; that is, it lies or is positioned below (i.e. underneath or under) the level of the cells and/or cell stack/s, relative to gravity. Preferably, the liquid circulation tank is located or positioned wholly below, underneath or under the level of the cells and/or cell stack/s, relative to gravity. The liquid circulation tank may be partially or completely filled with liquid. Preferably but not exclusively, the liquid circulation system may further include a pump that pumps liquid from the liquid circulation tank back into the cell or cell stack. In other examples, liquid may be drawn out of the liquid circulation tank by an ejector and circulated back into the cell or cell stack.

Preferably, liquid is added to or removed from the liquid circulation system by adding it to or removing it from the liquid circulation tank. Preferably but not exclusively, liquid is added to or removed from the liquid circulation system via a liquid addition/removal port on the liquid circulation tank.

In the case where the liquid circulation tank is completely filled with liquid, the pressure of the liquid in the tank may, preferably, be managed via a pressure port in the tank that interfaces with a pressure management device, such as, for example, an expansion tank of the type mentioned above. Optionally, the pressure port may be the same as the liquid addition/removal port.

In the case where the liquid circulation tank is only partially filled with liquid, the headspace above the liquid level in the tank may, preferably, be filled with a gas. Preferably, the pressure of the liquid in the liquid circulation tank is managed by managing the pressure of the gas in the headspace. Optionally, the gas in the headspace may be a gas that is also present in bulk form within the cell or cell stack. Optionally, the headspace may be physically connected to an inlet or outlet of that gas in the cell or cell stack, providing a fluid connection for the gas in the headspace and the gas in the cell or cell stack. Optionally, the pressure of the gas in the headspace may be the same or substantially similar to the pressure within the cell or cell stack. Optionally, the partially-filled liquid circulation tank may also function as a gas pressure equalisation tank along the lines described above. Optionally, the pressure of the gas in the headspace may be controlled by a coarse and a fine control valve located sequentially (in series) in an attached gas pipe as described above.

In the case where the cell or cell stack contains two or more separate circulating liquid streams, for example, an anolyte stream and a catholyte stream, the balance-of-plant may, optionally, include two or more separate liquid circulation systems. Such an arrangement is termed here a ‘parallel liquid circulation system’. Preferably but not exclusively, each liquid circulation system may incorporate a separate liquid circulation tank. Preferably but not exclusively, the tanks are each ‘infra’-tanks. Each of the component liquid circulation systems may, preferably but not exclusively, incorporate a separate ejector or similar component to draw liquid out of the cell or cell stack. Preferably but not exclusively, each liquid circulation system may incorporate a separate pump, to pump liquid from the tank back into the cell or cell stack. Optionally, each partially-filled liquid circulation tank may also function as a gas pressure equalisation tank along the lines described above. Optionally, the pressure of the gas in the headspace of each partially-filled liquid circulation tanks may be controlled by a coarse and a fine control valve located sequentially (in series) in an attached gas pipe as described above.

In the case where there are two liquid circulation systems, each of which include a separate, partially-filled liquid circulation tank whose headspace is filled with a distinct gas that is fluidly connected to the same gas in bulk form inside the cell or cell stack, the two liquid circulation tanks may simultaneously function as pressure equalisation tanks if they contain the same liquid and are fitted with a liquid-filled ‘connecting pipe’ of the type described above. In such a case, the two liquid circulation tanks may double as a pressure equalisation system. Preferably but not exclusively, the liquid circulation tanks that double as pressure equalisation tanks are infra-tanks, located below (i.e. underneath or under) the level of the cells and/or cell stack, relative to gravity. Preferably, the liquid circulation tanks that double as pressure equalisation tanks are located or positioned wholly below, underneath or under the level of the cells and/or cell stack, relative to gravity.

In an alternative example, the two liquid streams of a parallel liquid circulation system may, optionally, be combined into one stream at a point along each liquid circulation pathway and later, at another point, be re-separated into two liquid streams. For example, a single ejector or similar component may, optionally, draw both liquid streams out of the cell or cell stack, thereby combining the streams at the point that they exit the cell or cell stack. Alternatively, or additionally, the two liquid streams may be combined into a single electrolyte stream at the point at which each stream is deposited into a single liquid circulation tank. Alternatively, or additionally, the two liquid streams may be drawn out of two liquid circulation tanks by a single pump that combines them into one. The combined liquid stream may, similarly, be again separated into two streams at a point in the liquid circulation pathway prior to re-entering the cell or cell stack.

Optionally, other parts of the liquid circulation system may also be only partially filled with liquid. For example, the liquid outlet pipe of the cell or cell stack, where it is drawn out of the cell or cell stack by the ejector, may contain a headspace of gas above the liquid level. Optionally the gas in that headspace may be a gas that is also present in bulk form within the cell or cell stack. Optionally, that headspace may be physically connected, via an orifice, a valve, or a similar pressure drop device, to an inlet or outlet of that gas in the cell or cell stack, providing a fluid connection of the gas in the headspace with the gas in the cell or cell stack.

In one example, the electro-synthetic or electro-energy liquid-gas cell or cell stack is that of a water electrolyzer or a hydrogen-oxygen fuel cell, that contains two separate liquid streams, namely, an oxygen-side liquid electrolyte stream and a hydrogen-side liquid electrolyte stream.

In this example, the balance-of-plant may contain two separate liquid circulation systems, one for the oxygen-side liquid electrolyte stream and one for the hydrogen-side liquid electrolyte stream, wherein each liquid circulation system separately incorporates an ejector or similar component to draw the liquid stream out of the cell or cell stack, or a pump to pump the liquid stream out of the cell or cell stack. Preferably but not exclusively, each liquid circulation system also incorporates a separate, partially filled liquid circulation tank, whose headspace contains a gas that is fluidly connected, via a gas conduit, to the corresponding gas in bulk form within the cell or cell stack. That is, the gas in the headspace of the liquid circulation tank for the oxygen-side liquid electrolyte stream is, preferably but not exclusively, oxygen, which is fluidly connected via a gas conduit to the oxygen in bulk form within the cell or cell stack. The gas in the headspace of the liquid circulation tank for the hydrogen-side liquid electrolyte stream is, preferably but not exclusively, hydrogen, which is fluidly connected via a gas conduit to the hydrogen in bulk form within the cell or cell stack. Preferably but not exclusively, the pressure of the liquid in each liquid circulation tank is set by the pressure of the headspace gas which is comparable to the pressure of the bulk gas in the cell or cell stack. Preferably but not exclusively, the gas pressures within each liquid circulation system are equalised by a pressure equalisation system of the type described earlier and controlled by a gas pressure control system employing fine and coarse control valves of the type described previously. Preferably but not exclusively, the two liquid circulation tanks contain the same liquid electrolyte. Preferably but not exclusively, the two, separate liquid circulation tanks are infra-tanks; that is, they lie or are positioned below, underneath or under, preferably wholly below, underneath or under, the level of the cells or cell stack, relative to gravity.

In another example, the oxygen-side and the hydrogen-side liquid streams are combined into a single liquid stream and deposited into a single, partially filled liquid circulation tank. Preferably, the single liquid filled circulation tank has a headspace containing a gas that is fluidly connected via a gas conduit to the corresponding gas in bulk form within the cell or cell stack. Preferably but not exclusively, the headspace gas is oxygen, which is fluidly connected via a gas conduit to bulk oxygen within the cell or cell stack. Optionally, the headspace gas is hydrogen, which is fluidly connected via a gas conduit to bulk hydrogen within the cell or cell stack. Preferably but not exclusively, a single ejector or similar component draws both the oxygen-side and the hydrogen-side liquid streams out of the cell or cell stack, thereby combining the streams within the cell or cell stack, or at the point that they exit the cell or cell stack. Alternatively, or additionally, the oxygen-side and hydrogen-side liquid streams are drawn out of the single liquid circulation tank by a single pump. The combined liquid stream may be again separated into two streams at a point in the liquid circulation pathway prior to or after re-entering the cell or cell stack.

In a further example, the electro-synthetic or electro-energy liquid-gas cell or cell stack is that of a water electrolyzer or a hydrogen-oxygen fuel cell, that contains a single liquid stream, being either an aqueous oxygen-side liquid stream or an aqueous hydrogen-side liquid stream. Preferably, the single liquid stream is deposited into a single, partially filled liquid circulation tank. Preferably, the single liquid filled circulation tank has a headspace containing a gas that is fluidly connected via a gas conduit to the corresponding gas in bulk form within the cell or cell stack. Preferably but not exclusively, the headspace gas is oxygen, which is fluidly connected via a gas conduit to bulk oxygen within the cell or cell stack. Optionally, the headspace gas is hydrogen, which is fluidly connected via a gas conduit to bulk hydrogen within the cell or cell stack. Preferably but not exclusively, a single ejector or similar component draws the liquid stream out of the cell or cell stack. Alternatively, or additionally, the single liquid streams is drawn out of the single liquid circulation tank by a single pump.

Optionally, in the case of the water electrolyzer example, water consumed by the reaction is replenished by adding ‘make-up’ water to one or both of the liquid circulation tanks present. Optionally, the make-up water is de-ionized water that was passed between the cell stack and the walls of the pressure vessel around it, as described previously, prior to being added to a liquid circulation tank. The pressure vessel preferably surrounds the cell or cell stack. Optionally, in the case of the fuel cell example, water produced by the reaction is removed from one or both of the liquid circulation systems by removing it from one or both of the liquid circulation tanks. The removal process may involve, for example, condensation of water vapour from the headspace gas, with the resulting liquid water removed from the liquid circulation tank. Any other removal process may, alternatively, be employed.

In various example aspects, embodiments relate to balance-of-plants, or methods of operation, for electro-synthetic or electro-energy liquid-gas cells or cell stacks with new and/or improved cell or cell stack cooling management. Such cooling systems may be particularly useful for cell or cell stacks that have relatively small cooling requirements.

In one example, there is provided a cell or cell stack that is cooled by passing annular liquid, in this example being annular cooling water, through the volume between the external walls of the cell or cell stack and the walls of the pressure vessel around it, as described previously. In another example, there is provided a cell or cell stack with a liquid circulation system of the type described previously, wherein the cell or cell stack is cooled by cooling the liquid in a liquid circulation tank. The liquid in a liquid circulation tank may be cooled via a cooling system incorporated into the tank. Such a cooling system may employ a circulating cooling fluid. In another example, where the liquid in the liquid circulation tank is water, it may be cooled by adding cooling water to the water in the liquid circulation tank. In a further example, the liquid in the liquid circulation tank may be cooled by condensing water vapour from the gas in the tank and removing the resulting liquid water from the tank, as described above.

In example embodiments, the electro-synthetic or electro-energy liquid-gas cell or cell stack is that of a water electrolyzer or a hydrogen-oxygen fuel cell with a single liquid stream or two separate liquid streams, namely, an oxygen-side liquid electrolyte stream or/and a hydrogen-side liquid electrolyte stream. In the case of the water electrolyzer, preferably but not exclusively, the cell or cell stack is cooled by passing make-up water at ambient temperature between the cell or cell stack and the walls of the pressure vessel around it, as described above, and thereafter adding that make-up water to one or both of the liquid circulation tanks to replenish the water that is consumed in the reaction, as described above. Optionally, the make-up water may be cooled between its exit from the pressure vessel and its addition to a liquid circulation tank. In the case of the hydrogen-oxygen fuel cell, the cell or cell stack is, preferably but not exclusively, cooled by condensing water vapour in one or both of the liquid circulation tanks and removing the resulting liquid water from the tanks, as described above. Optionally, that removed water may be further cooled after its exit from the liquid circulation tank and then passed through the volume between the cell or cell stack and the walls of the pressure vessel around it, as described above.

In a further example embodiment, one or more ‘phase change tubes’, of the type commonly used in, for example, computer laptops, may be placed in the above liquid circulation tanks to cool the circulating liquid therein, or be used to cool the liquid passing along the liquid circulation pipes.

In various example aspects, embodiments relate to balance-of-plants, or methods of operation, for electro-synthetic or electro-energy liquid-gas cells or cell stacks with new and/or improved cell condition monitoring and management.

In one example aspect, each cell in a cell stack, contains a computer chip, or one or more computer chips, that communicates wirelessly with, or is connected via a single, common, electrical connection or wire to all of the other chips in the other cells and, therethrough communicates with a PLC in the balance-of-plant, wherein each computer chip, or the one or more computer chips associated with a cell, transmits voltage and/or other information from its cell to the PLC. In this way, the need for multiple wires, connecting the PLC to the different cells present, is avoided. It, thereby, becomes practically possible for a PLC of a balance-of-plant to monitor, in real time, the condition of many cells in an industrial cell stack containing, for example, 50 cells, 100 cells, 150 cells, 200 cells, 300 cells, 400 cells, 500 cells, or more. Such monitoring may allow the PLC to better manage the electro-synthetic or electro-energy liquid-gas cells or cell stack.

Preferably but not exclusively, the computer chip, or the one or more computer chips, is/are embedded in each cell, for example embedded within a polymeric cell frame of each cell. Preferably but not exclusively, the electrical connection or wire is similarly embedded in each cell, for example embedded within a polymeric cell frame of each cell. A variety of different communication protocols may be employed. In one example protocol, each chip in each cell is programmed to repeatedly transmit its cell information to the PLC wirelessly or along the single, common electrical connection or wire at a different time, thereby allowing the PLC to receive the data and match the data to the location of the chip that sent the data. In another example protocol, each chip, or the one or more computer chips associated with a cell, may transmit its information wirelessly or along the single, common electrical connection or wire only when polled to do so by the PLC, which may send a signal to this effect along the single, common electrical connection or wire. It is to be understood that a multiplicity of other techniques may provide for sending of cell information to the PLC; all such techniques fall within the scope of the present specification.

In various example aspects, embodiments relate to balance-of-plants, or methods of operation, for electro-synthetic or electro-energy liquid-gas cells or cell stacks with new and/or improved cell stack arrangements and management. In one example, multiple cell stacks are assembled into ‘arrays’ that share common manifolds, wherein the common manifolds accumulate the multiple, distinct gas and liquid flows of the attached cell stacks into single, distinct, external gas and liquid flows.

In one example embodiment, cell stacks, each included within a pressure vessel, i.e. the pressure vessel surrounds the cell or cell stack, are attached to a common manifold element that connects to the distinct liquid and gas inlets/outlets of each attached cell stack, wherein each manifold element accumulates the distinct gas and liquid pipes of its attached cell stacks into single, overall, distinct, external liquid and gas inlets/outlets. In this way, many distinct liquid and gas inlets/outlets in the attached cell stacks may be reduced to a few, overall, external, distinct liquid and gas inlets/outlets. Moreover, the manifold element may also incorporate or accommodate wiring that cumulatively or separately provides electrical power connections to each of the attached cell stacks.

Preferably but not exclusively, such arrays comprise of cell stacks within pressure vessels, wherein each end of each cell stack is attached to a different manifold element. In the case where separate cables are employed for each electrical power connection in such an array, each cell stack is, preferably but not exclusively, independently electrically activated. In the case where a single cable is employed to make electrical power connections to multiple cell stacks in such an array, all of the connected cells may be simultaneously electrically activated.

In one example, the electro-synthetic or electro-energy liquid-gas cell stacks are those of a water electrolyzer or a hydrogen-oxygen fuel cell with one or two liquid streams, namely, an oxygen-side liquid electrolyte stream or/and a hydrogen-side liquid electrolyte stream. Preferably but not exclusively, multiple cell stacks are arrayed between two manifold elements, each connecting to a different end of the cell stack. Preferably but not exclusively, such an arrangement provides for a single, overall, external hydrogen gas inlet on one of the manifolds, and a single, overall, external hydrogen gas outlet on the other manifold, as well as a single, overall, external oxygen gas inlet on one of the manifolds, and a single, overall, external oxygen gas outlet on the other manifold. Preferably but not exclusively, the water electrolyzer or hydrogen-oxygen fuel cell thus arrayed, may be configured to maintain a ‘standby’ state by recirculating either or both of the hydrogen and oxygen in bulk form within the arrayed cell stacks via the single, overall, external hydrogen inlet and outlet, and/or the single, overall, external oxygen inlet and outlet, respectively, as described earlier.

Preferably but not exclusively, the manifold elements of such an array of cell stacks, further provide for a single, overall, external oxygen-side liquid electrolyte inlet and a single, overall, external oxygen-side liquid electrolyte outlet, as well as a single, overall, external hydrogen-side liquid electrolyte inlet and a single, overall, external hydrogen-side liquid electrolyte outlet. Preferably but not exclusively, the water electrolyzer or hydrogen-oxygen fuel cell thus arrayed, may be configured to circulate oxygen-side liquid electrolyte and/or hydrogen-side liquid electrolyte via the single, overall, external oxygen-side liquid electrolyte inlet and outlet, and/or the single, overall, external hydrogen-side liquid electrolyte inlet and outlet, respectively, as described previously herein.

Preferably but not exclusively, each cell stack thus arrayed is separately electrically connected to a single power element, optionally capable of bi-directional electrical power management, such as an inverter that can provide power to the cell stack (during operation as a water electrolyzer) or transmit power from the cell stack (during operation as a hydrogen-oxygen fuel cell). Preferably but not exclusively, each such power element is managed by a PLC within the balance-of-plant to thereby allow for rapid changes in the direction of operation.

Preferably but not exclusively, these features, in combination with the other features described in the preceding paragraphs, provides for a balance-of-plant that allows for bi-directional operation of the cell stacks, thus arrayed, as either a water electrolyzer or as a hydrogen-oxygen fuel cell system; that is, as a regenerative fuel cell-electrolyzer.

Embodiments further relate to manifold elements suitable for manifolding cell stacks into arrays. Preferably, manifold elements may create either parallel or series connections of the distinct gas and liquid flows of the attached cell stacks. Preferably, manifold elements may be constructed of polymer materials, fibre- or filler-reinforced polymer materials, composites, metals, metal alloys, or other materials. Preferably, manifold elements may be fabricated by machining, 3D printing, moulding, including but not limited to injection moulding, or other fabrication techniques. Optionally, manifold elements may be prefabricated by assembling and affixing to each other, ‘manifold sub-elements’, which may in some cases only be capable of attaching to a single cell stack.

For example, techniques such as those taught in U.S. Pat. No. 5,405,528 to Selbie et al. for “Modular Microporous Filter Assemblies”, filed 19 Apr. 1991, which describes the assembly of manifold sub-elements entitled ‘symmetrical headers’, to thereby create manifold elements for filter systems, may be used.

Embodiments further relate to combining cell stack arrays into larger arrays, termed here ‘3D arrays’. Preferably but not exclusively, cell stacks arrayed as described above, may be combined with other, similar arrays of cell stacks, to further accumulate the distinct liquid and gas flows into larger 3D arrays of cell stacks. Such 3D arrays of cell stacks accumulate the multiple, distinct gas and liquid flows of the component arrays without the use of common manifold elements connecting the arrays.

In various example aspects, embodiments relate to balance-of-plants, or methods of operation, for electro-synthetic or electro-energy liquid-gas cells or cell stacks with new and/or improved capability to ‘load follow’ intermittent renewable energy power sources or to ‘grid balance’ electrical grids fed by intermittent renewable energy power sources. ‘Load-following’ refers to the phenomenon in which an electro-synthetic or electro-energy cell or cell stack receives electrical power from a renewable energy source whose energy output varies with time, necessitating constant changes in the rate of electrical operation of the cell or cell stack. ‘Grid balancing’ refers to the phenomenon in which an electro-energy or electro-synthetic cell or cell stack transmits electrical power to an electrical grid that is connected to renewable energy sources whose energy output varies with time, necessitating constant changes in the rate of energy transmission to the grid by the cell or cell stack.

In one example, load following or grid balancing is, preferably, accomplished by systematically disengaging the electrical power connection (and, if necessary, placing in a standby state) or engaging the electrical power connection (and, if necessary, removing from a standby state) of individual cell stacks or collections of cell stacks within arrays.

In another example, load following or grid balancing is, preferably, accomplished by systematically dis-engaging the electrical power connection (and, if necessary, placing in a standby state) or engaging the electrical power connection (and, if necessary, removing from a standby state) of individual arrays or collections of arrays within 3D arrays of cell stacks.

In a still further example, the electro-synthetic or electro-energy liquid-gas cell stacks used for load following or grid balancing are those of a water electrolyzer or a hydrogen-oxygen fuel cell. Optionally, the cell stacks and associated balance-of-plant may be capable of operating either as a water electrolyzer or as a hydrogen-oxygen fuel cell; that is, as a regenerative fuel cell-electrolyzer.

Electro-synthetic liquid-gas cells or cell stacks with the above features include but are not limited to the following types of cell: (i) a water electrolyzer, (ii) a chlor-alkali electrolyzer, (iii) a cell for ammonia manufacture, or (iv) a CO₂ electrolyzer, including a combined carbon capture and CO₂ electrolyzer.

Electro-energy liquid-gas cells or cell stacks with the above features include but are not limited to the following types of cell: (i) a hydrogen-oxygen fuel cell, including a Polymer Electrolyte Membrane (PEM) fuel cell or an Alkaline fuel cell, (ii) a direct alcohol fuel cell, including a direct methanol or direct ethanol fuel cell, (iii) a phosphoric acid fuel cell, or (iv) an ammonia fuel cell.

### BRIEF DESCRIPTION OF THE FIGURES

Illustrative embodiments will now be described solely by way of non-limiting examples and with reference to the accompanying figures. Various example embodiments will be apparent from the following description, given by way of example only, of at least one preferred but non-limiting embodiment, described in connection with the accompanying figures.

FIG. 1 depicts, in schematic form, a prior art example of a traditional electro-synthetic water electrolyzer cell stack and its balance-of-plant.

FIG. 2 depicts, in schematic form, a prior art example of an electro-synthetic water electrolyzer cell stack and its balance-of-plant, wherein bulk gases are produced directly in the electrolyzer cells.

FIG. 3 depicts, in schematic form, an example electro-synthetic or electro-energy liquid-gas cell stack surrounded by a liquid, within a pressure vessel.

FIG. 4 depicts, in schematic form, an example electro-synthetic or electro-energy liquid-gas cell stack surrounded by a liquid, within a pressure vessel, wherein an expansion tank has been included.

FIG. 5 depicts, in schematic form, an example gas pressure equalisation system wherein a single tank is utilised for pressure equalisation.

FIG. 6 depicts, in schematic form, another example gas pressure equalisation system wherein multiple tanks are utilised for pressure equalisation.

FIG. 7 depicts, in schematic form, another example gas pressure equalisation system wherein multiple tanks are utilised for pressure equalisation together with a connecting pipe.

FIG. 8 depicts, in schematic form, another example gas pressure equalisation system, fitted with a gas pressure control and management system.

FIG. 9 depicts, in schematic form, an example gas re-circulation system.

FIG. 10 depicts, in schematic form, an example liquid circulation system.

FIG. 11 depicts, in schematic form, the combination of an example liquid circulation system and an example gas pressure control and management system.

FIG. 12 depicts in schematic form, an interface between the liquid circulation system and the gas pressure control and management system in FIG. 10.

FIG. 13 depicts in schematic form, the combination of an example liquid circulation system and an example gas pressure control and management system in a water electrolyzer or a hydrogen-oxygen fuel cell.

FIG. 14 depicts an array of example electro-synthetic or electro-energy liquid-gas cell stacks.

FIG. 15 depicts an example of a ‘manifold sub-element’.

### DETAILED DESCRIPTION

The following modes, features, or aspects, given by way of example only, are described to provide a more precise understanding of the subject matter of a preferred embodiment or embodiments.

### Definitions

A ‘reactant’ is a chemical material that is consumed during an electrochemical reaction.

A ‘product’ is a chemical material that is produced during an electrochemical reaction.

A ‘liquid electrolyte’ is a liquid containing dissolved ions that has the capacity to conduct electricity.

‘Room temperature’ is defined here as 21° C.

An ‘electro-energy cell’ is an electrochemical cell that generates electrical power continually or continuously, during operation, over indefinite periods of time, for use outside of the cell. Electro-energy cells may require a constant external supply of reactants during operation. The products of the electrochemical reaction may also be constantly removed from such cells during operation.

An ‘electro-synthetic cell’ is an electrochemical cell that converts one or more reactants into products continually or continuously, during operation, over indefinite periods of time, for use outside the cell. The reactants or products may be in the form of a gas, liquid, or solid. An electro-synthetic cell requires a constant supply of reactants and a constant removal of products during operation. Electro-synthetic cells may generally further require a constant input of electrical energy during operation.

Electro-synthetic and electro-energy cells differ from other types of electrochemical cells, such as batteries, sensors and the like, in that they do not incorporate within the cell body all/some of the reactants they require to operate, nor all/some of the products they generate during operation. These may be, instead, constantly brought in from, or removed to the outside of the cell during operation. For example, electro-synthetic cells are distinguished from galvanic cells in that galvanic cells store their reactants and products within the cell body. Similarly, while some electrochemical sensors may consume reactants and generate products in limited quantities during the sensing operation, all/some of these are stored within the cell body itself.

A ‘liquid-gas’ cell is an electrochemical cell that has at least one liquid-phase reactant or product and at least one gas-phase reactant or product. An electro-synthetic or electro-energy cell may also be a liquid-gas cell. An example of an electro-synthetic liquid-gas cell is a water electrolyser cell that converts liquid-phase water into hydrogen gas at the cathode and oxygen gas at the anode. An example of an electro-energy liquid-gas cell is a hydrogen-oxygen fuel cell that converts gas-phase hydrogen and gas-phase oxygen into liquid-phase water.

An ‘inter-electrode separator’, a ‘separator’, a ‘separator membrane’, or a ‘separator ionomer’ refer, herein, to an electrically insulating material placed between the two electrodes of an electro-synthetic or electro-energy cell. The purpose of such material includes: (i) to prevent short-circuits from occurring between the two electrodes, and also (ii) to minimise the migration of gases from one electrode or half-cell (on one side of the separator), into the other. A specific example of an inter-electrode separator is a ‘porous capillary separator’, also known as a ‘porous capillary spacer’, which is defined in International Patent Publication Nos. WO2022056603, WO2022056604, WO2022056605, and WO2022056606, which are hereby incorporated by reference.

The term gas ‘crossover’ is herein defined as the phenomenon wherein gas present at one electrode or in one half-cell migrates across the inter-electrode separator to the other electrode or half-cell, within an electro-synthetic or electro-energy cell. In a water electrolyser or hydrogen-oxygen fuel cell, such migration may constitute a safety hazard, for example where the one gas is hydrogen and the other gas is oxygen. A mixture of more than ~4% oxygen in a body of hydrogen, or of more than ~4% hydrogen in a body of oxygen, may, at 80° C., constitute an explosive mixture that would be a safety hazard.

A ‘two-phase’ mixture is defined herein as an intermingled mixture of gas phase and liquid phase substances, for example in the form of a ‘froth’ or ‘foam’-type mixture of intermingled gas phase and liquid phase substances. Such ‘two-phase’ mixtures may also be referred to as a ‘liquid-gas’ mixture, or a ‘two-phase liquid-gas’ mixture. Intermingled two-phase mixtures may be separated within separation tanks or engineering structures that are specifically designed to allow such two-phase, liquid-gas mixtures to fractionate into discrete and separate gas and liquid phases.

A ‘single-phase’ or ‘bulk’ substance is herein defined as a substance that is substantially in a single phase. For example, a reactant provided substantially in the gas phase, or a product generated substantially in the gas phase, is referred to as a ‘bulk gas’ reactant or product, while a reactant provided substantially in the liquid phase, or a product generated substantially in the liquid phase, is referred to as a ‘bulk liquid’ reactant or product.

The ‘energy efficiency’ of an electro-synthetic cell or system is defined as the net energy present within a single unit output of a chemical product, divided by the net energy consumed by the cell or the system to produce that same unit output of the chemical product, expressed as a percentage. The ‘energy efficiency’ of an electro-energy cell or system is herein defined as the energy produced by the cell or system per unit time, divided by the maximum theoretical energy that may be produced by the cell or system per unit time, expressed as a percentage.

A ‘cell stack’ is defined as an assembly of two or more electro-synthetic or electro-energy cells, wherein the cells are stacked adjacent to or abutting each other along a single dimensional axis.

Cell stacks may take the form of a ‘filter-press’ arrangement, which is defined as a filter-press cell stack wherein the cells are substantially flat and compressed against each other between endplates during its assembly and/or operation.

A ‘gas conduit’ is defined as a conduit, a tube, a pipe, a chamber, that transports bulk gas, for example a bulk gas reactant or product of the electrochemical reaction.

A ‘header’ is a channel, a tube, a pipe, a chamber, a conduit, or a trough within a cell stack, formed by the combination of apertures in individual cells in a cell stack, for conveying a fluid through the length of a cell stack.

A ‘manifold’ is one or more pipes, tubes, chambers, conduits, or channels with multiple openings, for conveying a fluid. A header within a cell stack may also be a manifold.

A ‘supra’ component of a balance-of-plant is a component that is placed above the level of the cells and/or cell stack; for example, a ‘supra’-tank, is a tank that is located above the level of the cells and/or cell stack, relative to the direction of gravity.

An ‘infra’ component of a balance-of-plant is a component that is placed below the level of the cells and/or the cell stack; for example, an ‘infra’-tank is a tank that is located below (i.e. underneath or under) the level of the cells and/or cell stack, relative to the direction of gravity.

An ‘annular liquid’ is defined as a liquid that surrounds an electro-synthetic or electro-energy liquid-gas cell or cell stack that is incorporated or contained within a pressure vessel.

An ‘annular gas’ is defined as a gas that surrounds an electro-synthetic or electro-energy liquid-gas cell or cell stack that is incorporated or contained within a pressure vessel.

A ‘liquid capture device’ is an engineering component that removes liquid-phase materials from a gas-phase stream. Examples of liquid capture devices include but are not limited to liquid condensate traps, coalescers and droplet coalescers, condensors, and the like.

A ‘connecting pipe’ is here defined as a liquid-filled pipe that connects two or more pressure equalisation tanks and facilitates the movement of liquid between the two or more pressure equalisation tanks during equalisation of gas pressures.

An ‘ejector’ is a device that uses a higher-pressure fluid source (the motive fluid) to generate a region of lower pressure, where pressures are relative to the outlet or discharge port. Such a device can be used to pump fluids from the region of lower pressure to the outlet. The motive fluid is accelerated through an orifice or nozzle and some of the momentum is then transferred to the suction fluid as the two streams mix within the device. The outlet of the ejector generally includes a diffuser to recover some of the kinetic energy to fluid pressure. There are many variations and applications of these type of devices, and they may also be known by terms or combination of terms including but not limited to the following: evactor, eductor, aspirator, vacuum ejector, venturi, venturi pump, jet pump, or exhauster.

A ‘Standby’ state is an operational condition or state of an electro-synthetic or electro-energy liquid-gas cell or cell stack. A cell or cell stack in ‘standby’ is disengaged from the electrical power connection/s and therefore unable to carry out the liquid-gas reaction, however the cell or cell stack is maintained in a physical condition that allows it to commence operation and carry out the reaction, producing usable products, immediately the electrical power connection is established. That is, a cell or cell stack in ‘standby’ is ready to start operating without going through the steps and processes normally involved in a ‘startup’ procedure. In the case where a cell or cell stack has been operating and is then placed in ‘standby’ by disengaging the electrical power connection/s, the ‘standby’ state allows for an immediate re-start of the cells or cell stacks without going through the steps and processes normally involved in a startup procedure. The physical conditions that need to be maintained during ‘standby’, may involve, for example, a minimum temperature, a minimum pressure, a minimum level of gas or liquid purity, or another physical condition, or combination of physical conditions.

A ‘Startup’ procedure is a set of steps that may be needed to bring an electro-synthetic or electro-energy liquid-gas cell or cell stack up from its resting state to full operation. Such steps may include steps to: (i) remove inert gases (also known as purge gases) that may be present within the cell or cell stack when it is resting, (ii) bring the cell or cell stack up from ambient or near-ambient temperature to its operating temperature, and/or (iii) bring the cell or cell stack up from atmospheric or near-atmospheric pressure to its operating pressure.

A ‘Shutdown’ procedure is a set of steps that may be needed to bring an electro-synthetic or electro-energy liquid-gas cell or cell stack down to its resting state from full operation. Such steps may include steps to: (i) fill the cell or cell stack with inert gases (also known as ‘purging’ the cell or cell stack), (ii) bring the cell or cell stack down from its operating temperature to ambient or near-ambient temperature, and/or (iii) bring the cell or cell stack down from its operating pressure to atmospheric or near-atmospheric pressure.

An ‘Emergency stop’ procedure, also called an ‘e-stop’ procedure, is an accelerated and rapid shutdown procedure, typically with enactment of additional safety measures, that is initiated by the control system as a result of an emergency or potential emergency.

A ‘sensor’ is a device that detects or measures a physical property and reports it to a control system, for example, to a Programmable Logic Controller (PLC) that manages the balance-of-plant.

A ‘de-contamination unit’ is a process engineering device that removes contaminants from gas streams passing through it. Specific examples of de-contamination units include a ‘recombiner’ (for removing contaminant hydrogen from an oxygen stream, by ‘recombining’ the hydrogen with oxygen into water), and a ‘de-oxo’ unit (for removing contaminant oxygen from a hydrogen stream). De-contamination units may comprise a packed bed of catalyst through which the gas passes.

A ‘pressure drop device’ is a device, whose presence within a pipe creates a pressure change or pressure differential from its one side to its other side. Examples of a pressure drop device includes an ‘orifice’, which is a small aperture with a limited flow of gas or liquid through it, a ‘restrictor’, which is a narrow tube with many sharp turns, each of which create a pressure decline when a gas or liquid flows through it, and a valve, which can provide a variably small aperture.

A ‘parallel liquid circulation system’ for a cell or cell stack comprises two liquid circulation systems that are separate from each in at least some part outside of the cell or cell stack.

A Programmable Logic Controller (PLC) is an industrial computer that has been ruggedized and adapted for automated control of operational and/or safety processes in a balance-of-plant, such as control of the process engineering devices present, including valves, pumps, sensors, power devices, safety devices, water dispensing devices, cooling devices, and any other types of machines or devices present. A PLC may typically also manage process variable, such as pressures, temperatures, and the like, as well as operational steps, such as ‘start-up’, ‘shut down’, ‘normal operation’, ‘standby’, ‘process fault diagnosis’, ‘process fault resolution’, ‘emergency-stop’, or any other required activity. In general, a PLC should display high reliability, ease of programming, and be capable of diagnosing and responding to process faults. A PLC may also be referred to as a programmable controller.

A ‘computer chip’, or a ‘chip’ is an integrated circuit or small wafer of semiconductor material embedded with integrated circuitry, that is able to execute computational instructions, including carrying out measurements and transmitting the resulting measurement information via an electrical connection or wire to an attached PLC.

A ‘manifold element’ is a structure that contains a multiplicity of pipes, tubes, chambers, conduits, or channels for conveying distinct fluids, each of which is configured to be fluidly connected to a corresponding inlet/outlet for the distinct fluid in multiple attached cell stacks.

A ‘manifold sub-element’ is a structure that, when assembled correctly with other manifold sub-elements, creates a manifold element. Some manifold sub-elements may only be capable of attaching to one cell stack.

An ‘array’ is a collection of more than one cell stack that are connected via one or more manifold elements, to operate together.

A ‘3D array’ is a collection of more than one array, wherein the constituent individual arrays do not share manifold elements with each other, but are, nevertheless, connected, via piping and/or wiring and/or a common management/control system, to operate together, or to share a common, de-centralised balance-of-plant component (e.g. a water supply or cooling system).

‘Load following’ is the phenomenon in which the rate of electricity consumption by an electro-synthetic or electro-energy cell or cell stack is varied to match the electrical power supplied by a renewable energy source whose energy output varies with time.

‘Grid balancing’ is the phenomenon in which the rate at which an electro-energy or electro-synthetic cell or cell stack transmits electrical power to an electrical grid is varied in order to balance the total electrical power available on the grid when it is fed by renewable energy sources whose energy output varies with time.

### Description and Definition of the Term “Balance-of-Plant”

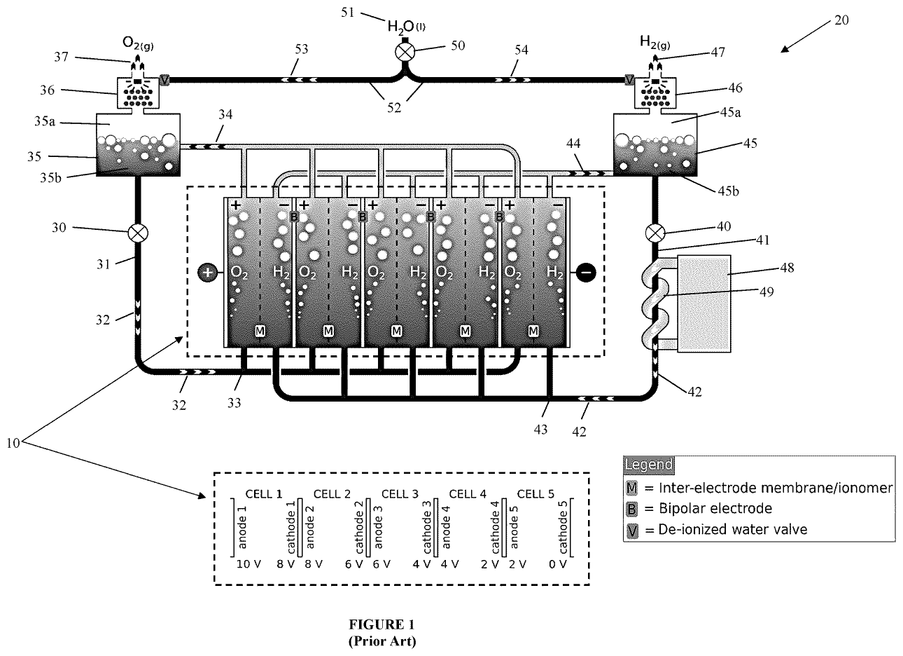

To clarify and define what a balance-of-plant is, FIG. 1 (prior art) schematically depicts the key components of a typical commercial alkaline water electrolyzer, which serves as an illustrative example of an electro-synthetic liquid-gas cell. Electrolyzers employ electrical energy to convert liquid water into hydrogen and oxygen gas.

In most electro-synthetic liquid-gas cells, the gaseous materials in a cell are in a ‘two-phase’ form that is intermingled with the liquid materials (e.g. as bubbles of gas within a liquid phase reactant). This necessitates separation of the two phases, which is typically carried out using tanks or engineering structures in the balance-of-plant that separate such two-phase mixtures into discrete gas-phases and liquid-phases. This is also the case in the example shown in FIG. 1.

The electrolyzer in FIG. 1 comprises a cell stack 10 (shown within the dashed line box in FIG. 1) and its balance-of-plant 20 (which is generally everything outside of the dashed line box in FIG. 1).

The cell stack 10 illustratively comprises 5 cells, with each cell having an anode electrode (designated the ‘+’ electrodes at which oxygen (O₂) gas is produced in the form of oxygen bubbles in the liquid electrolyte) and a cathode electrode (designated the ‘-’ electrodes at which hydrogen (H₂) gas is produced in the form of hydrogen bubbles in the liquid electrolyte) separated by an inter-electrode membrane/ionomer separator (designated “M”) in FIG. 1. The inter-electrode membrane/ionomer separators (“M”) split each cell into two half-cells, an anode half-cell and a cathode half-cell. The cells are filled with a conductive, liquid-phase, aqueous electrolyte that is referred to as the ‘anolyte’ (the liquid electrolyte in the anode half-cell) and the ‘catholyte’ (the liquid electrolyte in the cathode half-cell). In a water electrolyzer, the anolyte is therefore the oxygen-side liquid electrolyte, while the catholyte is the hydrogen-side liquid electrolyte. (In a hydrogen-oxygen fuel cell, which converts hydrogen gas and oxygen gas into water, with accompanying generation of electrical energy, by contrast, the anolyte is the hydrogen-side liquid electrolyte, and the catholyte is the oxygen-side liquid electrolyte).

The lower dashed line box in FIG. 1 schematically labels the electrodes in the upper dashed box and illustrates the voltages that may be applied to each of the electrodes in cell stack 10 when 10 V is applied over the external electrical terminals, designated as ‘+’ and ‘−’ at each end of the cell stack 10 in FIG. 1. The applied voltages cause an electrical current to flow through the cells, which splits the water in the cells into bubbles of oxygen (O₂) gas at the anodes, and hydrogen (H₂) gas at the cathodes.

The balance-of-plant is the process engineering system or apparatus around the cell stack that supports and manages the cell stack. In the example in FIG. 1, the balance-of-plant includes a pump 30 that pumps liquid electrolyte along the ‘anolyte pipe’ 31 in the direction 32, to junctions like 33 that direct the pumped flow in parallel through all of the anode half-cells. The mixtures of oxygen (O₂) bubbles and anolyte in each anode half-cell are then carried along the anolyte pipe 34 into an ‘oxygen separator tank’ 35, where the gas bubbles separate from the liquid anolyte 35b, forming bulk oxygen gas 35a at the top of the tank 35. The bubble-free liquid anolyte at the bottom of tank is pumped back to the anode half-cells cells, via anolyte pipe 31, while the separated ‘bulk’ oxygen gas 35a from the top of tank 35 passes through a scrubber 36, whereafter the oxygen gas is released at outlet 37.

Hydrogen gas produced at the cathodes in cell stack 10 is similarly collected and separated by the balance-of-plant. In this process, a pump 40 pumps liquid electrolyte along the ‘catholyte pipe’ 41 in the direction 42, to junctions like 43 that direct the pumped flow in parallel through all of the cathode half-cells. The mixtures of hydrogen (H₂) bubbles and catholyte in each anode half-cell are then carried along the catholyte pipe 44 into a ‘hydrogen separator tank’ 45, where the gas bubbles separate from the liquid catholyte, forming bulk hydrogen gas 45a at the top of tank 45. The bubble-free liquid catholyte 45b at the bottom of tank 45 is pumped back through the cathode half-cells cells, via catholyte pipe 41, while the separated hydrogen gas 45a from the top of tank 45 passes through a scrubber 46, whereafter the hydrogen gas is released at outlet 47. The separator tanks 35 and 45 are placed above the level of the cell stack, largely to avoid the risk of a ‘gas lock’ forming anywhere in the liquid circulation systems, wherein gas becomes trapped in liquid circulation piping. Gas bubbles also tend to rise in liquid media (due to their buoyancy), meaning that it makes sense to place the gas tanks into which the gas will be transported above the cell or cell stack. That is, the separator tanks 35 and 45 are ‘supra’-tanks, being located above the level of the cells and cell stack.

It should be noted that the pipes along which liquid electrolyte flows, namely pipes 31, 34, 43, and 44, may be partially incorporated into the cell stack in the form of headers and/or manifolds that are physically located within the cell stack. In that case, those portions that are physically within the cell stack are considered here to be part of the cell stack, while those portions that are physically outside of the cell stack are considered to be part of the balance-of-plant.

Because water electrolyzers typically produce excess heat, a liquid-cooled chiller 48 may be used to drive a heat exchanger 49 that extracts heat from, for example, the catholyte pipe 41.

During the course of operation, the water consumed in the cell stack 10 to produce the hydrogen and oxygen needs to be replenished. This is done by pump 50, which pumps ‘make-up’ water 51 through water replenishment pipes 52, in directions 53 and 54 respectively. The make-up water 51 is typically added to the scrubbers 36 and 46 respectively, via valves, designated as “V” in FIG. 1, from where the make-up water 51 dribbles down into the liquid bodies 35b and 45b in the separator tanks 35 and 45 respectively.

The operation of the valves “V”, as well as the pumps 30, 40, and 50, the chiller 48, the electrical power supply attached to the “+” and “−” terminals at each end of the cell stack 10, and other components in the balance-of-plant not shown in FIG. 1, such as flow, temperature, and pressure sensors, and the like, are typically managed by a computerised, automated control system in the form of at least one programmable logic controller (PLC), which also forms part of the balance-of-plant. It is of critical importance that the process engineering arrangement of components and system architecture of the balance-of-plant provides for efficient, reliable, and safe automated operation when it is controlled by the one or more PLCs.

The electrolyzer in FIG. 1 may be configured to operate at pressure. That is, the electrolyzer may output the produced hydrogen and oxygen at elevated pressure, for example at 1 bar above atmospheric pressure. This may be useful in applications where pressurised hydrogen is required. To produce such pressurised gases, the cell stack 10 would typically be designed to confine and maintain the additional pressure within the cell stack. In such a case, the balance-of-plant 20 would necessarily also have to be designed to confine and maintain the required pressure. That is, the pipes, tanks, pumps, valves, and other components of the balance-of-plant would have to be capable of handling the required pressure.

A key challenge in systems of the above type, especially at pressure, is to precisely balance the pressure of the produced hydrogen and oxygen, at all times during operation. Any imbalance between the pressure of the oxygen gas 35a inside separator tank 35 and inside scrubber 36, and the pressure of the hydrogen gas 45a inside separator tank 45 and inside scrubber 46, will be transmitted via the contiguous columns of liquid anolyte and catholyte respectively, in pipes 31 and 34 (anolyte) or pipes 41 and 44 (catholyte) respectively, to their respective half cells in the cell stack 10. A major imbalance in the pressures on opposite sides of the inter-electrode membrane/ionomer separators (“M” in FIG. 1) within the individual cells in the cell stack 10, may blow out or tear the separators, destroying or damaging the electrolyzer. Even more minor, short-lived, transient (temporal) imbalances in the anolyte and catholyte pressures on opposite sides of each inter-electrode membrane/ionomer separator increase the ‘gas crossover’ in the cell, wherein O₂ or H₂ gas passes through the inter-electrode membrane/ionomer separator (“M” in FIG. 1) and mixes with the gas being produced on the other side. Such ‘gas crossover’ constitutes a serious safety issue in electrolyzers since oxygen containing more than about 4% hydrogen, or hydrogen containing more than about 4% oxygen, is an explosive mixture at the usual operating temperature of 80° C. Commercial electrolyzers typically automatically carry out an ‘emergency stop’ shut down procedure if the percentage of O₂ in the H₂ stream, or H₂ in the O₂ stream exceeds 2%. Accordingly, it is essential to always minimise the pressure differentials between the hydrogen and oxygen gases in the individual cells in the cell stack 10, as well as in the balance-of-plant during operation.

What makes pressure management and equalisation particularly challenging is the fact that the gas separation tanks 35 and 45 may typically not have a clearly defined liquid level within them. The boundary between liquid (35b/45b) and gas (35a/45a) in those tanks is occupied by intermingled, two-phase ‘froths’ or ‘foams’, which comprise a haphazard collection of gas bubbles and liquid. That is, there may typically be no clearly defined, unambiguous interface of liquid and gas in tanks 35 and 45.

Moreover, the hydrogen and oxygen gas pressures are transmitted to opposite sides of the inter-electrode membrane/ionomer separators, designated “M” in FIG. 1, through the columns of contiguous liquid in pipes 34 and 44. These columns comprise intermingled, two-phase mixtures of gas and liquid electrolyte that may typically have widely varying and rapidly fluctuating densities and compressibilities. The pressure of the liquid electrolyte on opposite sides of the inter-electrode separator membrane/ionomers (“M” in FIG. 1) may therefore be subject to large and fluctuating, transient differentials, which leads, in turn, to high gas crossover.

In recent years, electro-synthetic liquid-gas systems have been developed that directly produce bulk gas phase products within their cells. That is, unlike the cells in FIG. 1, a permanent three-way liquid-gas-solid boundary may be present in such cells, for example at the electrodes in such cells (in the same way that such boundaries may exist in the electrodes of many electro-energy liquid gas cells). As noted herein previously, examples of such systems are described in the scientific publication “The prospects of developing a highly energy-efficient water electrolyser by eliminating or mitigating bubble effects”, Swiegers et al., published 10 Feb. 2021 in Sustainable Energy and Fuels, 2021, Vol. 5, pp. 1280-1310 (DOI: 10.1039/d0se01886d). Another example is described in the subsequent scientific publication “A high-performance capillary-fed electrolysis cell promises more cost-competitive renewable hydrogen”, Hodges et al., published 15 Mar. 2022 in Nature Communications, 2022, Vol. 13, page 1304 (DOI: 10.1038/s41467-022-28953-x).

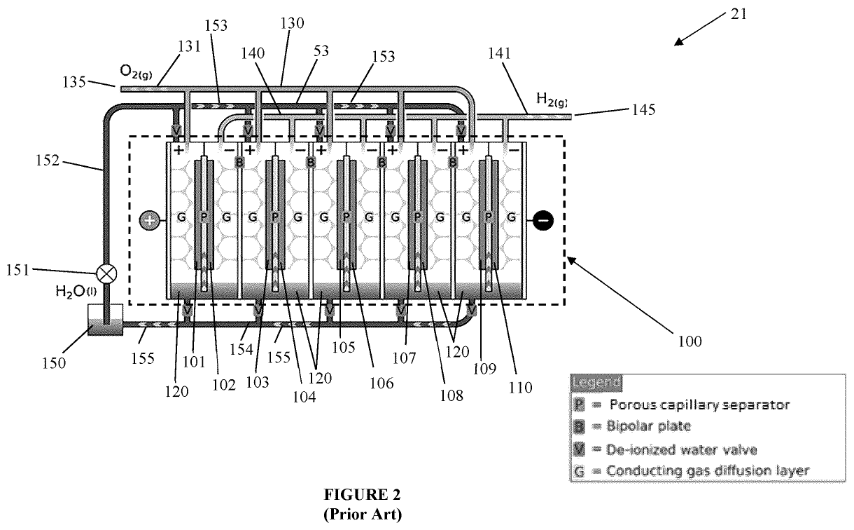

FIG. 2 (prior art) depicts an illustrative schematic of a cell stack of a capillary-fed alkaline electrolyzer in which a permanent three-way liquid-gas-solid interface is present at each electrode. The operation of such a cell stack is further described in the following patent applications that are hereby incorporated by reference: International Patent Publication Numbers WO2022056603 A1, WO2022056604 A1, WO2022056605 A1, and WO2022056606 A1.

The electrolyzer in FIG. 2 comprises of a cell stack 100 (shown within the dashed line box in FIG. 2). The balance-of-plant 200 would, generally, be all of the process engineering equipment outside of the dashed line box in FIG. 2.

The cell stack 100 in FIG. 2 is depicted in an illustrative schematic that allows for a direct comparison with the cell stack 10 in FIG. 1. Cell stack 100 in FIG. 2 comprises 5 cells, with each cell having an anode electrode (101, 103, 105, 107, 109) that directly produces oxygen (O₂) gas in bulk form, and a cathode electrode (102, 104, 106, 108, 100) that directly produces hydrogen (H₂) gas in bulk form, pressed tight up against an inter-electrode ‘porous capillary separator’, designated “P” in FIG. 2. The porous capillary separator membrane exhibits a fast-moving capillary action. The fast-moving capillary action of the porous capillary separator “P” has the effect of drawing up conductive, liquid, aqueous electrolyte from the liquid electrolyte reservoirs 120 at the base of each cell. The drawn-up liquid wets each of the electrodes 101-110 with liquid electrolyte. The gases are produced by the electrodes 101-110 in bulk form and not as gas bubbles and are therefore not intermingled with liquid in two-phase mixtures as occurs in FIG. 1. The gases flow out of the cells and along the gas pipes 130 (oxygen, O₂) and the gas pipes 140 (hydrogen, H₂) in the directions 131 and 141 respectively, exiting at locations 135 and 145 respectively.

Each electrode is electrically connected via a porous conducting, gas diffusion layer structure (designated “G” in FIG. 2), to either a bipolar plate (designated “P” in FIG. 2) that separates the cells, or to an end terminal plate (which is directly attached to the ‘+’ or ‘−’ electrical terminal at each end of the cell stack in FIG. 2).

It should be noted that the gas pipes 131 and 141 may be incorporated into the cell stack in the form of headers and/or manifolds within the cell stack. In that case, those portions that are physically located within the cell stack are considered here to be part of the cell stack, while those portions that are physically outside of the cell stack are considered here to be part of the balance-of-plant.

The inter-electrode membrane separators (“P”) split each cell into two half-cells, namely an anode half-cell (the oxygen-generating half-cell) and a cathode half-cell (the hydrogen-generating half-cell). The produced oxygen and hydrogen in each half are kept separate from each other by the inter-electrode membrane separators (“P”) and the liquid reservoirs 120.

When 10 V is applied over the external electrical terminals, designated as ‘+’ and ‘−’ at the ends of the cell stack in FIG. 2, the same voltages as those shown at the bottom schematic of FIG. 1 may be applied to each of the anodes and cathodes present in the cell stack 100. That is, the voltage at each of anode 1 (101), anode 2 (103), anode 3 (105), anode 4 (107) and anode 5 (109) may be the same as that shown for these anodes in the lower schematic in FIG. 1. Similarly, the voltage at each of cathode 1 (102), cathode 2 (104), cathode 3 (106), cathode 4 (108) and cathode 5 (110) may be the same as that shown for these cathodes in the lower schematic in FIG. 1.

In the example in FIG. 2, make-up water (to replenish the water that is consumed during operation) is, supplied by an external water supply tank 150, from where water is pumped by pump 151, along liquid pipe 152 in the direction 153 to a set of valves denoted “V” at the top of the cell. These valves may be needed to regulate the flow of water into the cell. A second set of valves “V” below each cell may be needed to regulate the flow of excess liquid out of the cell (for example, in the case where water or liquid electrolyte is circulated through each cell). Such water may pass out of the cell along liquid pipe 154, in the direction 155, back to the external water supply tank 150.

It should be noted that the pipes along which liquid electrolyte flows, namely pipes 152 (including at directions 153) and 154 (including at direction 155) may be partially physically incorporated into the cell stack in the form of headers and/or manifolds that are physically within the cell stack. In that case, those portions that are physically within the cell stack are considered here to be part of the cell stack, while those portions that are physically outside of the cell stack are considered here to be part of the balance-of-plant.

The cell stack 100 in FIG. 2 may also be configured to output the produced hydrogen and oxygen in bulk form at elevated pressure, for example at 1 bar above atmospheric pressure. As in the conventional electrolyzer in FIG. 1, to produce such pressurised gases, the cell stack 100 in FIG. 2 may need to be capable of confining and maintaining the necessary pressure within it. In both cases, the balance-of-plant 200 would necessarily also have to be capable of confining and maintaining the required pressure within it. That is, the pipes, tanks, pumps, valves, and other components of the balance-of-plant would have to be capable of handling the required pressure.

In comparing FIGS. 1 and 2, it will be appreciated that the liquid supply/circulation system in the electrolyzer in FIG. 2 is quite different to that in FIG. 1. Because the gases are produced in bulk form directly in the cells in cell stack 100, there is no need to pump liquid electrolyte filled with gas bubbles to a hydrogen or oxygen gas separator, as is needed in the conventional system depicted in FIG. 1.

The balance-of-plant needed for the cell stack 100 in FIG. 2 will therefore necessarily be different to that needed for the cell stack 10 in FIG. 1. That is, the recent development of new electro-synthetic cells that directly produce gaseous products in bulk form inside the cell, creates a need for new and/or improved balance-of-plants.

The preferred embodiments described below provide new and/or improved configurations for the balance-of-plant of electro-synthetic cells or cell stacks in which bulk gases are produced directly in the cell or cell stack itself, such as the example depicted in FIG. 2. It is to be understood however, that the preferred embodiments described below are not limited to cells or cell stacks of the type described in FIG. 2 and associated description. The preferred embodiments described below may constitute new and/or improved configurations for the balance-of-plant of a host of other electro-synthetic and electro-energy liquid-gas cells or cell stacks not described herein.

### Preferred Embodiments

The inventors have developed new and/or improved process engineering systems, apparatus, configurations and/or methods of operation for the balance-of-plants of electro-synthetic or electro-energy liquid-gas cells or cell stacks, in respect of:
(1) Gas management, including:
   i. Gas pressure management;
   ii. Gas pressure equalisation;
   iii. Gas pressure control; and/or
   iv. Gas circulation or re-circulation, including during ‘stand-by’;
(2) Liquid management;
(3) Stack cooling management;
(4) Cell condition monitoring and management;
(5) Cell stack arrangement and management; and/or
(6) Load following and/or grid balancing.

Each of the above aspects is described in more detail below. Each of the above aspects may be implemented within an automated or PLC-controlled balance-of-plant; that is, each may be applied automatically, for example via a PLC, or they may operate passively in parallel with automated management of the balance-of-plant.

Preferably but not exclusively, the above embodiments relate to balance-of-plants that are automated in their operation, for example by being computer-controlled by one or more programmable logic controller (PLC) that may utilise sensors, valves, pumps, and other conventional components of balance-of-plants to operate without active human intervention.

It is to be understood that any balance-of-plant incorporating one or more of these aspects, individually or in any combination, falls within the scope of this specification. It is to be further understood that many modifications, changes, substitutions, or alterations will be apparent to those skilled in the art without departing from the scope of this specification.

(1)(i) Gas Management: Gas Pressure Management

In examining the operation of electro-synthetic or electro-energy liquid-gas cells or cell stacks at pressure, the inventors have recognised that such cells or cell stacks must be able to physically withstand the pressure difference between the inside and the outside of the cell or cell stack. That is, the cells and cell stacks may typically require strong and thick external walls, depending on the extent of the above pressure difference. However, it is typically complex and demanding to assemble cells of this type into cell stacks that can handle and maintain the pressure difference. Indeed, it may typically be extremely challenging, if not impossible in many cases, to assemble such cells into cell stacks with acceptable reliability using a high speed, high volume industrial manufacturing process.

The inventors have recognised that this problem may be avoided by incorporating the cells or cell stack into a pressure vessel, wherein the annular volume between the outer walls of the cells or cell stack and the inner walls of the pressure vessel is filled with a liquid or gas that is pressurised to a similar pressure or to a slightly higher pressure to that inside the cells or cell stack, herein termed an annular liquid or an annular gas. As liquids and gases are generally easily compressed, for example using a simple pump in the case of an annular liquid, the pressure of such an annular liquid or annular gas may be readily matched to or maintained close to or slightly above the internal pressure of the cells. Such an arrangement ensures that the pressure differential between the inside and outside of the cells or cell stack may only ever be small, thereby allowing use of simpler cells with thinner walls that are more readily combined into cell stacks, including in high speed, high volume industrial manufacturing processes. Such an arrangement therefore potentially allows for high speed, high volume industrial manufacturing and assembly of cell stacks that can be used to produce or consume, for example, gases having high absolute pressures.

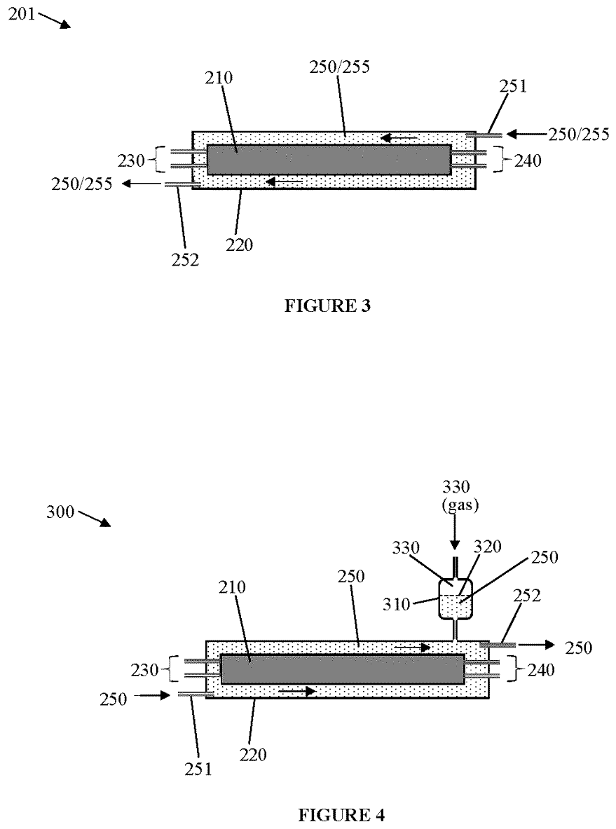

FIG. 3 depicts a system (i.e. process engineering arrangement) 201, involving cells or a cell stack 210 incorporated within a pressure vessel 220. The pressure vessel 220 surrounds the cell or cell stack 210. Liquid and gas pipes 230 and 240 from the cells or cell stack 210 penetrate the walls of the pressure vessel 220 and allow liquid and gas reactants and/or products to be delivered to/removed from the cells or cell stack 210, including at pressure. The annular volume between the cells or cell stack 210 and the walls of the pressure vessel 220 is occupied by an annular liquid 250 or an annular gas 255. That is, the pressure vessel 220 includes an annular liquid 250 or an annular gas 255. The annular liquid 250 or annular gas 255 may be passed into the pressure vessel 220 via an inlet port 251. From the inlet port 251, the annular liquid 250 or annular gas 255 may flow around the cells or cell stack 210 and fill the pressure vessel 220 until it reaches an outlet port 252, where the annular liquid 250 or annular gas 255 may exit the pressure vessel 220.

Preferably, the pressure differential between the gases and liquids inside the cells or cell stack 210 and the surrounding, annular liquid 250 or annular gas 255 outside the cells or cell stack 210, is low in absolute terms and/or low relative to the absolute pressure of the gases and/or liquids within the cell or cell stack 210. Preferably, the cells or cell stack 210 is sealed to exclude the annular liquid 250 or annular gas 255 so that the annular liquid 250 or annular gas 255 does not penetrate the cells or cell stack 210, nor come into direct contact with the electrodes within the cells or cell stack 210. Nor should the gases and/or liquids within the cell or cell stack 210 leak into the annular volume to mix with the annular liquid 250 or annular gas 255. Preferably, but not exclusively, the annular liquid 250 or annular gas 255 is passed continually, continuously or periodically through the space between the cells or cell stack 210 and the walls of the pressure vessel 220. Optionally, the annular liquid 250 or annular gas 255 is cooled or heated prior to, or during its passage through the space between the cell or cell stack 210 and the walls of the pressure vessel 220, to thereby manage the temperature of the cells or cell stack 210. Preferably, but not exclusively, the annular liquid 250 or annular gas 255 is not significantly electrically conductive. Preferably, but not exclusively, the annular liquid 250 or annular gas 255 is not significantly corrosive.

In another example aspect, annular liquid 250 inside the pressure vessel 220 may be pressurised by the pump that pumps the liquid into the pressure vessel 220 via the inlet port 251. The pump may, preferably but not exclusively, be controlled by a programmable logic controller (PLC) within the balance-of-plant that controls or partially controls the system and that may utilise pressure sensors to monitor the pressure in the liquid 250 and inside the cells or cell stack 210. The PLC may, for example, turn the pump on and off to thereby ensure that the liquid 250 in the pressure vessel 220 has a pressure that is close to the pressure of the gases and/or liquids within the cells or cell stack 210.

In one non-limiting example, the annular liquid 250 is water, for example, de-ionized water. Preferably but not exclusively, the annular liquid 250, being water, entering port 251 is at ambient temperature and is heated by the cell stack 210 in the pressure vessel 220. In so doing, the incoming water (annular liquid 250) (via port 251) may act to cool the cells or cell stack 210. When the heated annular liquid 250, i.e. the heated water, then leaves the pressure vessel 220 via port 252, the heat removed from the cells or cell stack 210 is carried away elsewhere to be released when the water cools back down to ambient temperature. Preferably but not exclusively, the flow of annular liquid 250 through the pressure vessel 220 is regulated to maintain the temperature of the cells or cell stack 210 at or about a target temperature. Preferably but not exclusively, the cells or cell stack 210 has a low cooling requirement, so that this cooling mechanism is sufficient to maintain the operating temperature of the cells or cell stack 210 without any other cooling mechanism being required.

Preferably but not exclusively, in the case that the cells or cell stack 210 is that of an electro-synthetic liquid-gas process that consumes water, the annular liquid 250 passing through the pressure vessel 220 is make-up water that is later, separately, added to the system to replenish water that has been consumed during operation. Preferably but not exclusively, in the case that the cells or cell stack 210 is that of an electro-energy liquid-gas process, the annular liquid 250 is water that is produced by the cells or cell stack 210 during operation and that has earlier been separately removed from the system.

In another example aspect wherein the fluid surrounding the cell or cell stack 210 in the pressure vessel 220 is an annular gas 255, the annular gas 255 is, preferably but not exclusively, an inert gas such as nitrogen or argon in a suitably pure and dry form. Preferably but not exclusively, the annular gas 255 is continually, continuously, or periodically passed through, preferably slowly passed through, the annular space between the cell or cell stack 210 and the inner walls of the pressure vessel 220. That is, the annular gas 255 is passed through the space between the cell or cell stack 210 and one or more walls of the pressure vessel 220. Preferably but not exclusively, the annular gas 255 exiting the pressure vessel 220 at, for example, pipe 252, is continuously monitored to detect the presence of contaminant gases that may have escaped from the cell or cell stack 210 into the annular gas 255, thereby alerting the safety system of the balance of plant to the presence of a gas leak from the inside to the outside of the cell or cell stack 210. That is, optionally, the annular gas 255 exits the pressure vessel 220 and the exiting annular gas is monitored to detect a presence of one or more contaminant gases. Preferably but not exclusively, where a product of the electrochemical reaction is a gas that is output via one of the pipes 230 or 240, that product gas is monitored in the balance of plant for contamination by the above inert annular gas 255 to thereby alert the safety system to a gas leak from the outside to the inside of the cell or cell stack. Preferably but not exclusively, a condensate trap or similar liquid capture device is affixed to the bottom of the pressure vessel 220 or to the outlet 252 of the annular gas 255 from the pressure vessel, to thereby detect and capture liquid that may have leaked out of the cell or cell stack 220 into the annular gas 255. In this way, the safety system may be alerted to the presence of a leak of liquid from the inside to the outside of the cell or cell stack 210 into the annular gas 255. Moreover, such a leak may, thereby, also be restricted and contained within the condensate trap or liquid capture device. Optionally, the annular gas 255 is a reactant or product gas of the electrochemical reaction.

Preferably, the cell or cell stack 210 is capable of withstanding an internal-to-external pressure differential over its walls that is less than 0.1 bar, less than 0.15 bar, less than 0.2 bar, less than 0.3 bar, less than 0.4 bar, less than 0.5 bar, less than 0.75 bar, less than 1 bar, less than 1.5 bar, less than 2 bar, less than 3 bar, less than 4 bar, less than 5 bar, less than 7.5 bar, or less than 10 bar.

Preferably, the difference in pressure between the pressure of the annular liquid 250 or annular gas 255, and the pressure of the gases and/or liquids within the cell or cell stack 210 during operation, is less than 0.001 bar, less than 0.002 bar, less than 0.003 bar, less than 0.005 bar, less than 0.010 bar, less than 0.020 bar, less than 0.040 bar, less than 0.050 bar, less than 0.075 bar, less than 0.100 bar, less than 0.125 bar, less than 0.150 bar, less than 0.200 bar, less than 0.300 bar, less than 0.400 bar, less than 0.500 bar, less than 0.750 bar, less than 1 bar, less than 2 bar, less than 5 bar, less than 10 bar, or less than 20 bar.

The inventors have further recognised that, in the above arrangement, a body of gas may become trapped in the pressure vessel 220 when it is initially filled or during operation with an annular liquid 250, for example, by leakage of gas from the cells or cell stack 210. To remove such gas may require ullage in the pressure vessel, such as in the form of an expansion tank containing a liquid-gas interface.

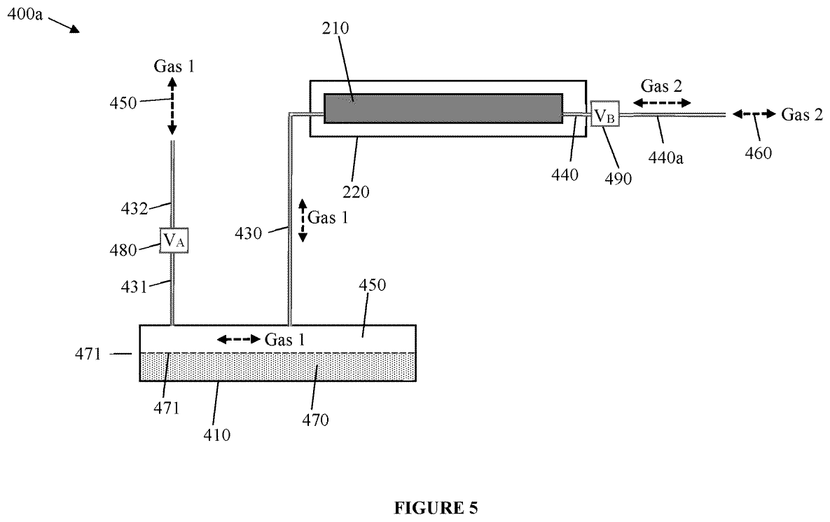

FIG. 4 schematically illustrates a system (i.e. process engineering arrangement) 300, wherein cells or cell stack 210, placed inside a pressure vessel 220, is surrounded by an annular liquid 250. The pressure vessel 220 surrounds the cell or cell stack 210. The annular liquid 250 may flow into the pressure vessel 220 via an inlet port 251 and out of the pressure vessel 220 via an outlet port 252. Liquid and gas pipes 230 and 240 from the cells or cell stack 210 penetrate the walls of the pressure vessel 220 and allow liquid and gas reactants and/or products to be delivered to/removed from the cell stack, including at pressure.

To this arrangement has been added an expansion volume/vessel 310, which contains a body of annular liquid 250 that is in fluid connection with the annular liquid 250 inside the pressure vessel 220. The annular liquid 250 in the expansion volume/vessel 310 has a level 320, above which is a headspace occupied by a gas 330. Preferably but not exclusively, the expansion volume/vessel 310 is located at a point on the pressure vessel 220 at which any gas in the annular liquid 250 within the pressure vessel 220 would accumulate. Preferably but not exclusively, the expansion volume/vessel 310 also provides for changes in the volume of the annular liquid 250 in the pressure vessel 220, around the cell stack 210, during, for example, temperature changes.

In a further example aspect, the annular liquid 250 within the pressure vessel 220 may be pressurised by the gas 330 within the attached expansion volume/vessel 310. Optionally, that gas 330 may be a gas produced by, or used by the cells or cell stack 210. In so doing, the annular liquid 250 is pressurised to, and/or has a pressure that will be comparable to the pressure of the gases and/or liquids within the cell stack 210 (provided only that, if there are more than one gas within the cell stack, they are maintained at near to equal pressures).

(1)(ii)(a) Gas Management: Gas Pressure Equalisation—Embodiment 1

In pressurised electro-synthetic or electro-energy liquid-gas cells involving two gas-phase reactants and/or products that are each present in bulk form within their own distinct and separate volumes within the cell or cell stack, techniques were devised to equalise (balance) their pressures and maintain them equal during operation. Process engineering configurations and methods were developed for improved equalisation or substantial equalisation of the gas pressures, including at high absolute pressures of each of the gases.

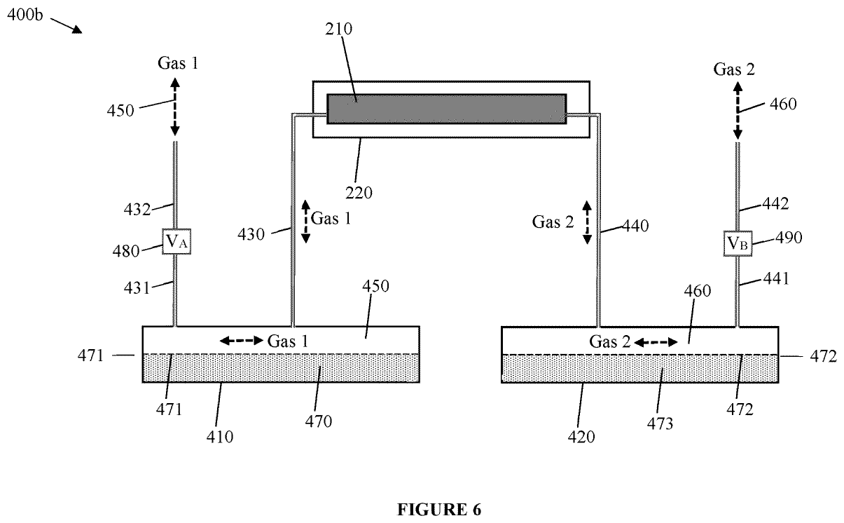

FIGS. 5 and 6 depict embodiments of such a gas pressure equalisation system 400. FIG. 5 depicts a first variant of the system 400a in which a single pressure equalisation tank is used, while FIG. 6 depicts a second variant 400b in which multiple pressure equalisation tanks are employed.

### Single Pressure Equalisation Tank

In FIG. 5: An electro-synthetic or electro-energy liquid-gas cell or cell stack 210, is, optionally, incorporated into or enclosed within a pressure vessel 220, that, optionally, includes an annular liquid 250 or annular gas 255 between the outer walls of the cell or cell stack 210 and the inner walls of the pressure vessel 220 (not shown in FIG. 5), as described in FIGS. 3-4 and associated description. The cell or cell stack 210 produces or consumes a first gas (gas 1) in bulk form within the cell or cell stack. The cell or cell stack 210 is configured to keep separate the first gas (gas 1) in bulk form within the cell or cell stack 210. Preferably, though not necessarily, the cell or cell stack 210 may produce or consume two different gases in bulk form within the cell or cell stack, namely, a first gas (gas 1) and a second gas (gas 2). In this particular example, the cell or cell stack 210 is configured to keep separate the first gas (gas 1) in bulk form from the second gas (gas 2) in bulk form within the cell or cell stack 210. Each gas occupies its own distinct and separate volume/s within the cell or cell stack 210. The first gas (gas 1) passes out of or into the cell or cell stack 210 via a first gas conduit 430 that connects to a first pressure equalisation tank 410, which contains, or at least partially contains, a first liquid 470 that partially fills the first pressure equalisation tank 410. The first headspace 450 of first pressure equalisation tank 410 is filled with the first gas (gas 1). First pressure equalisation tank 410 further has an exit/entry gas port 431 (or gas pipe or gas conduit) for the first gas (gas 1), along which is located, preferably but not exclusively, a first valve (V_{A}) 480 (being, for example, a backpressure valve or backpressure regulator) that controls the pressure of the first gas (gas 1) in the first pressure equalisation tank 410, as well as in the cell or cell stack 210 during operation.

The first gas (gas 1) passes out of or into the first pressure equalisation tank 410 via a first external gas conduit 432 (i.e. a first external gas pipe 432) that connects to the first pressure equalisation tank 410. Optionally, first external gas conduit 432 is connected to one side of valve (V_{A}) 480 and exit/entry gas port 431 is connected to the other side of first valve (V_{A}) 480.

Thus, there is provided a gas pressure equalisation system 400a for an electro-synthetic or electro-energy liquid-gas cell or cell stack 210, wherein the cell or cell stack 210 is configured to keep separate a first gas (gas 1) in bulk form within the cell or cell stack 210. In another example, preferably, the cell or cell stack 210 is configured to keep separate a first gas (gas 1) in bulk form from a second gas (gas 2) in bulk form within the cell or cell stack 210. The gas pressure equalisation system 400a comprises a first pressure equalisation tank 410 for at least partially containing a first liquid 470 having a liquid first level 471 and for partially containing the first gas (gas 1) in bulk form. The first gas (gas 1) is positioned above the liquid first level 471. A first gas conduit 430 is provided for transfer of the first gas (gas 1) in bulk form between the cell or cell stack 210 and the first pressure equalisation tank 410.

Preferably, the first pressure equalisation tank 410 is positioned below, underneath or under, preferably wholly below, underneath or under, the cell or cell stack 210, relative to gravity. Preferably, the first gas conduit 430 is positioned above a liquid first level 471. Preferably, the first gas conduit 430 is positioned at or near a top (i.e. a top surface) of the first pressure equalisation tank 410. In another example, the first gas is partially held in the first headspace 450 above the liquid first level 471 of the first liquid 470 in the first pressure equalisation tank 410. In another example, the first gas conduit 430 is positioned above the liquid first level 471. In another example, the first gas conduit 430 is positioned at the first headspace 450. In another example, the first gas conduit 430 is positioned at a top of the first pressure equalisation tank 410. In another example, the first exit/entry gas port 431 provided for the transfer of the first gas out of or into the first pressure equalisation tank 410 is positioned above the liquid first level 471. In one example, the first pressure equalisation tank 410 is partially filled with the first liquid 470. Preferably, the first gas (gas 1) is sparingly soluble in the first liquid 470.

The second gas (gas 2) is also present in bulk form within the cell or cell stack 210 and passes out of or into the cell or cell stack 210 via a second gas port 440 (or gas pipe or gas conduit) along which is, preferably but not exclusively, affixed a second valve (V_{B}) 490 (being, for example, a backpressure valve or regulator) that controls the pressure of the second gas (gas 2) in the cell or cell stack 210 during operation.

The gas pressure equalisation system 400a operates as follows. The pressures of the first gas (gas 1) and the second gas (gas 2) within the cell or cell stack are individually managed by the backpressure valves V_{A} and V_{B} respectively. Such management may be done manually or it may be done automatically, for example by a controlling PLC. The valves V_{A} and V_{B} may be iteratively and systematically opened or closed relative to each other to thereby bring the pressures of gas 1 and gas 2, respectively, into balance. That is, by iteratively and systematically opening or closing the valves V_{A} and V_{B}, relative to each other, the pressures of the first gas (gas 1) and the second gas (gas 2), respectively, may be equalised or substantially equalised during operation of the electro-synthetic or electro-energy cell or cell stack.

Thus, there is provided a method of operating a gas pressure equalisation system 400a for an electro-synthetic or electro-energy liquid-gas cell or cell stack 210. The method comprising operating the cell or cell stack 210 to produce or consume a first gas (gas 1), wherein the cell or cell stack 210 is configured to keep separate the first gas (gas 1) in bulk form within the cell or cell stack 210. In another example, the method comprising operating the cell or cell stack 210 to produce or consume a first gas (gas 1) and to produce or consume a second gas (gas 2), wherein the cell or cell stack 210 is configured to keep separate the first gas (gas 1) in bulk form from the second gas (gas 2) in bulk form within the cell or cell stack 210. The method also comprising the first gas (gas 1) flowing, in bulk form, into or out of a first pressure equalisation tank 410 via a first gas conduit 430. The first pressure equalisation tank 410 at least partially containing a first liquid 470 having a liquid first level 471, and the first gas (gas 1) positioned above the liquid first level 471. In one example, the first liquid 470 has a substantially constant density during operation. In another example, the first liquid 470 is free, or substantially free, of gas bubbles during operation. Preferably, the first liquid 470 does not enter the cell or cell stack 210 during operation. Optionally, the first liquid 470 is the same as a liquid electrolyte of an electrochemical reaction occurring in the cell or cell stack 210. Optionally, a pressure of the first liquid 470 in the first pressure equalisation tank 410 is substantially equalised with a pressure of the liquid electrolyte in the cell or cell stack 210. Optionally, the method includes including adjusting the pressure of the first gas (gas 1) in the first pressure equalisation tank 410 to maintain the liquid first level 471 at a height.

The inventors have surprisingly found that the headspace 450 of the first pressure equalisation tank 410 may act as or provide a buffer volume that makes it significantly easier to equalise or substantially equalise the pressures of the first gas (gas 1) and the second gas (gas 2) within the cell or cell stack during operation. Moreover, the presence of the headspace 450 in the first pressure equalisation tank 410 may also make such equalisation or substantial equalisation: more ready, more reliable, more stable (over time), and/or more rapidly achieved.

Furthermore, if the first liquid 470 in the first pressure equalisation tank 410 also comprises the liquid electrolyte that is circulated into and employed in the cell or cell stack 210, then that liquid electrolyte will have the same or substantially the same pressure as the first gas (gas 1) and the second gas (gas 2) following their equalisation or substantial equalisation.

Accordingly, the approach described above provides a means with which to equalise or substantially equalise the pressures of all of the separate and distinct bulk gases (gas 1 and gas 2), as well as to equalise the pressure of the liquid electrolyte (470) within the cell or cell stack 210.

Moreover, pressure is directly transmitted to the inter-electrode separator membranes/ionomers by the gas(es), i.e. the first gas (gas 1) and the second gas (gas 2), and not via columns of intermingled, two-phase mixtures of liquid electrolyte and gas of the type found in conventional electrolysers (and described in FIG. 1 and associated text). High gas crossover due to fluctuating and transient pressure differentials across the separators is thereby avoided.

### Multiple Pressure Equalisation Tanks

FIG. 6 depicts a variation on the above embodiment that employs more than one pressure equalisation tank, for example it may employ a separate pressure equalisation tank for each bulk gas present within the cell or cell stack.

In FIG. 6: An electro-synthetic or electro-energy liquid-gas cell or cell stack 210, is, optionally, incorporated into or enclosed within a pressure vessel 220, that, optionally, includes an annular liquid 250 or annular gas 255 between the outer walls of the cell or cell stack 210 and the inner walls of the pressure vessel 220 (not shown in FIG. 6), as described in FIGS. 3-4 and associated description. The cell or cell stack 210 produces or consumes two different gases in bulk form within the cell or cell stack, namely, gas 1 (i.e. a first gas) and gas 2 (i.e. a second gas). Each gas occupies its own distinct and separate volume/s within the cell or cell stack 210. Gas 1 (in bulk form) passes out of or into the cell or cell stack 210 via a first gas conduit 430 that connects to a first pressure equalisation tank 410 for gas 1 (i.e. the first gas). Gas 2 (in bulk form) passes out of or into the cell or cell stack 210 via a second gas conduit 440 that connects to a second pressure equalisation tank 420 for gas 2 (i.e. the second gas). The first pressure equalisation tank 410 contains, or at least partially contains, a first liquid 470 that partially fills the first pressure equalisation tank 410, and the second pressure equalisation tank 420 contains, or at least partially contains, a second liquid 473 that partially fills the second pressure equalisation tank 420. Optionally, the first liquid 470 can be a different liquid to the second liquid 473, or the first liquid 470 can be the same liquid as the second liquid 473. Preferably, though not necessarily, the first liquid 470 in the first pressure equalisation tank 410 is the same liquid as the second liquid 473 in the second pressure equalisation tank 420. Optionally, the first liquid 470 in the first pressure equalisation tank 410 is a different liquid to the second liquid 473 in the second pressure equalisation tank 420. The first pressure equalisation tank 410 thus at least partially contains the first liquid 470 having a liquid first level 471 and partially contains the first gas (gas 1) in bulk form. The second pressure equalisation tank 420 thus at least partially contains the second liquid 473 having a liquid second level 472 and partially contains the second gas (gas 2) in bulk form.

Preferably, gas 1 (i.e. the first gas) passing into or out of first pressure equalisation tank 410, flows through the first headspace 450 above the liquid first level 471 of first liquid 470 in first pressure equalisation tank 410. Preferably, gas 2 (i.e. the second gas) passing into or out of second pressure equalisation tank 420, flows through the second headspace 460 above the liquid second level 472 of second liquid 473 in second pressure equalisation tank 420. The liquid first level 471 and the liquid second level 472 in each pressure equalisation tank 410 and 420, respectively, are, preferably, clear and well-defined (given that, for example, there are no gas bubbles within the first liquid 470 or second liquid 473). First pressure equalisation tank 410 has a first exit/entry gas port 431 (or gas pipe or gas conduit) for gas 1, to which is, optionally, affixed a first valve (V_{A}) 480 that controls the pressure of gas 1 in the first pressure equalisation tank 410, the gas conduit 430, and within the cell or cell stack 210 during operation. Gas 1 passes out of or into the first pressure equalisation tank 410 via a first external gas conduit 432 (i.e. a first external gas pipe 432) that connects to the first pressure equalisation tank 410 for gas 1 (i.e. the first gas). Optionally, first external gas conduit 432 is connected to one side of first valve (V_{A}) 480 and first exit/entry gas port 431 is connected to the other side of first valve (V_{A}) 480. Second pressure equalisation tank 420 has a second exit/entry gas port 441 (or gas pipe or gas conduit) for gas 2, to which is, optionally, affixed a second valve (V_{B}) 490 that controls the pressure of gas 2 in the second pressure equalisation tank 420, the gas conduit 440, and the cell stack 210 during operation. Gas 2 passes out of or into the second pressure equalisation tank 420 via a second external gas conduit 442 (i.e. a second external gas pipe 442) that connects to the second pressure equalisation tank 420 for gas 2 (i.e. the second gas). Optionally, second external gas conduit 442 is connected to one side of second valve (V_{B}) 490 and second exit/entry gas port 441 is connected to the other side of second valve (V_{B}) 490. In examples where first valve (V_{A}) 480 and/or second valve (V_{B}) 490 are not used, then first external gas conduit 432 and first exit/entry gas port 431 can be a single continuous gas conduit, pipe or line (i.e. a first external gas pipe) and/or second external gas conduit 442 and second exit/entry gas port 441 can be a single continuous gas conduit, pipe or line (i.e. a second external gas pipe).

Preferably, the first gas conduit 430 is positioned above the liquid first level 471. Preferably, the first gas conduit 430 is positioned at or near a top (i.e. a top surface) of the first pressure equalisation tank 410. Preferably, the second gas conduit 440 is positioned above the liquid second level 472. Preferably, the second gas conduit 440 is positioned at or near a top (i.e. a top surface) of the second pressure equalisation tank 420. Preferably, the first pressure equalisation tank 410 and the second pressure equalisation tank 420 are positioned below, underneath or under, preferably wholly below, underneath or under, the cell or cell stack 210, relative to gravity. In another example, the first gas is partially held in a first headspace above the liquid first level 471 of the first liquid 470 in the first pressure equalisation tank. In another example, the first gas conduit 430 is positioned above the liquid first level 471. In another example, the first gas conduit 430 is positioned at the first headspace 450. In another example, the first gas conduit 430 is positioned at a top of the first pressure equalisation tank 410. In another example, the first exit/entry gas port 431 provided for the transfer of the first gas out of or into the first pressure equalisation tank 410 is positioned above the liquid first level 471. In another example, the second gas is partially held in a second headspace 460 above the liquid second level 472 of the second liquid 473 in the second pressure equalisation tank 420. In another example, the second gas conduit 440 is positioned above the liquid second level 472. In another example, the second gas conduit 440 is positioned at the second headspace 460. In another example, the second gas conduit 440 is positioned at a top of the second pressure equalisation tank 420. In another example, the second exit/entry gas port 441 provided for the transfer of the second gas out of or into the second pressure equalisation tank 420 is positioned above the liquid second level 472. Preferably, the first gas (gas 1) is sparingly soluble in the first liquid 470 and/or the second gas (gas 2) is sparingly soluble in the second liquid 473.

The gas pressure equalisation system 400b in FIG. 6 operates as follows. The pressures of the first gas (gas 1) and the second gas (gas 2) within the cell or cell stack are individually managed by the backpressure valves V_{A} and V_{B} respectively. Such management may be done manually or it may be done automatically, for example by a controlling PLC. The valves V_{A} and V_{B} may be iteratively and systematically opened or closed relative to each other to thereby bring the pressures of gas 1 and gas 2, respectively, into balance. That is, by iteratively and systematically opening or closing the valves V_{A} and V_{B}, relative to each other, the pressures of the first gas (gas 1) and the second gas (gas 2), respectively, may be equalised or substantially equalised during operation of the electro-synthetic or electro-energy cell or cell stack.

Thus, there is provided a method of operating a gas pressure equalisation system 400b for an electro-synthetic or electro-energy liquid-gas cell or cell stack 210. The method comprising operating the cell or cell stack 210 to produce or consume a first gas (gas 1) and a second gas (gas 2), wherein the cell or cell stack 210 is configured to keep separate the first gas (gas 1) in bulk form from the second gas (gas 2) in bulk form within the cell or cell stack 210. The method also comprising the first gas (gas 1) flowing, in bulk form, into or out of a first pressure equalisation tank 410 via a first gas conduit 430. The first pressure equalisation tank 410 at least partially containing a first liquid 470 having a liquid first level 471, and the first gas (gas 1) positioned above the liquid first level 471. Additionally, the method includes the second gas (gas 2) flowing, in bulk form, into or out of a second pressure equalisation tank 420 via a second gas conduit 440, the second pressure equalisation tank 420 at least partially containing a second liquid 473 having a liquid second level 472, the second gas (gas 2) positioned above the liquid second level 472. In one example, the first liquid 470 and the second liquid 473 (should it be a different liquid) have a substantially constant density during operation. In another example, the first liquid 470 and the second liquid 473 are free, or substantially free, of gas bubbles during operation. Preferably, the first liquid 470 and the second liquid 473 do not enter the cell or cell stack 210 during operation. Optionally, the first liquid 470 and/or the second liquid 473 are the same as a liquid electrolyte of an electrochemical reaction occurring in the cell or cell stack 210. Optionally, a pressure of the first liquid 470 in the first pressure equalisation tank 410 and/or a pressure of the second liquid 473 in the second pressure equalisation tank 420 are substantially equalised with a pressure of the liquid electrolyte in the cell or cell stack 210. Optionally, the method includes including adjusting the pressure of the first gas (gas 1) in the first pressure equalisation tank 410 to maintain the liquid first level 471 at a first height, and/or adjusting the pressure of the second gas (gas 2) in the second pressure equalisation tank 420 to maintain the liquid second level 472 at a second height. Preferably, though not necessarily, the first height is equal or substantially equal to the second height, or the liquid first level 471 is equal or substantially equal to the liquid second level 472. Optionally, the first height is different to the second height, or the liquid first level 471 is different to the liquid second level 472.

The inventors have surprisingly found that the headspace 450 of the first pressure equalisation tank 410 and the headspace 460 of the second pressure equalisation tank 420 may act as or provide buffer volumes that make it significantly easier to equalise or substantially equalise the pressures of the first gas (gas 1) and the second gas (gas 2) within the cell or cell stack during operation. Moreover, the presence of the headspace 450 in the first pressure equalisation tank 410 and the headspace 460 of the second pressure equalisation tank 420 may also make such equalisation or substantial equalisation: more ready, more reliable, more stable (over time), and/or more rapidly achieved.

Furthermore, if the first liquid 470 in the first pressure equalisation tank 410 and the second liquid 473 in the second pressure equalisation tank 420 also comprises the liquid electrolyte that is circulated into and employed in the cell or cell stack 210, then that liquid electrolyte will have the same or substantially the same pressure as the first gas (gas 1) and the second gas (gas 2) following their equalisation or substantial equalisation.

Accordingly, the approach described above provides a means with which to equalise or substantially equalise the pressures of all of the separate and distinct bulk gases (gas 1 and gas 2) as well as to equalise the pressure of the liquid electrolyte within the cell or cell stack 210.

Moreover, pressure is directly transmitted to the inter-electrode separator membranes/ionomers by the gas(es), i.e. the first gas (gas 1) and the second gas (gas 2), and not via columns of intermingled, two-phase mixtures of liquid electrolyte and gas of the type found in conventional electrolysers (and described in FIG. 1 and associated text). High gas crossover due to fluctuating and transient pressure differentials across the separators is thereby avoided.

It is to be understood however, that different liquids 470, 473 may be used in the first and second pressure equalisation tanks 410, 420 and that one or both of those liquids 470, 473 may not be the same as the liquid electrolyte used in the cell or cell stack.

(1)(ii)(b) Gas Management: Gas Pressure Equalisation—Embodiment 2

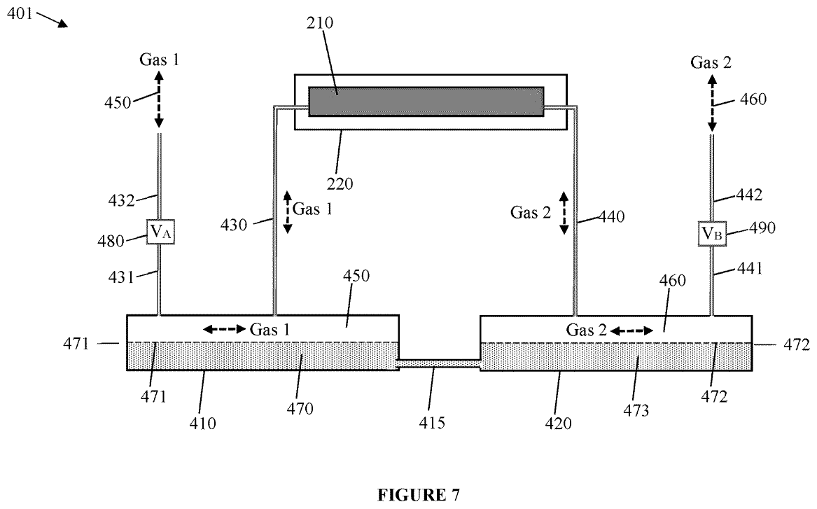

FIG. 7 depicts a further embodiment of a gas pressure equalisation system 401.

An electro-synthetic or electro-energy liquid-gas cell or cell stack 210, is, optionally, incorporated into or enclosed within a pressure vessel 220, that, optionally, includes an annular liquid 250 or annular gas 255 between the outer walls of the cell or cell stack 210 and the inner walls of the pressure vessel 220 (not shown in FIG. 7), as described in FIGS. 3-4 and associated description. The cell or cell stack 210 produces or consumes two different gases in bulk form within the cell or cell stack, namely, gas 1 (i.e. a first gas) and gas 2 (i.e. a second gas). Each gas occupies its own distinct and separate volume/s within the cell or cell stack 210. Gas 1 (in bulk form) passes out of or into the cell or cell stack 210 via a first gas conduit 430 that connects to a first pressure equalisation tank 410 for gas 1 (i.e. the first gas). Gas 2 (in bulk form) passes out of or into the cell or cell stack 210 via a second gas conduit 440 that connects to a second pressure equalisation tank 420 for gas 2 (i.e. the second gas). The first pressure equalisation tank 410 contains, or at least partially contains, a first liquid 470 that partially fills the first pressure equalisation tank 410, and the second pressure equalisation tank 420 contains, or at least partially contains, a second liquid 473 that partially fills the second pressure equalisation tank 420. In this example the first liquid 470 is preferably the same as the second liquid 473 (though not necessarily so). The first pressure equalisation tank 410 and the second pressure equalisation tank 420 are in fluid communication with each other via a ‘connecting pipe’ 415 that is also filled with first liquid 470/second liquid 473 (i.e. the same liquid in a preferred example). The connecting pipe 415 allows for transfer of the first liquid 470 or the second liquid 473 flowing between the first pressure equalisation tank 410 and the second pressure equalisation tank 420 via the connecting pipe 415.

Preferably, connecting pipe 415 is a relatively large diameter connecting pipe. Preferably, in operation, the connecting pipe is completely filled with first liquid 470/second liquid 473; this ensures that the connecting pipe 415 does not allow the first gas or the second gas to transfer to a different pressure equalisation tank. The headspace 450 of the first pressure equalisation tank 410 is therefore filled only with the first gas (gas 1), while the headspace 460 of the second pressure equalisation tank 420 is filled only with the second gas (gas 2). The ends of connecting pipe 415 are positioned at or near the bottom of each pressure equalisation tank. That is, connecting pipe 415 for transferring the first liquid 470/second liquid 473 is positioned at or near a bottom (i.e. a bottom surface) of the first pressure equalisation tank 410 and at or near a bottom (i.e. a bottom surface) of the second pressure equalisation tank 420. First liquid 470 from first pressure equalisation tank 410 may readily pass along connecting pipe 415 into second pressure equalisation tank 420, and vice versa. Preferably, the connecting pipe 415 is configured to be filled with first liquid 470/second liquid 473 during operation. Being a liquid, or different liquids in some examples, the first liquid 470 in the first pressure equalisation tank 410, the second liquid 473 in the second pressure equalisation tank 420, and first liquid 470/second liquid 473 (which may be the same liquid) in the connecting pipe 415, has an invariant density and the liquid(s) is (are) essentially incompressible under operational conditions; the liquid(s) is (are) free of, for example, gas bubbles that may induce changeability in the liquid(s) density and compressibility. This quality provides for improved gas equalisation characteristics (as described below).

Preferably but not exclusively, first pressure equalisation tank 410 and second pressure equalisation tank 420 are positioned or located at a level (i.e. at a height or at a position) below (i.e. underneath or under) the level of the cell or cell stack 210 relative to gravity; that is, the first pressure equalisation tank 410 and the second pressure equalisation tank 420 are ‘infra’-tanks, being positioned below (i.e. underneath or under) the level of the cell or cell stack 210. Preferably, the first pressure equalisation tank 410 and the second pressure equalisation tank 420 are positioned wholly below, underneath or under the cell or cell stack 210, relative to gravity. For example, first pressure equalisation tank 410 is a first pressure equalisation infra-tank, and second pressure equalisation tank 420 is a second pressure equalisation infra-tank. Preferably but not exclusively, first pressure equalisation tank 410 is positioned completely below cell or cell stack 210 relative to gravity. Preferably but not exclusively, second pressure equalisation tank 420 is positioned completely below cell or cell stack 210 relative to gravity. Preferably, the first gas conduit 430 is positioned above the liquid first level 471. Preferably, the first gas conduit 430 is positioned at or near a top (i.e. a top surface) of the first pressure equalisation tank 410. Preferably, the second gas conduit 440 is positioned above the liquid second level 472. Preferably, the second gas conduit 440 is positioned at or near a top (i.e. a top surface) of the second pressure equalisation tank 420.

Preferably, gas 1 (i.e. the first gas) passing into or out of first pressure equalisation tank 410, flows through the first headspace 450 above the liquid first level 471 of first liquid 470 in first pressure equalisation tank 410. Preferably, gas 2 (i.e. the second gas) passing into or out of second pressure equalisation tank 420, flows through the second headspace 460 above the liquid second level 472 of second liquid 473 in second pressure equalisation tank 420. The liquid first level 471 and the liquid second level 472 in each pressure equalisation tank 410 and 420, respectively, are, preferably, clear and well-defined (given that there are no gas bubbles within the first liquid 470 or the second liquid 473). First pressure equalisation tank 410 has a first exit/entry gas port 431 (or gas pipe or gas conduit) for gas 1, to which is, optionally, affixed a first valve (V_{A}) 480 that controls the pressure of gas 1 in the first pressure equalisation tank 410, the gas conduit 430, and within the cell or cell stack 210 during operation. Gas 1 passes out of or into the first pressure equalisation tank 410 via a first external gas conduit 432 (i.e. a first external gas pipe 432) that connects to the first pressure equalisation tank 410 for gas 1 (i.e. the first gas). Optionally, first external gas conduit 432 is connected to one side of first valve (V_{A}) 480 and first exit/entry gas port 431 is connected to the other side of first valve (V_{A}) 480. Second pressure equalisation tank 420 has a second exit/entry gas port 441 (or gas pipe or gas conduit) for gas 2, to which is, optionally, affixed a second valve (V_{B}) 490 that controls the pressure of gas 2 in the second pressure equalisation tank 420, the gas conduit 440, and the cell stack 210 during operation. Gas 2 passes out of or into the second pressure equalisation tank 420 via a second external gas conduit 442 (i.e. a second external gas pipe 442) that connects to the second pressure equalisation tank 420 for gas 2 (i.e. the second gas). Optionally, second external gas conduit 442 is connected to one side of second valve (V_{B}) 490 and second exit/entry gas port 441 is connected to the other side of second valve (V_{B}) 490. In examples where first valve (V_{A}) 480 and/or second valve (V_{B}) 490 are not used, then first external gas conduit 432 and first exit/entry gas port 431 can be a single continuous gas conduit, pipe or line (i.e. a first external gas pipe) and/or second external gas conduit 442 and second exit/entry gas port 441 can be a single continuous gas conduit, pipe or line (i.e. a second external gas pipe).

Thus, in this embodiment there is provided a gas pressure equalisation system 401 for an electro-synthetic or electro-energy liquid-gas cell or cell stack 210. The gas pressure equalisation system 401 comprises a first pressure equalisation tank 410 for at least partially containing a first liquid 470 having a liquid first level 471 and for partially containing a first gas. The first gas is positioned in a headspace 450 above the liquid first level 471. A first gas conduit 430 is provided for the transfer of the first gas in bulk form between the cell or cell stack 210 and the first pressure equalisation tank 410. A second pressure equalisation tank 420 is provided for at least partially containing the second liquid 473 (which in this example is preferably the same as first liquid 470, though not necessarily) having a liquid second level 472 and for partially containing a second gas, the second gas positioned in a headspace 460 above the liquid second level 472. A second gas conduit 440 is provided for the transfer of the second gas in bulk form between the cell or cell stack 210 and the second pressure equalisation tank 420. A connecting pipe 415 is provided for the transfer of the first liquid 470/second liquid 473 between the first pressure equalisation tank 410 and the second pressure equalisation tank 420. The first pressure equalisation tank 410 and the second pressure equalisation tank 420 are positioned below the cell or cell stack 210. The first pressure equalisation tank 410 thus at least partially contains the first liquid 470 having a liquid first level 471 and partially contains the first gas (gas 1) in bulk form. The second pressure equalisation tank 420 thus at least partially contains the second liquid 473 having a liquid second level 472 and partially contains the second gas (gas 2) in bulk form. Preferably, though not necessarily, the first liquid 470 in the first pressure equalisation tank 410 is the same liquid as the second liquid 473 in the second pressure equalisation tank 420.

Preferably, the connecting pipe 415 is positioned below, and preferably wholly or completely below, the liquid first level 471 and the liquid second level 472. In one example, the connecting pipe 415 is positioned at or near a bottom of the first pressure equalisation tank 410 and at or near a bottom of the second pressure equalisation tank 420. In another example, the connecting pipe 415 is wholly filled with first liquid 470/second liquid 473 during operation. In another example, the first gas is partially held in a first headspace above the liquid first level 471 of the first liquid 470 in the first pressure equalisation tank. In another example, the first gas conduit 430 is positioned above the liquid first level 471. In another example, the first gas conduit 430 is positioned at the first headspace 450. In another example, the first gas conduit 430 is positioned at a top of the first pressure equalisation tank 410. In another example, the first exit/entry gas port 431 provided for the transfer of the first gas out of or into the first pressure equalisation tank 410 is positioned above the liquid first level 471. In another example, the second gas is partially held in a second headspace 460 above the liquid second level 472 of the second liquid 473 in the second pressure equalisation tank 420. In another example, the second gas conduit 440 is positioned above the liquid second level 472. In another example, the second gas conduit 440 is positioned at the second headspace 460. In another example, the second gas conduit 440 is positioned at a top of the second pressure equalisation tank 420. In another example, the second exit/entry gas port 441 provided for the transfer of the second gas out of or into the second pressure equalisation tank 420 is positioned above the liquid second level 472. In another example, the first pressure equalisation tank 410 is partially filled with the first liquid 470 and the second pressure equalisation tank 420 is partially filled with the second liquid 473, preferably where the first liquid 470 is the same as the second liquid 473. In another example, the first liquid 470 or the second liquid 473 flowing between the first pressure equalisation tank 410 and the second pressure equalisation tank 420 via the connecting pipe 415 when a pressure of the first gas (gas 1) in the first pressure equalisation tank 410 is different to a pressure of the second gas (gas 2) in the second pressure equalisation tank 420.

### Operation

The gas pressure equalisation system 401 in FIG. 7 operates as follows. If the pressure of gas 1 (the first gas) exceeds that of gas 2 (the second gas), then gas 1 will force first liquid 470 to flow out of first pressure equalisation tank 410 into second pressure equalisation tank 420 via connecting pipe 415. In so doing, liquid first level 471 in first pressure equalisation tank 410 will decline, increasing the volume of and decreasing the pressure of gas 1, while liquid second level 472 in second pressure equalisation tank 420 will rise, decreasing the volume of and increasing the pressure of gas 2. First liquid 470 will flow between the first pressure equalisation tank 410 and the second pressure equalisation tank 420 until the pressures of gas 1 and gas 2 are equal, at which stage liquid flow between the first pressure equalisation tank 410 and the second pressure equalisation tank 420 will cease.

Similarly, if the pressure of gas 2 (the second gas) exceeds that of gas 1 (the first gas), then gas 2 will force second liquid 473 to flow out of second pressure equalisation tank 420 into first pressure equalisation tank 410 via connecting pipe 415. In so doing, liquid second level 472 in second pressure equalisation tank 420 will decline, increasing the volume of and decreasing the pressure of gas 2, while liquid first level 471 in first pressure equalisation tank 410 will rise, decreasing the volume of and increasing the pressure of gas 1. Second liquid 473 will flow between the second pressure equalisation tank 420 and the first pressure equalisation tank 410 until the pressures of gas 1 and gas 2 are equal, at which stage liquid flow between second pressure equalisation tank 420 and first pressure equalisation tank 410 will cease.

Having both the first pressure equalisation tank 410 and the second pressure equalisation tank 420 positioned or located below the level of the cells and/or cell stack 210—i.e. as ‘infra’-tanks—facilitates the operation of the system 401. Minimising the number of turns in first gas conduit 430 and second gas conduit 440 also minimises any pressure difference in the pressures of: (i) gas 1 and gas 2 in the first pressure equalisation tank 410 and the second pressure equalisation tank 420, and (ii) the pressures of gas 1 and gas 2, each in bulk form, within the cell or cell stack 210, respectively.

Accordingly, this arrangement provides a passive but automatic means of equalising the pressures of gas 1 and gas 2 at any point in time. That is, pressure differentials between the pressure of gas 1 and the pressure of gas 2 in the first headspace 450 and the second headspace 460 respectively, are spontaneously compensated by flows of the first liquid 470/second liquid 473 between the first pressure equalisation tank 410 and the second pressure equalisation tank 420 until the pressures of gas 1 and gas 2 are equal or substantially equal.

The absolute pressures of the first gas (gas 1) and the second gas (gas 2) within the cell or cell stack may be changed by adjusting the backpressure valves V_{A} and V_{B} respectively, however the passive pressure balancing provided the above system will thereafter see their pressures spontaneously equilibrate. Such adjustments of the backpressure valves V_{A} and V_{B} may be done manually or may be done automatically, for example by a controlling PLC. The valves V_{A} and V_{B} may be iteratively and systematically opened or closed relative to each other to thereby change the pressures of gas 1 or gas 2, respectively. That is, by iteratively and systematically opening or closing the valves V_{A} and V_{B}, relative to each other, the pressures of the first gas (gas 1) and the second gas (gas 2), respectively, may be changed, however they will thereafter be spontaneously equalised or substantially equalised by the above passive equalisation system. Such adjustments may be carried out during operation of the electro-synthetic or electro-energy cell or cell stack.

Preferably, the first liquid 470 and the second liquid 473 in the first pressure equalisation tank 410 and second pressure equalisation tank 420, respectively, have a large surface area at the liquid-gas interfaces at liquid first level 471 and liquid second level 472 respectively, relative to the volume of their respective gases in the cell or cell stack 210 and the remainder of the balance-of-plant, to thereby provide for more rapid equilibration of the gas pressures. The larger the surface area of the gas-liquid interfaces at liquid first level 471 and liquid second level 472, relative to the volume of their respective gases, the smaller the rise and fall of each of liquid first level 471 and liquid second level 472 that will be needed to equilibrate the pressures of gas 1 and gas 2 and the faster the equilibration action. Preferably, the first liquid 470 and the second liquid 473 in first pressure equalisation tank 410 and second pressure equalisation tank 420, respectively, have a large volume relative to the volume of its corresponding gas, gas 1 and gas 2, in the cell or cell stack 210 and the remainder of the balance-of-plant, to thereby provide for equilibration of even large gas pressure differentials. For example, the volume of the first liquid 470 in the first pressure equalisation tank 410 is larger than the volume of the first gas in the cell or cell stack 210 and the first headspace 450 and the first gas conduit 430. Similarly, for example, the volume of the second liquid 473 in the second pressure equalisation tank 420 is larger than the volume of the second gas in the cell or cell stack 210 and the second headspace 460 and the second gas conduit 440. The larger the volume of the first liquid 470 and the second liquid 473 in first pressure equalisation tank 410 and second pressure equalisation tank 420, respectively, relative to the volume of their respective gases, the smaller the rise and fall of each of liquid first level 471 and liquid second level 472 that will be needed to equilibrate the pressures of gas 1 and gas 2 and the faster the equilibration action.

Moreover, if the first liquid 470 in the first pressure equalisation tank 410 and the second liquid 473 in the second pressure equalisation tank 420 each also comprises the liquid electrolyte that is circulated into and employed in the cell or cell stack 210, then that liquid electrolyte will have the same or substantially the same pressure as the first gas (gas 1) and the second gas (gas 2) following their equalisation or substantial equalisation.

Accordingly, the approach described above provides a means with which to equalise or substantially equalise the pressures of all of the separate and distinct bulk gases (gas 1 and gas 2) as well as equalise the pressure of the liquid electrolyte within the cell or cell stack 210.

It should be noted that in system 401, pressure is transmitted directly to the inter-electrode separator membranes/ionomers by the gas(es), i.e. the first gas and the second gas, and not via columns of intermingled, two-phase mixtures of liquid electrolyte and gas of the type found in conventional electrolysers (and described in FIG. 1 and associated text). High gas crossover due to fluctuating and transient pressure differentials across the separators is thereby avoided.

It should further be noted that system 401 in FIG. 7 may easily be configured to be converted into a system of the type 400a in FIG. 5 or the type 400b in FIG. 6, by simply including a flow valve in connecting pipe 415. Closure of that flow valve to thereby halt liquid movement between tanks 410 and 420, will then cause the system to be transformed into a system of type 400b in FIG. 6. Moreover, closure of that flow valve and removal of the second liquid 473 in tank 420 will cause the system to be transformed into a system of type 400a in FIG. 5. Accordingly, a single engineering arrangement can be used to enable all three of the above systems.

### Method of Operation

In another example there is provided a method of operating the gas pressure equalisation system including operating the electro-synthetic or electro-energy liquid-gas cell or cell stack to produce or consume the first gas or the second gas. If a pressure of the first gas exceeds a pressure of the second gas, wherein the first gas and the second gas are each in bulk form: allowing a first liquid to flow out of the first pressure equalisation tank and into the second pressure equalisation tank via the connecting pipe; allowing the liquid first level in the first pressure equalisation tank to decline, thereby decreasing the pressure of the first gas; allowing the liquid second level in the second pressure equalisation tank to rise, thereby increasing the pressure of the second gas; and, allowing the first liquid to flow until the pressure of the first gas and the pressure of the second gas are equal, after when the first liquid ceases to flow.

If a pressure of the second gas exceeds a pressure of the first gas, wherein the first gas and the second gas are each in bulk form: allowing a second liquid (which may be the same liquid as the first liquid) to flow out of the second pressure equalisation tank and into the first pressure equalisation tank via the connecting pipe; allowing the liquid second level in the second pressure equalisation tank to decline, thereby decreasing the pressure of the second gas; allowing the liquid first level in the first pressure equalisation tank to rise, thereby increasing the pressure of the first gas; and, allowing the second liquid to flow until the pressure of the second gas and the pressure of the first gas are equal, after which the liquid ceases to flow. Preferably, the first liquid and/or second liquid has a substantially constant density during operation. In another example, the first liquid and/or second liquid is free of gas bubbles during operation. In another example, the first liquid and/or second liquid does not enter the cell or cell stack during operation.

In another example embodiment there is provided a method of operating a gas pressure equalisation system 401 for an electro-synthetic or electro-energy liquid-gas cell or cell stack 210. The method comprising the steps of operating the electro-synthetic or electro-energy liquid-gas cell or cell stack 401 to produce or consume a first gas and a second gas. The first gas flowing into or out of a first pressure equalisation tank 410 via a first gas conduit 430. The first pressure equalisation tank 410 at least partially containing a first liquid 470 having a liquid first level 471, the first gas positioned above the liquid first level 471. The second gas flowing into or out of a second pressure equalisation tank 420 via a second gas conduit 440. The second pressure equalisation tank 420 at least partially containing a second liquid 473 having a liquid second level 472, the second gas positioned above the liquid second level 472. The first liquid 470/second liquid 473, which can be the same liquid, flowing between the first pressure equalisation tank 410 and the second pressure equalisation tank 420 via a connecting pipe 415 when a pressure of the first gas in the first pressure equalisation tank 410 is different to a pressure of the second gas in the second pressure equalisation tank 420. Preferably, the connecting pipe 415 is positioned below the liquid first level 471 and the liquid second level 472 during operation.

If a pressure of the first gas in the first pressure equalisation tank exceeds a pressure of the second gas in the second pressure equalisation tank: the first liquid flows out of the first pressure equalisation tank into the second pressure equalisation tank via the connecting pipe; the liquid first level in the first pressure equalisation tank declines, thereby decreasing the pressure of the first gas; the liquid second level in the second pressure equalisation tank rises, thereby increasing the pressure of the second gas; and, the first liquid flows until the pressure of the first gas and the pressure of the second gas are equal.

If a pressure of the second gas in the second pressure equalisation tank exceeds a pressure of the first gas in the first pressure equalisation tank: the second liquid flows out of the second pressure equalisation tank into the first pressure equalisation tank via the connecting pipe; the liquid second level in the second pressure equalisation tank declines, thereby decreasing the pressure of the second gas; the liquid first level in the first pressure equalisation tank rises, thereby increasing the pressure of the first gas; and, the second liquid flows until the pressure of the second gas and the pressure of the first gas are equal.

In one example, the first liquid and/or second liquid flows spontaneously depending on any pressure difference between the pressure of the first gas in the first pressure equalisation tank and the pressure of the second gas in the second pressure equalisation tank. Another example includes adjusting the pressure of the first gas in the first pressure equalisation tank and/or adjusting the pressure of the second gas in the second pressure equalisation tank to maintain the liquid first level and the liquid second level at an equal height. In another example, the first exit/entry gas port for transfer of the first gas out of or into the first pressure equalisation tank is positioned above the liquid first level, and a first valve is connected to the first exit/entry gas port, and operating the first valve adjusts the pressure of the first gas in the first pressure equalisation tank to change a height of the liquid first level. In another example, the second exit/entry gas port for transfer of the second gas out of or into the second pressure equalisation tank is positioned above the liquid second level, a second valve is connected to the second exit/entry gas port, and operating the second valve adjusts the pressure of the second gas in the second pressure equalisation tank to change a height of the liquid second level.

In another example, the first valve and/or the second valve can be automatically operated using one or more Programmable Logic Controllers. The one or more Programmable Logic Controllers can also monitor the height of the liquid first level and the height of the liquid second level using one or more sensors. The pressure of the first gas and the pressure of the second gas can be maintained at a fixed differential pressure by maintaining the liquid first level and the liquid second level at a fixed difference in height. Preferably, a volume of the first liquid in the first pressure equalisation tank is larger than a volume of the first gas in the cell or cell stack and a first headspace of the first pressure equalisation tank and the first gas conduit. Also preferably, a volume of the second liquid in the second pressure equalisation tank is larger than a volume of the second gas in the cell or cell stack and a second headspace of the second pressure equalisation tank and the second gas conduit.

### Example Embodiment

In one example embodiment, the cell or cell stack 210 is an electro-synthetic liquid-gas water electrolyzer wherein gas 1 (the first gas) is oxygen and gas 2 (the second gas) is hydrogen, both of which are produced by the electrolyzer from water. The gas pressure equalisation system 401 may provide for exceedingly accurate pressure equalisation in such an electrolyzer, in the order of maintaining an average pressure differential of around 1 millibar when the overall absolute pressure of each gas is around 30 bar. This is believed to be partly because the first liquid 470/second liquid 473 in each pressure equalisation tank has a well-defined and essentially unchanging density and compressibility during operation, unlike the gas-filled liquids, froths or foams in the separation tanks 35 and 45 discussed in the prior art example in FIG. 1 and associated description. Moreover, each of liquid first level 471 and liquid second level 472, at their interfaces with their gases in the headspaces 450, 460 of the first pressure equalisation tank 410 and second pressure equalisation tank 420 respectively, is well defined and unambiguous. This again contrasts with the ‘liquid levels’ in the separation tanks 35 and 45 discussed in the prior art example described in FIG. 1, which are poorly defined and diffuse because of the presence of large numbers of gas bubbles at the liquid-gas interface.

The well-defined and essentially invariant density and compressibility of the first liquid 470/second liquid 473 along with the well-defined and unambiguous liquid first level 471 and liquid second level 472 in first pressure equalisation tank 410 and second pressure equalisation tank 420, respectively, provide a method for maintaining the pressures of gas 1 and gas 2 to be equal. The method involves maintaining the liquid first level 471 of the first liquid 470 and liquid second level 472 of the second liquid 473 in the first pressure equalisation tank 410 and second pressure equalisation tank 420 at equal heights. This may be achieved by managing the first valve (V_{A}) 480 and the second valve (V_{B}) 490 to open and close in such a way as to maintain the liquid first level 471 of the first liquid 470 and liquid second level 472 of the second liquid 473 in the first pressure equalisation tank 410 and second pressure equalisation tank 420 to be at equal heights. The operation of the valves V_{A} and V_{B} may be automatically managed by, for example, a PLC of the balance-of-plant that simultaneously monitors sensors that detect the height of liquid first level 471 and liquid second level 472 in real time.

In another example method, the pressure of gas 1 and the pressure of gas 2 are maintained at a fixed differential pressure by similarly maintaining the liquid first level 471 and the liquid second level 472 in the first pressure equalisation tank 410 and the second pressure equalisation tank 420 at a fixed difference in heights.

(1)(iii) Gas Management: Gas Pressure Control

In various example aspects, embodiments relate to balance-of-plants, or methods of operation, for electro-synthetic or electro-energy liquid-gas cells or cell stacks with new and/or improved gas pressure control.

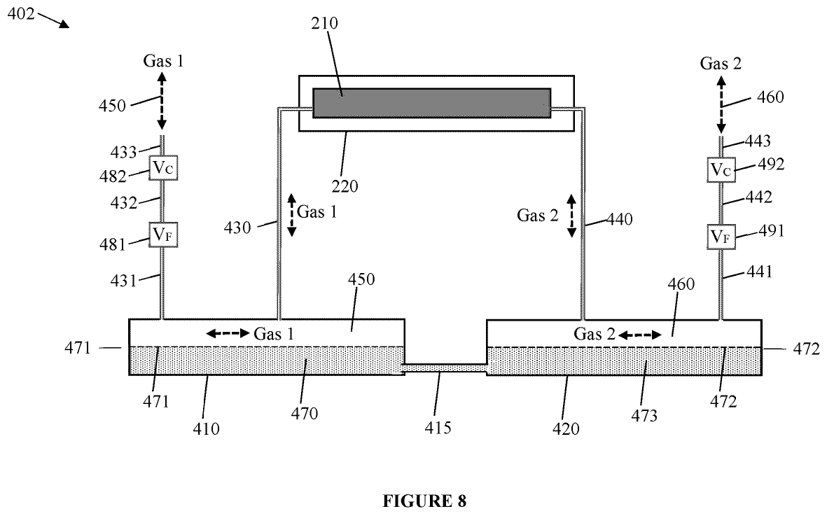

In one example, referring to FIG. 8 there is provided a gas pressure control system 402 for the balance-of-plant of an electro-synthetic or electro-energy liquid-gas cell or cell stack 210, which employs two valves, a valve for coarse adjustments and a valve for fine adjustments, placed sequentially (i.e. in series) in an external inlet or outlet gas pipe to manage the gas pressure in an attached cell or cell stack. Preferably, the valves are controlled by an automated control system, such as, for example, a PLC of the balance-of-plant.

FIG. 8 depicts the pressure equalisation system of FIG. 7, fitted with two such valves in series in the gas pipes for each of gas 1 and gas 2. As can be seen in FIG. 8, the pressure control valves V_{A} 480 (gas 1) and V_{B} 490 (gas 2) in FIG. 7 have each been replaced by two valves, namely, a ‘fine’ control valve, V_{F}, 481 (gas 1) and a ‘fine’ control valve, V_{F}, 491 (gas 2), i.e. ‘fine control valve for first gas’ 481 and ‘fine control valve for second gas’ 491, which provide for relatively small adjustments in gas pressure, and a ‘coarse’ control valve, V_{C}, 482 (gas 1) and a ‘coarse’ control valve, V_{C}, 492 (gas 2), i.e. ‘course control valve for first gas’ 482 and ‘course control valve for second gas’ 492, which provides for relatively larger adjustments in gas pressure at each gas inlet/outlet. A contiguous gas volume also exists between each fine control valve, V_{F}, 481 (gas 1) and 491 (gas 2), and the cell or cell stack, wherein this gas volume is designated as having pressures P_{fine} (gas 1) and P_{fine} (gas 2). Pressures P_{fine} (gas 1) and P_{fine} (gas 2) will generally be close to or identical to the pressure of gas 1 and gas 2, respectively, within the attached cell or cell stack, whose pressure is designated as P_{stack} (gas 1) and P_{stack} (gas 2), respectively. A buffer first gas volume 432 (gas 1) and a buffer second gas volume 442 (gas 2), each designated as a ‘buffer’ volume, further exists between each fine control valve, V_{F}, 481 (gas 1) and 491 (gas 2), and each coarse control valve, V_{C} 482 (gas 1) and 492 (gas 2). The pressure within the buffer volumes, that is within buffer first gas volume 432 (gas 1) and buffer second gas volume 442 (gas 2) are designated P_{coarse} (gas 1) and P_{coarse} (gas 2), respectively. For each of gas 1 and gas 2, the pressure P_{coarse} may generally be of similar order to, and not vastly different to P_{fine}. That is, the pressure difference from one side to the other, across each fine control valve, namely, ΔP=P_{coarse}-P_{fine} may generally be only small. While the buffer first gas volume 432 (gas 1) and buffer second gas volume 442 (gas 2) are depicted as pipes in FIG. 8, they may be larger volumes, for example they may incorporate tanks, i.e. buffer tanks.

The inventors have found that a small pressure difference (ΔP) across a PLC-managed control valve may allow for more precise and accurate adjustments of the pressure on the cell stack side of the valve than is possible with a larger pressure difference across the same control valve. That is, a (fine) control valve in the above configuration may open and close in a more controlled and precise way under PLC control when it has a small pressure difference (ΔP) across it than when it has a large pressure difference across it. Such a small pressure difference may be created by placing another control valve—a (coarse) control valve—in series, on the outside of the (fine) control valve, on the side away from the cell stack. Thus, a capacity for more precise, automated adjustments of the pressure P_{fine} may be created by incorporating two control valves, a fine and a coarse control valve in series on the external inlet/outlet of the gas pipe. Moreover, a capacity for more precise adjustments of the pressure P_{fine} also provides for more precise adjustments of the pressure P_{stack} in the cell or cell stack.

That is, the presence of a ‘fine’ control valve, V_{F}, 481 (gas 1) and 491 (gas 2) (i.e. ‘fine control valve for first gas’ 481 and ‘fine control valve for second gas’ 491) in FIG. 8, which are used to make relatively small adjustments in gas pressure, and a ‘coarse’ control valve, V_{C}, 482 (gas 1) and 492 (gas 2) (i.e. ‘course control valve for first gas’ 482 and ‘course control valve for second gas’ 492), which are used to make relatively larger adjustments in gas pressure at each gas inlet/outlet, provides for better control of the pressure of the respective gases in an electro-synthetic or electro-energy liquid-gas cell or cell stack.

This may be achieved in a fully automated process by, for example, a programmable logic controller (PLC) that controls the fine and coarse control valves, while simultaneously monitoring pressure detectors/sensors located in: (i) the gas pipe between the fine and coarse control valves, (ii) the gas pipe between the fine control valve and the cell or cell stack, and (iii) within the cell or cell stack.

Preferably, the pressure difference across either one or both of the fine control valves, namely, ΔP=P_{coarse}-P_{fine}, is less than 0.001 bar, less than 0.002 bar, less than 0.003 bar, less than 0.005 bar, less than 0.010 bar, less than 0.020 bar, less than 0.040 bar, less than 0.050 bar, less than 0.075 bar, less than 0.100 bar, less than 0.125 bar, less than 0.150 bar, less than 0.200 bar, less than 0.300 bar, less than 0.400 bar, less than 0.500 bar, less than 0.750 bar, less than 1 bar, less than 2 bar, less than 5 bar, less than 10 bar, or less than 20 bar.

Preferably, the pressure difference between either one or both of the fine control valves and the cell stack, P_{fine} and P_{stack}, is less than 0.001 bar, less than 0.002 bar, less than 0.003 bar, less than 0.005 bar, less than 0.010 bar, less than 0.020 bar, less than 0.040 bar, less than 0.050 bar, less than 0.075 bar, less than 0.100 bar, less than 0.125 bar, less than 0.150 bar, less than 0.200 bar, less than 0.300 bar, less than 0.400 bar, less than 0.500 bar, less than 0.750 bar, less than 1 bar, less than 2 bar, less than 5 bar, or less than 10 bar.

It is to be understood that, whereas the use of a coarse and fine control valve has been discussed above as it applies to the pressure equalisation system in FIG. 7, they may equally be applied to any other pressure equalisation system, including, for example, the pressure equalisation systems depicted in FIG. 5 and FIG. 6.

It is further to be understood that, whereas the coarse control valve has been located on the outside of the fine control valve along the gas lines in FIG. 8, any order may be used. For example, the fine control valve may be located on the outside of the coarse control valve in an example gas line.

(1)(iv) Gas Circulation or Re-Circulation, including during ‘Standby’

All of the embodiments and examples described above had a single gas conduit pathway for each distinct and separate gas to enter or leave the cells or cell stacks. Such connections are termed in the industry, ‘dead end’ connections, since gas entering via such a conduit has no pathway out of the cell or cell stack. In many cases however, including specifically many electro-energy cells, the distinct and separate gases need to be circulated through the cell; they cannot be operated safely with ‘dead end’ connections.

In various example aspects, embodiments relate to balance-of-plants, or methods of operation, for electro-synthetic or electro-energy liquid-gas cells or cell stacks capable of circulating or re-circulating gases through a cell or cell stack, including but not limited to the purpose of maintaining a ‘standby’ state. ‘Standby’ is a state in which the cells or cell stacks are not operating but are available for an immediate start without going through the steps normally involved in a startup procedure.

In many electro-energy liquid-gas cells, introducing two or more distinct gases in bulk form into the cell results in contaminants starting to build up within those bulk gas/es in the cell. This may be because of gas crossover, in which gas on one side of the inter-electrode separator membrane/ionomer migrates to the other side, resulting in contamination of each gas with the other. Such gas crossover may systematically build up the contamination of each gas over time. Similarly, in many electro-synthetic liquid-gas cells containing two or more distinct bulk gases, disengagement of the electrical power connection to halt operation, may result in contaminants starting to build up within those bulk gas/es in the cell. Contaminant build-up may be problematic because it may, by way of example: (i) create a safety hazard, (ii) breach the purity specification of the gas, making the bulk gas within the cell or cell stack unacceptable to a customer being supplied with the gas, and/or (iii) make the bulk gas inside the cell or cell stack too impure to be properly used as a reactant when the cell or cell stack is re-started. In such cases, the build-up of contaminants may, effectively, necessitate a full shutdown process, in which the cells or cell stack is purged with an inert gas. This may then, in turn, necessitate a full startup process before operation can be recommenced.

A non-limiting example in this respect is an electro-synthetic liquid-gas water electrolysis cell. As noted above, such cells typically produce two gases, namely hydrogen (at the cathode) and oxygen (at the anode). The hydrogen and oxygen product streams are typically maintained separate by a separator membrane/ionomer placed between the electrodes. Such separator membranes or ionomers generally slow, but do not stop, the rate at which hydrogen gas migrates across the separator into the oxygen stream, and the rate at which oxygen gas migrates across the separator into the hydrogen stream, which is known as gas crossover. When such cells are disengaged from their electrical power connection, they cease producing hydrogen and oxygen gas. However, the gas crossover rate continues unabated. Accordingly, the hydrogen contaminant in the body of bulk oxygen in the cell may build-up over time. The oxygen contaminant in the body of bulk hydrogen within the cell may also build-up over time. This may become a problem since, as noted above, oxygen containing more than ~4% hydrogen, or hydrogen containing more than ~4% oxygen, is an explosive mixture at the usual operating temperature of 80° C. It may, especially, be a problem in water electrolysis cell that have permanent three-way liquid-gas-solid boundaries at each electrode, for example cells of the type depicted in FIG. 2. Large bodies of bulk hydrogen and bulk oxygen may be present inside such cells.

The inventors have found that, by continually, continuously or periodically re-circulating the separate bulk gas bodies in the cells through external devices that remove the contaminants, it is possible to constantly remove the contaminant gases from the hydrogen and oxygen in the cell and thereby maintain them safe, even after the electrical power has been disengaged from such cells. A device that removes hydrogen from a body of oxygen is referred to herein as a ‘recombiner’. A device that removes oxygen from a body of hydrogen is referred to herein as a ‘de-oxo’ unit.

Similarly, the gases introduced into electro-energy liquid-gas cells, for example the hydrogen and oxygen introduced into a hydrogen-oxygen fuel cell, may be maintained safe, if both gases are continually, continuously or periodically re-circulated through devices that remove the contaminant gases deriving from gas crossover.

Accordingly, there is provided a balance-of-plant, or method of operation, for an electro-synthetic or electro-energy liquid-gas cell or cell stack that continually, continuously or periodically re-circulates one or more bulk gases from out of the cell or cell stack, through a ‘de-contamination’ unit, and back into the cell or cell stack. Such re-circulation may allow the balance-of-plant to maintain the cell/s or cell stacks safe even in a ‘standby’ state, when the electrical power connection has been disengaged.

In some examples, the standby condition may be implemented independently of the commencement of any recirculation of the gas through the cell or cell stack. For example, the recirculation of the gas through the cell or cell stack may be commenced after implementation of the standby condition, only when the level of a contaminant gas within the gas body risks it becoming hazardous. The recirculation of the gas through the cell or cell stack may, similarly, be halted when the level of a contaminant gas within the gas body is sufficiently diminished.

In other examples, the recirculation of the gas through the cell or cell stack is commenced when the standby state is activated; that is, when the electrical power connection of the cell or cell stack is disengaged. In still other examples, the recirculation of the gas through the cell or cell stack is halted when the standby state is deactivated; that is when the electrical power connection of the cell or cell stack is engaged.

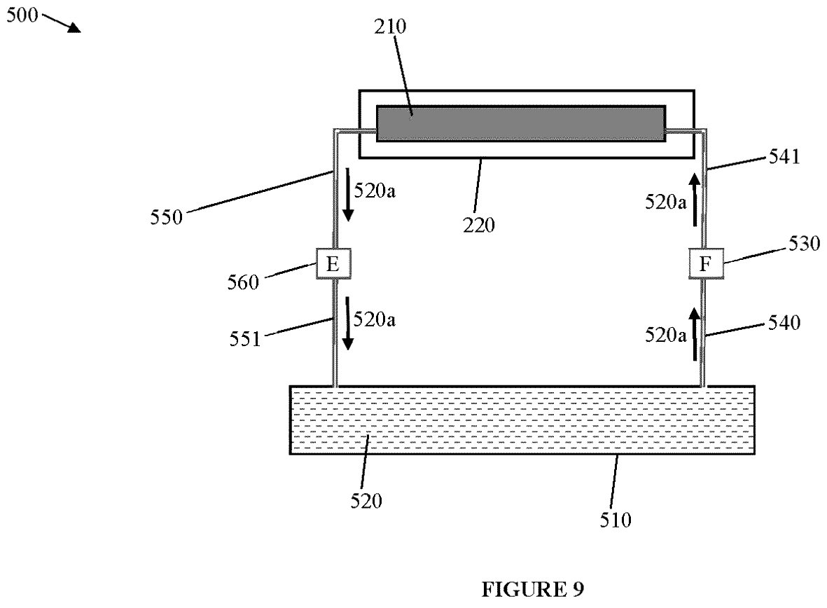

FIG. 9 depicts a gas re-circulation system 500 of the above type. An electro-synthetic or electro-energy liquid-gas cell or cell stack 210, is, optionally, incorporated into a pressure vessel 220, that, optionally, includes an annular liquid 250 or annular gas 255 between the outer walls of the cell or cell stack 210 and the inner walls of the pressure vessel 220 (not shown in FIG. 9), as described in FIGS. 3-4 and associated text. The cell or cell stack 210 contains a gas in bulk form that becomes progressively contaminated, for example when the cell or cell stack 210 is disengaged from its electrical power connection during a ‘standby’ state. To avoid a build-up of the contaminants, the bulk gas is, preferably but not exclusively, drawn out of the cell or cell stack 210 along pipe 550, in the direction 520a, by an ejector, E, 560 or similar device. The gas then passes along pipe 551, in the direction 520a, into a ‘decontamination unit’ 510. Preferably but not exclusively, the de-contamination unit 510 may comprise a porous, packed bed of catalyst or adsorbent 520 that removes contaminant gases within the circulating gas. In passing through the decontamination unit 510, the contaminants in the gas are removed by the catalyst or absorbent bed 520. The gas then passes out of the decontamination unit 510 into pipe 540 in the direction 520a. Preferably, but not exclusively, the gas is circulated back to and into the cell or cell stack 210 by a fan, F, 530, which may, alternatively, be a blower, a compressor, or any similar engineering component capable of moving a gas-phase fluid. The gas is propelled via pipe 541, in the direction 520a, back into the cell or cell stack 210.

In one example, the recirculation system 500 of the gas through the cell or cell stack 210 may be initiated when the electro-synthetic or electro-energy liquid-gas cell or cell stack 210 is turned off; that is when its electrical power connection is disengaged. Preferably, the recirculation of the gas through the cell or cell stack 210 is halted when the electrical power connection of the electro-synthetic or electro-energy liquid-gas cell or cell stack 210 is engaged.

Optionally, in the case where the cell or cell stack 210 contains two or more separate gas streams, the balance-of-plant may provide for two or more separate re-circulation loops, each incorporating an appropriate de-contamination unit and the other components described above. In such a case, preferably but not exclusively, both re-circulation loops may be turned on when the electro-synthetic or electro-energy liquid-gas cell or cell stack 210 is turned off; that is when the electrical power connection is disengaged. Preferably but not exclusively, both recirculation loops may be halted when the electrical power connection of the electro-synthetic or electro-energy liquid-gas cell or cell stack 210 is engaged.

In one example embodiment, the electro-synthetic or electro-energy liquid-gas cell or cell stack 210 is that of a water electrolyzer or a hydrogen-oxygen fuel cell, which contains two separate gas streams, namely, an oxygen stream and a hydrogen stream. Preferably but not exclusively, a de-contamination unit termed a recombiner continually removes contaminant hydrogen that builds up in the oxygen gas stream within the cell or cell stack 210 during the standby state, thereby ensuring that the oxygen stream remains safe. Preferably, a de-contamination unit termed a de-oxo unit continually removes contaminant oxygen that builds-up in the hydrogen stream within the cell or cell stack 210 during the standby state, thereby ensuring that the hydrogen stream remains safe. Preferably but not exclusively, the standby state is used in the water electrolyzer or hydrogen-oxygen fuel cell during ‘load following’ or ‘grid balancing’, as described in section 6 below.

### (2) Liquid Management

In various example aspects, embodiments relate to balance-of-plants, or methods of operation, for electro-synthetic or electro-energy liquid-gas cells or cell stacks with new and/or improved liquid management.

While pumps have been widely used to move liquids in electro-synthetic or electro-energy liquid-gas cells and cell stacks, the inventors have found that ejectors provide for improved operation under certain circumstances. This may be particularly, but not exclusively, the case for cells that are only partially filled with liquid, for example cells of the type depicted in FIG. 2. Because such cells are not fully filled with liquid, the conventional approach of pumping large volumes of liquid through the cell using a pump, may be problematic, at least if the liquid level in the cell is to be reliably maintained constant. Drawing liquid from the cell with an ejector, whilst potentially simultaneously pumping liquid into the cell using a pump, may provide a more effective and controlled means of circulating liquid through such a cell. In such a case, the tank from which liquid is circulated may be best placed below the level of the cells and cell stack, not above it.

Accordingly, there is provided a liquid circulation system or method for the balance-of-plant of an electro-synthetic or electro-energy liquid-gas cell or cell stack, wherein liquid, is circulated through the cell or cell stack by being drawn out of the cell or cell stack using an ejector or similar component. Preferably but not exclusively, gravity may assist the ejector or similar component to draw the liquid out of the cell or cell stack.

### Basic Liquid Circulation System

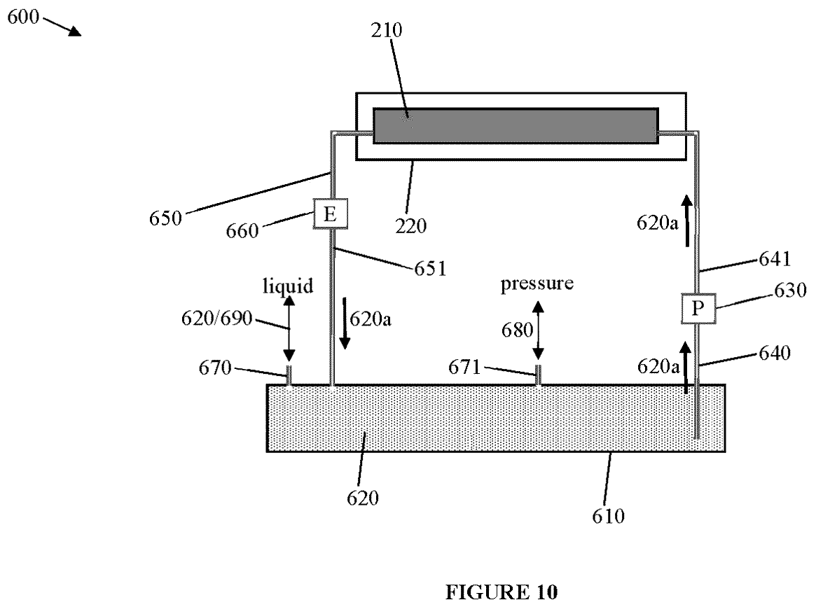

FIG. 10 depicts a liquid circulation system 600 wherein liquid is circulated through the cell or cell stack 210 by being drawn out of the cell or cell stack 210 using an ejector, E, 660 or similar component, such as, for example, a pump. The electro-synthetic or electro-energy liquid-gas cell or cell stack 210, is, optionally, incorporated into a pressure vessel 220, that, optionally, incorporates an annular liquid 250, e.g. cooling liquid 250, that may be water, or an annular gas 255, between the outer walls of the cell or cell stack 210 and the inner walls of the pressure vessel 220 (not shown in FIG. 10), as described in FIGS. 3-4 and associated text. That is, a liquid outlet pipe 650 of the cell or cell stack 210 is connected to a liquid circulation tank 610 and a liquid 620 is drawn out of the cell or cell stack 210 via the liquid outlet pipe 650 by an ejector, E, 660. The liquid 620 drawn out of, or pumped out of, the cell or cell stack 210 may be a liquid electrolyte or a cooling liquid.

The cell or cell stack 210 has liquid 620, e.g. liquid electrolyte or a cooling liquid, drawn out of it by an ejector, E, 660, via liquid outlet pipe 650. The liquid 620 passes along pipe 651 in the direction 620a, into a liquid circulation tank 610 that may be partially or completely filled with liquid 620. From the liquid circulation tank 610, liquid 620 may be pumped by a pump, P, 630 (or drawn by an ejector) back into the cell or cell stack 210 via one or more pipes, such as pipes 640 and 641, in the direction 620a. Thus, there is provided a liquid outlet pipe 650 of a cell or cell stack 210 that is connected to a liquid circulation tank 610 and a liquid 620 is drawn out of the cell or cell stack 210 by an ejector 660 or a pump. The liquid 620 is pumped by a pump 630 or similar component, such as, for example, an ejector, from the liquid circulation tank 610 back into the cell or cell stack 210 via one or more pipes. The liquid circulation tank 610 is, optionally, positioned below the cell or cell stack 210.

Annular liquid 250 that surrounds the cell or cell stack 210 may similarly but separately be circulated from the pressure vessel 220 into a separate liquid circulation tank and back into the pressure vessel 220.

Preferably, liquid 620 is added to or removed from the liquid circulation system 600 by adding or removing liquid to the liquid circulation tank 610. The added or removed liquid may be the same as liquid 620, or it may be a different liquid 690, for example, it may be water that is added to or removed from an aqueous liquid electrolyte 620. Preferably but not exclusively, liquid 620 or different liquid 690 is added to the liquid circulation system 600 or removed from the liquid circulation system 600 via a liquid addition/removal port 670 of the liquid circulation tank 610.

In the case where the liquid circulation tank 610 is completely filled with liquid 620, the pressure of the liquid 620 in the liquid circulation tank 610 is, preferably, managed via a pressure port 671 of the liquid circulation tank 610. Preferably the pressure port 671 interfaces with a pressure management device that controls the pressure 680 applied to liquid 620, such as, for example, an expansion tank of the type described in FIG. 4 and associated text. Optionally, the pressure port 671 may also be the liquid addition/removal port 670.

It is to be understood that the pump, P, 630 shown in FIG. 10 may be interchanged or replaced with an ejector, E, 660, and vice versa. That is, the ejector, E, 660 shown in FIG. 10 may be replaced or interchanged by a pump. Similarly, the pump, P, 630 shown in FIG. 10 may be replaced or interchanged by an ejector.

Liquid Circulation System Integrated with a Gas Pressure Equalisation System and a Gas Pressure Control System

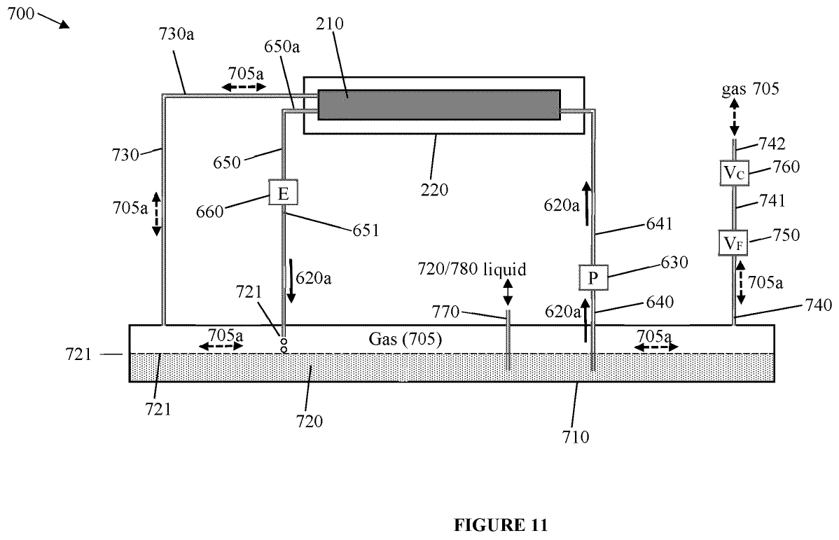

In the case where the liquid circulation tank is only partially filled with liquid, the headspace is preferably filled with a gas and the pressure of the liquid in the tank is managed by managing the pressure of the gas in the headspace. FIG. 11 depicts an example of such a system 700, that also incorporates:
a gas pressure equalisation system utilizing a pressure equalisation tank of the type depicted in FIGS. 5-6, and FIG. 7 and associated text; and
a pressure control system utilizing coarse and fine backpressure valves of the type depicted in FIG. 8 and associated text.
   That is, the liquid circulation tank includes a gas headspace of the type used for pressure equalisation in FIGS. 5-6 and FIG. 7 and associated text, while the backpressure control utilises a fine and coarse valve as described in FIG. 8 and associated text.

An electro-synthetic or electro-energy liquid-gas cell or cell stack 210, is, optionally, incorporated into a pressure vessel 220, that, optionally, incorporates an annular liquid 250, that may be water, or an annular gas 255 between the outer walls of the cell or cell stack 210 and the inner walls of the pressure vessel 220 (not shown in FIG. 11), as described in FIGS. 3-4 and associated text.

The liquid circulation system 700 comprises of pipe 650, through which liquid 720 is drawn out of the cell or cell stack 210 by an ejector, E, 660, and directed along pipe 651, in the direction 620a, into a liquid circulation tank 710 that is partially filled with liquid 720. In this case, the headspace of the liquid circulation tank 710, above liquid level 721, is filled with gas 705, i.e. ‘circulation tank gas’ 705, which is also present in bulk form inside the cell or the cell stack 210. In examples, the gas 705 may be a first gas or a second gas produced or consumed by the cell or cell stack 210. Gas 705 (i.e. ‘circulation tank gas’ 705) may pass over liquid 720 in liquid circulation tank 710 on its way to or from the cell or cell stack 210. In passing between the cell or cell stack 210 and the headspace of the liquid circulation tank 710, the gas 705 passes along gas conduit 730 (including arm 730a) in one of the directions 705a. In passing between the headspace of the liquid circulation tank 710 and the external environment, the gas 705 passes along pipes 740, 741, and 742, via a fine control valve 750 and a coarse control valve 760 placed in series. The fine control valve 750 and a coarse control valve 760 may control the pressure of the gas 705 in the headspace of the liquid circulation tank 710, above the liquid level 721. In so doing, these valves may also control the pressure of the liquid 720 in the liquid circulation tank 710. The liquid in pipe 651 has the same pressure as the liquid 720 in liquid circulation tank 710, including at the point 721, at which the liquid in pipe 651 enters the liquid circulation tank 710 (and passes through the headspace of gas 705 above the liquid level 721).

This embodiment may therefore combine a liquid circulation system with a pressure equalisation system of the type described in FIGS. 5-6 and FIG. 7 and associated text, and a pressure control system employing coarse and fine backpressure valves of the type described in FIG. 8 and associated text. The pressure of gas 705 inside the cell or cell stack 210 may be managed by the coarse and fine valves, with the headspace of liquid tank 710 acting as a buffer volume that facilitates equalisation of the pressure of gas 705 with the pressure of another gas, present in bulk form within the cell or cell stack 210. If the liquid 720 is also the liquid electrolyte in the cell or cell stack 210, then system 700 may facilitate equalisation of the pressures of the separate and distinct bulk gases present in the cell or cell stack 210, as well as equalisation with the pressure of a liquid electrolyte within the cell or cell stack 210.

Preferably but not exclusively, the liquid circulation tank 710 is below, preferably wholly below, the level of the cell or cell stack 210c, relative to gravity; that is, the liquid circulation tank 710 is, preferably but not exclusively, an ‘infra’-tank. Preferably but not exclusively, liquid passing along pipe 651 in direction 620a falls through the gas headspace into the tank 710, as shown at 721.

Preferably, pressure is directly transmitted to the inter-electrode separator membranes/ionomers by the gas(es) and not via columns of intermingled, two-phase mixtures of liquid electrolyte and gas of the type found in conventional electrolysers (and described in FIG. 1 and associated text). High gas crossover due to fluctuating and transient pressure differentials across the separators is thereby avoided.

Preferably, liquid is added to or removed from the liquid circulation system in 700 by adding to or removing liquid from the liquid circulation tank 710 via port 770. The added or removed liquid may be the same as liquid 720, or it may be a different liquid 780, for example, it may be water 780 that is added to or removed from an aqueous liquid electrolyte 720.

While this example depicts the case where the gas in the headspace is a bulk gas that is also present in the cell or cell stack, i.e. the first gas or the second gas, it is to be understood that any gas may be used in the headspace, including a different gas to those present in the cell or cell stack.

### Parallel Liquid Circulation System

In the case where the cells or cell stacks contains two or more separate liquid streams, for example, an anolyte stream and a catholyte stream, the balance-of-plant may, optionally, provide two or more separate liquid circulation systems. Such an arrangement is here termed a ‘parallel liquid circulation system’.

Each circulation system may, optionally, separately incorporate an ejector or similar component capable of moving a liquid-phase fluid. Optionally, each liquid circulation system may also incorporate a separate liquid-filled or partially-filled tank, from where it may, preferably but not exclusively, be pumped by a pump back into the cell or cell stack.

In the case involving separate liquid circulation tanks that are only partially filled with liquid, the headspace above the liquid level in each tank may be filled with a gas. Optionally, the gas in each headspace may be a distinct gas to that present in the cell or cell stack, or the gas in each headspace may be a same gas as that present in bulk form in the cell or cell stack. Optionally, the gas in each headspace may be fluidly connected to the same gas in the cell or cell stack, via a gas conduit between the headspace and an inlet/outlet for the same gas in the cell or cell stack. Optionally, the pressure of the gas in each headspace may be the same or substantially similar to the pressure of the same gas within the cell or cell stack. Optionally, the pressure of the gas in each headspace may be controlled by a coarse and a fine control valve located sequentially (in series) in a gas pipe attached to the liquid circulation tank, as described in FIG. 8 and associated text.

In the case where there are two, separate, partially-filled liquid circulation tanks each of whose headspace is filled with a distinct gas that is fluidly connected to the same gas in bulk form inside the cell or cell stack, the two liquid circulation tanks may simultaneously function as pressure equalisation tanks of the type described in FIG. 6 and associated text. Moreover, if the two liquid circulation tanks contain the same liquid electrolyte and are fitted with a ‘connecting pipe’, they may function as a pressure equalisation system of the type described in FIG. 7 and associated text. In such a case, the two liquid circulation tanks may double as a pressure equalisation system. Preferably but not exclusively, the two, separate, liquid circulation tanks that double as pressure equalisation tanks are ‘infra’-tanks; that is, they are below the level of the cells and/or cell stack.

Optionally the two liquid circulation streams in a parallel liquid circulation system may be combined into a single liquid stream at a point along each liquid circulation pathway and later, at another point, be re-separated into two liquid streams. For example, a single ejector or similar component may, optionally, draw both liquid streams out of the cell or cell stack, thereby combining the streams at the point that they exit the cell or cell stack. Alternatively, or additionally, the two liquid streams may be combined into a single liquid stream at the point at which each stream is deposited into a single liquid circulation tank. Alternatively, or additionally, the two liquid streams may be drawn out of two, separate liquid circulation tanks by a single pump that combines them into one. The combined liquid stream may be again separated into two streams at a point in the liquid circulation pathway prior to re-entering the cell or cell stack.

### Gas Headspaces in Other Parts of the Liquid Circulation System

Optionally, the liquid outlet pipe 650a of the cell or cell stack 210 in FIG. 11, which is also connected to the ejector 660 at its other end, may contain a headspace of gas. Optionally the gas in that headspace may be a gas 705 that is also present in the cell or cell stack 210. Optionally, the headspace of the liquid outlet pipe 650a of the cell or cell stack 210 may be physically connected to an inlet/outlet 730a of that gas 705 in the cell or cell stack 210, via a connecting gas pipe equipped with a suitable orifice or similar ‘pressure drop’ device.

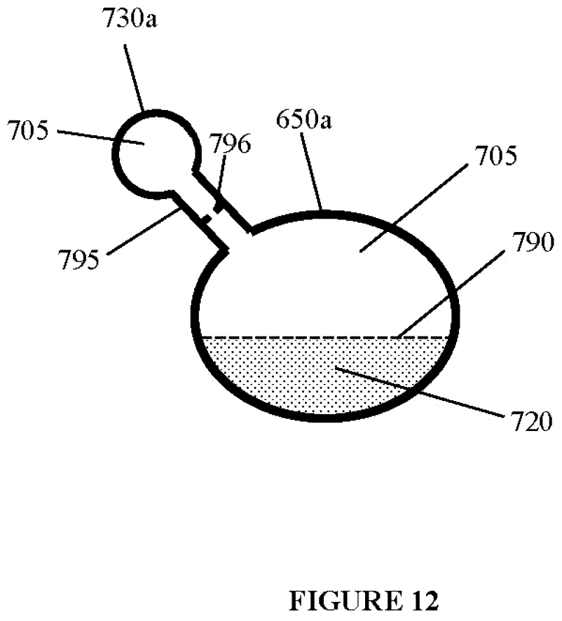

FIG. 12 depicts in schematic cross-section such an arrangement. The liquid outlet pipe 650a of the cell or cell stack 210 contains liquid 720 and a headspace of gas 705 above the liquid level 790. Because of the effect of the ejector, E, 660, the pressure within pipe 650a will necessarily be less than the pressure in pipe 730a when the arrangement depicted in FIG. 11 is used. The gas 705 fills the headspace in pipe 650a above liquid level 790 and fluidly connects with pipe 795 that connects liquid outlet 650a with the gas inlet/outlet 730a of the cell stack 210 via an orifice 796, or similar ‘pressure drop device’ 796. The orifice 796 or similar pressure drop device 796 is needed because the pressure of the liquid 720 and gas 705 inside pipe 650a is less than the pressure of gas 705 inside pipe 730a because of the effect of the ejector, E, 660. Such an arrangement may be used on either end of the cell or cell stack 210.

In another example, the gas 705 and liquid 720 inside pipe 650a may be intermingled to create some bubbles of gas 705 in the liquid 720; that is, pipe 650a may be filled or partially filled with a froth or foam of intermingled gas and liquid. In such a case, preferably, there is no connecting gas pipe 795 between pipe 650a and pipe 730a.

Gravity may partially assist the liquid 720 at the bottom of liquid outlet pipe 650a to fall downward when it enters pipe 650 in FIG. 11.

### Water Electrolyzer/Hydrogen-Oxygen Fuel Cell Example Embodiment

In an example embodiment, the electro-synthetic or electro-energy liquid-gas cell or cell stack is that of a water electrolyzer or a hydrogen-oxygen fuel cell, that may contain two separate liquid streams, namely, an oxygen-side liquid electrolyte stream and an hydrogen-side liquid electrolyte stream. Preferably but not exclusively, the balance-of-plant contains two separate liquid circulation systems, one for the oxygen-side liquid electrolyte stream and one for the hydrogen-side liquid electrolyte stream, wherein each liquid circulation system separately incorporates an ejector or similar component. Preferably but not exclusively, each liquid circulation system incorporates a separate liquid circulation tank, partially filled with liquid, with a headspace containing a gas, where, for the oxygen-side liquid electrolyte circulation tank, the gas is oxygen, coming from or going to the cell or cell stack, and, for the hydrogen-side liquid electrolyte circulation tank, the gas is hydrogen, coming from or going to the cell or cell stack.

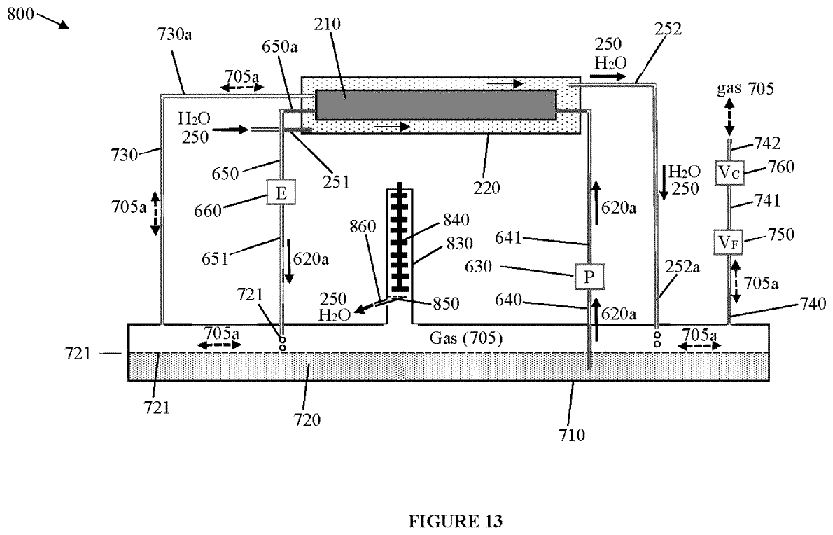

FIG. 13 schematically depicts one of the above liquid circulation systems, incorporating a gas control system and a water dispensing/removal system, of an example embodiment water electrolyzer or fuel cell 800.

A cell or cell stack 210 of a water electrolyzer or fuel cell is incorporated into a pressure vessel 220, that includes annular liquid water 250, between the outer walls of the cell stack 210 and the inner walls of the pressure vessel 220. The liquid water 250 passes into the pressure vessel 220 via inlet 251 and out of the pressure vessel 220 via outlet 252 that becomes pipe 252a. The liquid water 250 may be pressurised to a pressure similar to that inside the cell stack 210.

The liquid circulation system in FIG. 13, which is either that of the oxygen-side liquid electrolyte or the hydrogen-side liquid electrolyte, comprises of pipe 650, including arm 650a, through which liquid 720 is drawn out of the cell stack 210, by an ejector, E, 660, and directed along pipe 651, in the direction 620a, into a liquid circulation tank 710 that is partially filled with liquid 720. The headspace of the liquid circulation tank 710, above the liquid level 721, is filled with gas 705, which is either hydrogen or oxygen, and is also present in the cell or cell stack 210. Gas 705 passes over liquid 720 in liquid circulation tank 710 on its way to or from the cell stack 210. In passing between the cell or cell stack 210 and the headspace of liquid circulation tank 710, the gas passes along gas conduits 730 and 730a in one of the directions 705a. In passing between the headspace of the liquid circulation tank 710 and the external environment, the gas passes along pipes 740, 741, and 742, via a fine control valve 750 and a coarse control valve 760 placed in series. The fine control valve 750 and a coarse control valve 760 control the pressure of the gas 705 in the headspace of liquid circulation tank 710, above the liquid level 721. In so doing, these valves also control the pressure of the liquid 720 in the liquid circulation tank 710, which is either the oxygen-side liquid electrolyte or the hydrogen-side liquid electrolyte.

In the case of a water electrolyzer, make-up water to replenish the water that is consumed in the cell or cell stack 210 is, preferably but not exclusively, added to one or both of the oxygen-side or hydrogen-side liquid circulation tanks from the water (i.e. the annular liquid 250) that passes between the cell or cell stack 210 and the walls of the pressure vessel 220. That is, water (i.e. the annular liquid 250) exits the pressure vessel 220 via pipe 252 and 252a in FIG. 13 and is then dispensed into liquid circulation tank 710 to make up the water that is consumed in the cell or cell stack 210.

In the case of a hydrogen-oxygen fuel cell, water produced by the reaction is, preferably but not exclusively, removed from the liquid circulation tank 710 by a suitable process, for example, by condensation of water vapour. FIG. 13 depicts a water removal vessel 830, that is attached to liquid circulation tank 710, and containing a condenser column 840. Water vapour in the gas 705 condenses on the cooled condenser column 840 and is collected as liquid water (i.e. annular liquid 250) at location 850, where it exits the water removal vessel 830 (and the liquid circulation system overall) via pipe 860. Such water (i.e. the annular liquid 250) may be separately cooled and then passed through port 251 into pressure vessel 220 to cool the cell or cell stack 210. It is to be understood that any other water removal systems may, alternatively, be used and still fall within the scope of the specification.

FIG. 13 depicts one of the liquid circulation systems and its associated pressure equalisation and pressure control systems in the water electrolyzer or fuel cell example embodiment above. FIG. 12 may depict either the hydrogen-side liquid circulation system and hydrogen pressure equalisation and pressure control system, or the oxygen-side liquid circulation system and oxygen pressure equalisation and pressure control system, connected to the cell or cell stack 210 inside the pressure vessel 220. Whichever it is, the other liquid circulation system and associated gas management system, must also be connected to the cell or cell stack 210 inside the pressure vessel 220. The other liquid circulation system and associated gas management system is, preferably, identical to that depicted in FIG. 13, except that it involves the other gas and its associated liquid stream, and the other liquid circulation tank (not shown in FIG. 12). The same liquid electrolyte, for example, 30 wt % aqueous KOH, is, preferably, circulated in both liquid circulation systems; that is, liquid 720 and the other liquid are, preferably, identical. Moreover, the two liquid circulation tanks may be disconnected from each other, providing for pressure equalisation of the type discussed in FIG. 5 and associated text; or the two liquid circulation tanks may be connected to each other by a liquid-filled ‘connecting pipe’, providing for pressure equalisation of the type described in FIG. 7 and associated text. The two liquid circulation tanks then, preferably, also operate as pressure equalisation tanks that maintain the pressure of the hydrogen gas equal to the pressure of the oxygen gas in the cell or cell stack 210. The pressure of the liquid in the hydrogen-side liquid circulation system and the oxygen-side liquid circulation system may then also be equalised and also be equalised to the gas pressures. That is, the liquid circulation tanks, preferably, double as pressure equalisation tanks, thereby providing an economy in the utilisation of components within the balance-of-plant. Preferably but not exclusively, the two liquid circulation tanks that then also operate as pressure equalisation tanks are ‘infra’-tanks, being below, preferably wholly below, the level of the cell or cell stack 210.

It is to be understood that a single liquid circulation tank may be used for both of the hydrogen-side liquid circulation system and the oxygen-side liquid circulation system, with the liquid streams being combined prior to passing into the tank and divided after being removed from the tank. The headspace gas within such a single tank may be either oxygen or hydrogen, with the other gas being regulated via piping similar to components 440, 440a, and 490 in FIG. 5 or components 441, 442, 443, 491, and 492 in FIG. 8.

### (3) Cell or Cell Stack Cooling Management

In various example aspects, embodiments relate to balance-of-plants, or methods of operation, for electro-synthetic or electro-energy liquid-gas cells or cell stacks with new and/or improved cell or cell stack cooling management. Such new cooling systems are particularly useful for cell or cell stacks that have small cooling requirements, like the cells in FIG. 2, as they may potentially provide all or almost all of the cooling needed for such systems.

In one example, the inventors have found that a cell or cell stack may be cooled using an annular liquid passing between the cell or cell stack and the walls of the pressure vessel around it, as described in FIGS. 3-4 and associated text.

That is, referring to FIGS. 3-4, the simple act of passing an annular liquid 250, such as water, at ambient temperature into a pressure vessel 220 via port 251, over a cell stack 210 operating at 80° C. within the pressure vessel 220, and then out of the pressure vessel 220 via port 252, as described in FIG. 3-4, may impart ~2-4 kW of cooling to the cell or cell stack 210. In the case of a cell or cell stack 210 that requires only ~2-4 kW of cooling (e.g. that in FIG. 2), such an arrangement may potentially provide all necessary cooling. If additional cooling is needed, then this can be provided by actively cooling the annular liquid 250, e.g. water, prior to passing it into the pressure vessel 220 at port 251.

Moreover, in the case of a water electrolyzer cell or cell stack 210, the annular liquid 250, e.g. water, exiting at port 252 is heated to the operating temperature of the cell or cell stack 210 and, can be added to the liquid circulation system without causing it to cool down, as illustrated at the bottom of pipe 252a in FIG. 13.

Alternatively, or additionally, the inventors have found that cooling the circulating liquid in liquid circulation tank 610 (in FIG. 10) or liquid circulation tank 710 (in FIGS. 11 and 13) may provide further cooling of the cell or cell stack 210. That may be achieved by placing a cooling element in the above liquid circulation tanks.

In a further example embodiment, one or more ‘phase change tubes’, of the type commonly used in, for example, computer laptops, may be placed in the above liquid circulation tanks to cool the circulating liquid therein (i.e. it may be placed in the liquid circulation tank 610 in FIG. 10 or in the liquid circulation tank 710 in FIGS. 11 and 13), or be used to cool the liquid passing along the pipes 650, 651, 640, or 641 (in FIGS. 10, 11 and/or 13).

In the case of a hydrogen-oxygen fuel cell, which may typically produce larger quantities of heat than an electrolyzer, a still further option involves cooling the liquid 720 in the liquid circulation tank 610 (in FIG. 10) or in the liquid circulation tank 710 (in FIGS. 11 and 13) by condensing annular liquid 250, e.g. water, and removing that annular liquid 250, e.g. water, as described in the text associated with FIG. 13.

It is to be understood that in the example of an electro-synthetic or electro-energy liquid-gas cell or cell stack with two separate liquid circulation systems (for example, an aqueous oxygen-side electrolyte stream and an aqueous hydrogen-side electrolyte stream within a water electrolyzer or a hydrogen-oxygen fuel cell or cell stack), one or both of the liquid circulation systems may be employed for cooling.

### (4) Cell Condition Monitoring and Management

In various example aspects, embodiments relate to balance-of-plants, or methods of operation, for electro-synthetic or electro-energy liquid-gas cells or cell stacks with new and/or improved means for monitoring and managing the condition of the cells.

In general, it is desirable to monitor the condition of each cell within a cell stack by, for example, measuring the voltage/s of its electrodes and/or other information in real time. This may be done by, for example, fitting a highly resistive wire to each electrode in each cell and then measuring the voltage at the attached electrode using that wire. However, in a cell stack with many cells, for example with 50 or more cells, this approach creates a large number of wires that need to be connected and monitored.

The inventors have found that this problem may be overcome by incorporating a computer chip, or one or more computer chips, within each cell, for example, by embedding the computer chip, or the one or more computer chips, within the polymeric cell frame of each cell. The computer chip(s) may then be connected, via short, highly resistive wires, to each electrode in the cell. A single, common electrical wire may then be used to connect each computer chip(s) in each cell to all of the other computer chips in the other cells in the stack, and to a PLC of the balance-of-plant. Alternatively, the computer chips may contain antennas allowing them to wirelessly communicate with the PLC. The computer chip(s) in each cell may then transmit voltage and/or other information from its cell to the attached PLC. In so doing, the large number of wires previously needed may be replaced by a single, common wire or by no wire at all, which is much easier and more practical to use, especially when fabricating cell stacks containing many cells in a high speed, high volume industrial manufacturing process.

Communication protocols that may be used in such an arrangement include:
(1) Programming each chip or chips in the cell stack to repeatedly transmit its cell information to the PLC along the single, common wire or wirelessly at a different time. This allows the PLC to record the voltage information and match it to the location of the chip(s) that sent it, along the cell stack; or
(2) Programming each chip or chips in the cell stack to transmit its information along the single, common wire or wirelessly only when polled to do so by the PLC. That is, the PLC sends signals addressed to individual chips in the stack and the chips respond by sending back their cell information to the PLC.

It is to be understood that the above communication protocols are not all-inclusive; any other communication protocol that enables an arrangement of the above type falls within the scope of this specification.

### (5) Cell Stack Arrangement and Management

In various example aspects, embodiments relate to balance-of-plants, or methods of operation, for electro-synthetic or electro-energy liquid-gas cells or cell stacks with new and/or improved cell stack arrangements and management.

In one example, cell stacks are attached to a common manifold element that connects to the distinct liquid and gas flows of each attached cell stack, wherein each manifold element accumulates the distinct gas and liquid flows of its attached cell stacks into single, distinct, external liquid and gas flows. In this way, many distinct liquid and gas flows in the attached cell stacks may be reduced to a few, distinct, external liquid and gas flows. The collection of cell stacks, thus connected, is referred to here as an ‘array’.

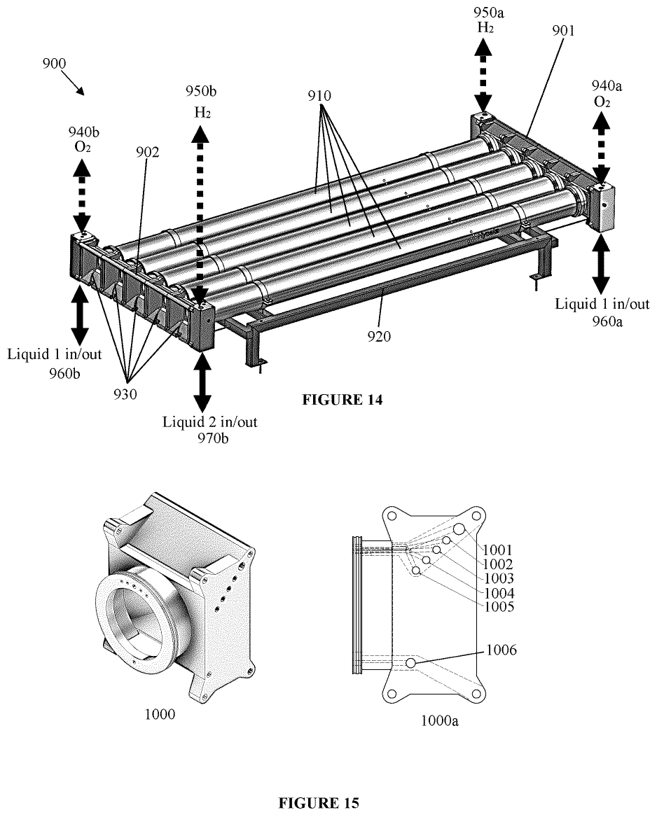

FIG. 14 depicts a non-limiting example in which the electro-synthetic or electro-energy liquid-gas cell stacks are those of a water electrolyzer or a hydrogen-oxygen fuel cell with two separate liquid streams, an oxygen-side liquid electrolyte stream (designated liquid 1) and a hydrogen-side liquid electrolyte stream (designated liquid 2) within each cell stack. In addition to distinct inlets/outlets for liquid 1 and liquid 2, each cell stack also has distinct inlets/outlets for oxygen (O₂) gas and hydrogen (H₂) gas. Such distinct inlet/outlets may be present on each end of each cell stack to thereby allow for re-circulation of each distinct gas or liquid through the cell stack via an inlet on one end of the cell stack and an outlet on the other end of the cell stack.

FIG. 14 depicts five such cell stacks (by way of example only as any number of cell stacks could be used) assembled in parallel into an array 900 that is placed on a stand 920. Five pressure vessels 910, each containing a cell stack within them (not visible in FIG. 14), are attached to a common first manifold element 901 on one end and a common second manifold element 902 on their other end. Each manifold element contains pipes within them that attach to the respective distinct outlet and inlet pipes of each cell stack (which penetrate through the walls of their respective pressure vessels at each end). The fluid flows through these distinct cell stack inlet/outlet pipes of each stack are, effectively, combined and accumulated into single, distinct, external gas and liquid flows, in the attached manifold elements.

Thus, first manifold element 901 has a single external inlet/outlet pipe 940a for oxygen (O₂) gas that connects, via internal pipes within the manifold element 901, to all of the oxygen inlets/outlets on the right-hand side of each of the stacks in the five pressure vessels 910. Similarly, first manifold element 901 has a single external inlet/outlet pipe 950a for hydrogen (H₂) gas that connects, via internal pipes within the first manifold element 901, to all of the hydrogen inlets/outlets on the right-hand side of each of the stacks in the five pressure vessels 910. Moreover, first manifold element 901 has a single external inlet/outlet pipe 960a for a first circulating liquid, liquid 1, that connects, via internal pipes within the first manifold element 901, to all of the inlets/outlets for liquid 1 on the right-hand side of each of the stacks in the five pressure vessels 910. First manifold element 901 further has a single external inlet/outlet pipe 970a (which cannot be seen in FIG. 14, as it is obscured by the pressure vessels 910) for a second circulating liquid, liquid 2, that connects, via internal pipes within the first manifold element 901, to all of the inlets/outlets for liquid 2 on the right-hand side of each of the stacks in the five pressure vessels 910.

Second manifold element 902 similarly has a single external inlet/outlet pipe 940b for oxygen (O₂) gas that connects, via internal pipes within the second manifold element 902, to all of the oxygen inlets/outlets on the left-hand side of each of the stacks in the five pressure vessels 910. Second manifold element 902 also has a single external inlet/outlet pipe 950b for hydrogen (H₂) gas that connects, via internal pipes within the second manifold element 902, to all of the hydrogen inlets/outlets on the left-hand side of each of the stacks in the five pressure vessels 910. Moreover, second manifold element 902 has a single external inlet/outlet pipe 960b for circulating liquid 1, that connects, via internal pipes within the second manifold element 902, to all of the inlets/outlets for liquid 1 on the left-hand side of each of the stacks in the five pressure vessels 910. Second manifold element 902 also has a single external inlet/outlet pipe 970b for circulating liquid 2, that connects, via internal pipes within the second manifold element 902, to all of the inlets/outlets for liquid 2 on the left-hand side of each of the stacks in the five pressure vessels 910.

In the example depicted in FIG. 14, the distinct pipes within the first manifold element 901 and the second manifold element 902 are each configured to provide parallel connection of flow pathways. However, it is to be understood that pipes within the manifold elements 901, 902 may, alternatively, be configured to provide series connections of flow pathways, or combinations of parallel and series connections of flow pathways.

Also, while FIG. 14 depicts cell stacks inside pressure vessels that are connected to manifold elements 901, 902 at each end, it is to be understood that the cell stacks need not be inside pressure vessels. Nor do they need to be attached to manifold elements 901, 902 at each end. A multiplicity of different array arrangements may be envisaged, all of which may constitute an array.

Moreover, the manifold element may also contain or at least incorporate electrical power connections/wiring that cumulatively or separately provide electrical power connections to each of the cell stacks in the array. For example, in FIG. 14, second manifold element 902 accommodates five electrical power connections/wires 930 going to the left-hand side of each individual cell stack (through their respective pressure vessels 910). First manifold element 901 similarly accommodates five electrical power connections/wires 930 (not visible in FIG. 14, as they are obscured by the first manifold element 901) going to the right-hand side of each individual cell stack (through their respective pressure vessels 910). When separate wires are employed for each electrical power connection to each cell stack in such an array, each individual cell stack is, preferably but not exclusively, independently electrically activated. In the case where a single cable is employed to make electrical power connections to multiple cell stacks in such an array, all of the connected cell stacks may be simultaneously electrically activated.

Preferably but not exclusively, each cell stack in each pressure vessel 910 in the array 900 is electrically connected to either a single, unshared power element, or to a shared power element connected to multiple cell stacks. The power elements are, preferably, capable of bi-directional electrical power management, being an inverter or similar device that can provide power to the cell stack (during operation as a water electrolyzer) or transmit power from the cell stack (during operation as a hydrogen-oxygen fuel cell). Preferably but not exclusively, each such power element is managed automatically by, for example, a PLC within the balance-of-plant to thereby allow for rapid changes in the direction of electrical current flow. Preferably but not exclusively, these features, in combination with the other features described in preceding paragraphs, provides for a balance-of-plant that allows for bi-directional operation of the cell stacks, thus arrayed, as either a water electrolyzer or as a hydrogen-oxygen fuel cell; that is, as a regenerative fuel cell-electrolyzer.

Preferably but not exclusively, the array 900 of water electrolyzer or hydrogen-oxygen fuel cell stacks, is configured to be capable of circulating bulk hydrogen and/or oxygen through the cells and stacks, including for the purpose of maintaining a ‘standby’ state. That is, the accumulated oxygen streams may be recirculated via the external oxygen inlet/outlets 940a-b on manifold elements 901 and 902, while the accumulated hydrogen streams may be separately recirculated via the external hydrogen inlets/outlets 950a-b on manifold elements 901 and 902, respectively, as described in section 1 (iv) above.

Preferably but not exclusively, the array 900 of water electrolyzer or hydrogen-oxygen fuel cell stacks, is configured to separately circulate the oxygen-side liquid electrolyte (liquid 1) via the external via the external liquid 1 inlet/outlets 960a-b on manifold elements 901 and 902, and circulate the hydrogen-side liquid electrolyte (liquid 2) via the external via the external liquid 2 inlet/outlets 970a-b on manifold elements 901 and 902, respectively, as described in section 2 above.

Optionally, the array 900 is configured to employ gases and liquids at pressure. Optionally, each pressure vessel 910 incorporates a pressurised annular liquid or annular gas between the outer walls of the cell stacks and the inner walls of the pressure vessel as described in section 1 (i) above. Optionally, the oxygen gas and the hydrogen gas is passed via inlets/outlets 940a-b and 950a-b respectively, through a gas pressure equalisation system of the type depicted in section 1 (ii)(a)-(b) above. Optionally, the oxygen gas pressure and hydrogen gas pressure in the cell stacks in the pressure vessels 910 are controlled via a coarse control valve and a fine control valve incorporated into the outer end of each of the oxygen gas pipe and hydrogen gas pipe, respectively, as described in section 1 (iii) above. Optionally, the cell stacks in the pressure vessels 910 in the array 900 are cooled as described in section 3 above. Optionally, the conditions in each cell within the cell stacks in the pressure vessels 910 in the array 900 are monitored and managed as described in section 4 above.

Embodiments further relate to manifold elements suitable for manifolding cell stacks into arrays. Preferably, manifold elements may be constructed of polymer materials, fibre- or filler-reinforced polymer materials, composites, metals, metal alloys, or other materials. Preferably, manifold elements may be fabricated by machining, 3D printing, moulding, including but not limited to injection moulding, or other fabrication techniques.

While the manifold elements 901 and 902 in FIG. 14 are depicted as single structures that each connect to five cell stacks within five pressure vessels 910, it is to be understood that techniques exist to pre-assemble such manifold elements from five or more separate manifold sub-elements, some of which may connect to only a single cell stack. For example, techniques taught in U.S. Pat. No. 5,405,528, describe the assembly of manifold elements for filter systems by combining multiple, identical manifold sub-elements, termed ‘symmetrical headers’ in U.S. Pat. No. 5,405,528.

The manifold elements 901 and 902 may, similarly, be fabricated by assembling manifold sub-elements 1000 in FIG. 15. Cross-section 1000a of the manifold sub-element 1000 is also shown. The manifold sub-element 1000 may incorporate, for example, internal pipe 1001 (for hydrogen gas flows out of/into the attached stack), internal pipe 1002 (for hydrogen gas flows out of/into the attached stack via a second pathway in the attached stack), internal pipe 1003 (for oxygen gas flows out of/into the attached stack), internal pipe 1004 (for oxygen gas flows out of/into the attached stack via a second pathway in the attached stack), internal pipe 1005 (for flows of liquid 1 into/out of the attached stack), and internal pipe 1006 (for flows of liquid 2 into/out of the attached stack). The internal pipes 1001-1006, i.e. inlets/outlets, are located in or on manifold sub-element 1000 such that when multiple manifold sub-elements 1000 are compressed together laterally and horizontally to assemble manifold elements 901 or 902, the distinct internal pipes 1001-1006 line up into single, overall, distinct pipes that accumulate the distinct, individual flow pathways of each of the attached cell stacks.

It is further to be understood that, whereas FIG. 14 depicts the example in which manifold elements 901 and 902 each connect and interface with five cell stacks and associated pressure vessels 910, manifold elements may connect to any multiplicity of cell stacks. Many permutations of cell stacks and manifold elements are possible, all of which fall within the scope of and definition of an array

Moreover, cell stacks need not be only manifolded in a horizontal plane as shown in the array 900 in FIG. 14. They may, alternatively, be manifolded in the vertical plane, or they may be manifolded in both the horizontal and vertical plane. Many permutations of cell stacks and manifold elements are possible, all of which fall within the scope of and definition of an array.

Arrays of the above type may further be combined into ‘3D arrays’, which are collections of arrays wherein each array is not connected to the next array by a shared, common manifold element, but which, nevertheless, share common piping and/or wiring and/or a common management/control system and/or a common, de-centralised balance-of-plant component (such as, but not limited to, a water supply/removal system, a cooling system, or the like).

### Drain Receiver Design for Multiple Cell Stacks Arrayed Vertically

When multiple cell stacks 910 are arrayed vertically above one another, then some design considerations may be needed for the single vertical pipe (within the manifold element) that will accumulate and drain the ‘liquid out’ flows emanating from each cell stack. A vertical drain pipe of this type is termed herein a ‘drain receiver’. Such a drain receiver will generally rely on gravity for flow of the liquid downwards. However, it may be important to design the drain receiver to decouple the downwardly flowing (vertical) liquid column from the static body of gas present within it.

Thus, the diameter of the drain receiver may generally need to be notably larger than the diameter of the horizontal pipes that feed liquid into the drain receiver. This may be necessary to prevent gas or liquid locks from forming in the drain receiver. For example, if the vertical pipe 650 in FIG. 11 acts as a drain receiver that accepts liquid draining out of multiple pipes 650a from multiple cell or cell stacks 210 arrayed vertically above each other, then the diameter of pipe 650 may have to be notably larger than the diameters of the pipes 650a. A spiral channel structure may need to be included on the inner pipe walls of vertical drain receiver 650 to keep the flowing liquid separate from the static gas. Such spiral structures may be used to encourage the liquid passing down a drain receiver to flow along the walls of the pipe, allowing gas to occupy the middle of the pipe.

The pressure of the gas in the drain receiver may be controlled by the ejector 660. The ejector 660 may need to be capable of shutting down if the level of the liquid in pipe 650 gets too high and threatens to enter the ejector 660. The pressure in the pipe may be varied by varying the gas bleed through the orifices 796 (FIG. 12) of the pipes 650a. For example, instead of using a fixed orifice, a valve capable of changing its aperture (i.e. an ‘active’ orifice) may be used at orifices 796. Several other design considerations may need to be taken into account.

### (6) Load Following or Grid Balancing

‘Load-following’ refers to the phenomenon in which an electro-synthetic or electro-energy cell or cell stack consumes electrical power from a renewable energy source whose energy output varies with time, necessitating constant changes in the rate of its electrical operation. That is, the rate of energy consumption of the electro-synthetic or electro-energy cell or cell stack (the ‘load’) follows changes in the energy output of a renewable energy source, which varies according to, for example, the brightness of sunlight in the case of a solar power generator, or the wind speed in the case of a wind generator.

‘Grid balancing’ refers to the phenomenon in which an electro-energy cell or cell stack transmits constantly varying levels of electrical power to thereby maintain the total energy available on an electrical grid that receives power from renewable energy sources whose energy output changes with time. That is, the rate of energy transmission by the electro-synthetic or electro-energy cell or cell stack to maintain the total energy available on the grid at any one time, must constantly change to ‘balance’ the variations in power supplied to the grid by the attached renewable energy sources.

In various example aspects, embodiments relate to balance-of-plants, or methods of operation, for electro-synthetic or electro-energy liquid-gas cells or cell stacks with new and/or improved capability to ‘load follow’ renewable energy power sources or ‘grid balance’ electrical grids supplied by renewable energy power sources.

In one example, load following or grid balancing is accomplished by systematically disengaging the electrical power connections and placing in a standby state, or engaging the electrical power connections and removing from a standby state, individual stacks or collections of stacks within arrays of electro-synthetic liquid-gas cell stacks.

In another example, load following or grid balancing is carried out by systematically disengaging the electrical power connections and placing in a standby state, or engaging the electrical power connections and removing from a standby state, individual arrays or collections of arrays within 3D arrays of electro-synthetic liquid-gas cell stacks.

In a still further example, the electro-synthetic or electro-energy liquid-gas cell stacks used for load following or grid balancing are those of a water electrolyzer and/or a hydrogen-oxygen fuel cell. Optionally, the cell stacks and associated balance-of-plant may be capable of operating either as a water electrolyzer or as a hydrogen-oxygen fuel cell; that is, as a regenerative fuel cell-electrolyzer.

### Electro-Synthetic and Electro-Energy Liquid-Gas Cells or Cell Stacks

The electro-synthetic liquid-gas cells or cell stacks described above may, preferably, be those of: (i) a water electrolyzer, (ii) a chlor-alkali electrolyzer, (iii) a cell for ammonia manufacture, or (iv) a CO₂ electrolyzer, including a combined carbon capture and CO₂ electrolyzer, or (v) any other type of liquid-gas cell or cell stack that may be considered to be an electro-synthetic cell or cell stack. Optionally, the electro-synthetic liquid-gas cells or cell stacks described above may comprise combinations of the cell types referred to above.

The electro-energy liquid-gas cells or cell stacks described above may, preferably, be those of: (i) a hydrogen-oxygen fuel cell, including a Polymer Electrolyte Membrane (PEM) fuel cell or an Alkaline fuel cell, (ii) a direct alcohol fuel cell, including but not limited to a direct methanol or direct ethanol fuel cell, (iii) a phosphoric acid fuel cell, (iv) an ammonia fuel cell, or (v) any other type of liquid-gas cell or cell stack that may be considered to be an electro-energy cell or cell stack. Optionally, the electro-energy liquid-gas cells or cell stacks described above may comprise combinations of the cell types referred to above.

### Combinations of Features

According to various non-limiting example embodiments, the following points disclose combinations of features that provide various example systems and/or example methods of operation.
1.1a. A gas pressure equalisation system for an electro-synthetic or electro-energy liquid-gas cell or cell stack, wherein the cell or cell stack is configured to keep separate a first gas in bulk form within the cell or cell stack.
1.1b. A gas pressure equalisation system for an electro-synthetic or electro-energy liquid-gas cell or cell stack, wherein the cell or cell stack is configured to keep separate a first gas in bulk form from a second gas in bulk form within the cell or cell stack.
1.2a. A gas pressure control system or method for an electro-synthetic or electro-energy liquid-gas cell or cell stack, wherein the cell or cell stack is configured to keep separate a first gas in bulk form within the cell or cell stack.
1.2b. A gas pressure control system or method for an electro-synthetic or electro-energy liquid-gas cell or cell stack, wherein the cell or cell stack is configured to keep separate a first gas in bulk form from a second gas in bulk form within the cell or cell stack.
1.3a. A gas circulation or re-circulation system or method for an electro-synthetic or electro-energy liquid-gas cell or cell stack, wherein the cell or cell stack is configured to keep separate a first gas in bulk form within the cell or cell stack.
1.3b. A gas circulation or re-circulation system or method for an electro-synthetic or electro-energy liquid-gas cell or cell stack, wherein the cell or cell stack is configured to keep separate a first gas in bulk form from a second gas in bulk form within the cell or cell stack.
1.4a. A liquid management system or method for an electro-synthetic or electro-energy liquid-gas cell or cell stack, wherein the cell or cell stack is configured to keep separate a first gas in bulk form within the cell or cell stack.
1.4b. A liquid management system or method for an electro-synthetic or electro-energy liquid-gas cell or cell stack, wherein the cell or cell stack is configured to keep separate a first gas in bulk form from a second gas in bulk form within the cell or cell stack.
1.5a. A cooling management system or method for an electro-synthetic or electro-energy liquid-gas cell or cell stack, wherein the cell or cell stack is configured to keep separate a first gas in bulk form within the cell or cell stack.
1.5b. A cooling management system or method for an electro-synthetic or electro-energy liquid-gas cell or cell stack, wherein the cell or cell stack is configured to keep separate a first gas in bulk form from a second gas in bulk form within the cell or cell stack.
1.6. A monitoring or management system or method for an electro-synthetic or electro-energy liquid-gas cell or cell stack, the monitoring or management system or method employing a computer chip, or one or more computer chips, within the cell or within one or more individual cells in the cell stack.
1.7a. An electro-synthetic or electro-energy liquid-gas cell stack arrangement, wherein the cell stack is configured to keep separate a first gas in bulk form within the cell stack.
1.7b. An electro-synthetic or electro-energy liquid-gas cell stack arrangement, wherein the cell stack is configured to keep separate a first gas in bulk form from a second gas in bulk form within the cell stack.
1.8a. A gas pressure equalisation system for an electro-synthetic or electro-energy liquid-gas cell or cell stack, wherein the cell or cell stack is configured to keep separate a first gas in bulk form within the cell or cell stack, the gas pressure equalisation system comprising:
   a first pressure equalisation tank for at least partially containing a first liquid having a liquid first level and for partially containing the first gas in bulk form, the first gas positioned above the liquid first level; and
   a first gas conduit for transfer of the first gas in bulk form between the cell or cell stack and the first pressure equalisation tank.
1.8b. A gas pressure equalisation system for an electro-synthetic or electro-energy liquid-gas cell or cell stack, wherein the cell or cell stack is configured to keep separate a first gas in bulk form from a second gas in bulk form within the cell or cell stack, the gas pressure equalisation system comprising:
   a first pressure equalisation tank for at least partially containing a first liquid having a liquid first level and for partially containing the first gas in bulk form, the first gas positioned above the liquid first level; and
   a first gas conduit for transfer of the first gas in bulk form between the cell or cell stack and the first pressure equalisation tank.
1.9a. A method of operating a gas pressure equalisation system for an electro-synthetic or electro-energy liquid-gas cell or cell stack, the method comprising the steps of:
   operating the cell or cell stack to produce or consume a first gas, wherein the cell or cell stack is configured to keep separate the first gas in bulk form within the cell or cell stack; and
   the first gas flowing, in bulk form, into or out of a first pressure equalisation tank via a first gas conduit, the first pressure equalisation tank at least partially containing a first liquid having a liquid first level, the first gas positioned above the liquid first level.
1.9b. A method of operating a gas pressure equalisation system for an electro-synthetic or electro-energy liquid-gas cell or cell stack, the method comprising the steps of:
   operating the cell or cell stack to produce or consume a first gas and a second gas, wherein the cell or cell stack is configured to keep separate the first gas in bulk form from the second gas in bulk form within the cell or cell stack; and
   the first gas flowing, in bulk form, into or out of a first pressure equalisation tank via a first gas conduit, the first pressure equalisation tank at least partially containing a first liquid having a liquid first level, the first gas positioned above the liquid first level.
2. Any one or more of the preceding points, wherein a first pressure equalisation tank is positioned below the cell or cell stack.
3. Any one or more of the preceding points, wherein the cell or cell stack is configured to keep separate a first gas in bulk form from a second gas in bulk form within the cell or cell stack, and further including:
   a second pressure equalisation tank for at least partially containing a second liquid having a liquid second level and for partially containing the second gas in bulk form, the second gas positioned above the liquid second level; and
   a second gas conduit for transfer of the second gas in bulk form between the cell or cell stack and the second pressure equalisation tank.
4. Any one or more of the preceding points, wherein a second liquid is the same as a first liquid.
5. Any one or more of the preceding points, wherein a first pressure equalisation tank and a second pressure equalisation tank are positioned below the cell or cell stack.
6. Any one or more of the preceding points, further including:
   a connecting pipe for transfer of a first liquid or a second liquid between a first pressure equalisation tank and a second pressure equalisation tank.
7. Any one or more of the preceding points, wherein a connecting pipe is positioned below a liquid first level and a liquid second level.
8. Any one or more of the preceding points, wherein a connecting pipe is positioned at or near a bottom of a first pressure equalisation tank and at or near a bottom of a second pressure equalisation tank.
9. Any one or more of the preceding points, wherein a connecting pipe is wholly liquid-filled during operation.
10. Any one or more of the preceding points, wherein a first gas is partially held in a first headspace above a liquid first level of a first liquid in a first pressure equalisation tank.
11. Any one or more of the preceding points, wherein a first gas conduit is positioned above a liquid first level.
12. Any one or more of the preceding points, wherein a first gas conduit is positioned at a first headspace.
13. Any one or more of the preceding points, wherein a first gas conduit is positioned at a top of a first pressure equalisation tank.
14. Any one or more of the preceding points, further including a first exit/entry gas port for transfer of a first gas out of or into a first pressure equalisation tank, a first exit/entry gas port positioned above a liquid first level.
15. Any one or more of the preceding points, further including a first valve connected to a first exit/entry gas port.
16. Any one or more of the preceding points, wherein a second gas is partially held in a second headspace above a liquid second level of a second liquid in a second pressure equalisation tank.
17. Any one or more of the preceding points, wherein a second gas conduit is positioned above a liquid second level.
18. Any one or more of the preceding points, wherein a second gas conduit is positioned at a second headspace.
19. Any one or more of the preceding points, wherein a second gas conduit is positioned at a top of a second pressure equalisation tank.
20. Any one or more of the preceding points, further including a second exit/entry gas port for transfer of a second gas out of or into a second pressure equalisation tank, a second exit/entry gas port positioned above a liquid second level.
21. Any one or more of the preceding points, further including a second valve connected to a second exit/entry gas port.
22. Any one or more of the preceding points, wherein the cell or cell stack is configured to produce or consume a first gas or a second gas.
23. Any one or more of the preceding points, wherein a first pressure equalisation tank is partially filled with a first liquid.
24. Any one or more of the preceding points, wherein a second pressure equalisation tank is partially filled with a second liquid.
25. Any one or more of the preceding points, further including one or more Programmable Logic Controllers for operating a first valve.
26. Any one or more of the preceding points, wherein a pressure vessel surrounds the cell or cell stack.
27. Any one or more of the preceding points, wherein a pressure vessel includes an annular gas.
28. Any one or more of the preceding points, wherein an annular gas is passed through a space between the cell or cell stack and one or more walls of a pressure vessel.
29. Any one or more of the preceding points, wherein an annular gas exits a pressure vessel and the exiting annular gas is monitored to detect a presence of one or more contaminant gases.
30. Any one or more of the preceding points, wherein a pressure vessel includes an annular liquid.
31. Any one or more of the preceding points, wherein a liquid outlet pipe of the cell or cell stack is connected to a liquid circulation tank and a liquid is drawn out of the cell or cell stack via a liquid outlet pipe by an ejector or a pump.
32. Any one or more of the preceding points, wherein a liquid drawn out of the cell or cell stack is a liquid electrolyte or a cooling liquid.
33. Any one or more of the preceding points, wherein a liquid is pumped by a pump or an ejector from a liquid circulation tank back into the cell or cell stack via one or more pipes.
34. Any one or more of the preceding points, wherein a liquid circulation tank is positioned below the cell or cell stack.
35. Any one or more of the preceding points, wherein a liquid circulation tank includes a gas headspace.
36. Any one or more of the preceding points, including:
   operating the cell or cell stack to produce or consume a first gas and a second gas, wherein the cell or cell stack is configured to keep separate the first gas in bulk form from the second gas in bulk form within the cell or cell stack; and
   the first gas flowing, in bulk form, into or out of a first pressure equalisation tank via a first gas conduit, the first pressure equalisation tank at least partially containing a first liquid having a liquid first level, the first gas positioned above the liquid first level.
37. Any one or more of the preceding points, wherein a first liquid has a substantially constant density during operation.
38. Any one or more of the preceding points, wherein a first liquid is free of gas bubbles during operation.
39. Any one or more of the preceding points, wherein a first liquid does not enter the cell or cell stack during operation.
40. Any one or more of the preceding points, wherein a first liquid is the same as a liquid electrolyte of an electrochemical reaction occurring in the cell or cell stack.
41. Any one or more of the preceding points, wherein a pressure of a first liquid in a first pressure equalisation tank is substantially equalised with a pressure of the liquid electrolyte in the cell or cell stack.
42. Any one or more of the preceding points, wherein a first pressure equalisation tank is positioned below the cell or cell stack.
43. Any one or more of the preceding points, further including adjusting the pressure of a first gas in a first pressure equalisation tank to maintain a liquid first level at a height.
44. Any one or more of the preceding points, further comprising the step of:
   a second gas flowing, in bulk form, into or out of a second pressure equalisation tank via a second gas conduit, the second pressure equalisation tank at least partially containing a second liquid having a liquid second level, the second gas positioned above the liquid second level.
45. Any one or more of the preceding points, wherein a second liquid is the same as a first liquid.
46. Any one or more of the preceding points, wherein a second pressure equalisation tank is positioned below the cell or cell stack.
47. Any one or more of the preceding points, wherein a connecting pipe is attached between a first pressure equalisation tank and a second pressure equalisation tank, and further comprising the step of:
   a first liquid or a second liquid flowing between the first pressure equalisation tank and the second pressure equalisation tank via the connecting pipe when a pressure of the first gas in the first pressure equalisation tank is different to a pressure of the second gas in the second pressure equalisation tank.
48. Any one or more of the preceding points, wherein a connecting pipe is positioned below a liquid first level and a liquid second level during operation.
49. Any one or more of the preceding points, further comprising the steps of:
   operating the electro-synthetic or electro-energy liquid-gas cell or cell stack to produce or consume a first gas or a second gas, wherein the first gas and the second gas are each in bulk form; and,
   if a pressure of the first gas exceeds a pressure of the second gas:
      allowing a first liquid to flow out of a first pressure equalisation tank and into a second pressure equalisation tank via a connecting pipe;
   allowing a liquid first level in the first pressure equalisation tank to decline, thereby decreasing the pressure of the first gas;
   allowing a liquid second level in the second pressure equalisation tank to rise, thereby increasing the pressure of the second gas; and,
   allowing the first liquid to flow until the pressure of the first gas and the pressure of the second gas are equal, after when the first liquid ceases to flow.
50. Any one or more of the preceding points, further comprising the steps of:
   operating the electro-synthetic or electro-energy liquid-gas cell or cell stack to produce or consume a first gas or a second gas, wherein the first gas and the second gas are each in bulk form; and,
   if a pressure of the second gas exceeds a pressure of the first gas:
      allowing a second liquid to flow out of a second pressure equalisation tank and into a first pressure equalisation tank via a connecting pipe;
      allowing a liquid second level in the second pressure equalisation tank to decline, thereby decreasing the pressure of the second gas;
      allowing a liquid first level in the first pressure equalisation tank to rise, thereby increasing the pressure of the first gas; and,
allowing the second liquid to flow until the pressure of the second gas and the pressure of the first gas are equal, after when the second liquid ceases to flow.

51. Any one or more of the preceding points, wherein a first liquid or a second liquid flows spontaneously depending on any pressure difference between the pressure of a first gas in a first pressure equalisation tank and the pressure of a second gas in a second pressure equalisation tank.
52. Any one or more of the preceding points, further including adjusting the pressure of a first gas in a first pressure equalisation tank and/or adjusting the pressure of a second gas in a second pressure equalisation tank to maintain a liquid first level and a liquid second level at an equal height.
53. Any one or more of the preceding points, further including a first exit/entry gas port for transfer of a first gas out of or into a first pressure equalisation tank, the first exit/entry gas port positioned above a liquid first level, further including a first valve connected to the first exit/entry gas port, and operating the first valve to adjust the pressure of the first gas in the first pressure equalisation tank to change a height of the liquid first level.
54. Any one or more of the preceding points, further including automatically operating a first valve using one or more Programmable Logic Controllers.
55. Any one or more of the preceding points, further including a second exit/entry gas port for transfer of a second gas out of or into a second pressure equalisation tank, the second exit/entry gas port positioned above a liquid second level, further including a second valve connected to the second exit/entry gas port, and operating the second valve to adjust the pressure of the second gas in the second pressure equalisation tank to change a height of the liquid second level.
56. Any one or more of the preceding points, further including automatically operating a second valve using one or more Programmable Logic Controllers.
57. Any one or more of the preceding points, further including the one or more Programmable Logic Controllers monitoring the height of a liquid first level and/or the height of a liquid second level using one or more sensors.
58. Any one or more of the preceding points, further including maintaining the pressure of a first gas and the pressure of a second gas at a fixed differential pressure by maintaining a liquid first level and a liquid second level at a fixed difference in height.
59. Any one or more of the preceding points, wherein a first gas is sparingly soluble in a first liquid.
60. Any one or more of the preceding points, wherein a volume of a first liquid in a first pressure equalisation tank is larger than a volume of a first gas in the cell or cell stack and a first headspace of the first pressure equalisation tank and a first gas conduit.
61. Any one or more of the preceding points, wherein a volume of a second liquid in a second pressure equalisation tank is larger than a volume of a second gas in the cell or cell stack and a second headspace of the second pressure equalisation tank and a second gas conduit.
62. Any one or more of the preceding points, wherein the cell or cell stack is an electro-synthetic liquid-gas water electrolyzer, and a first gas is oxygen and a second gas is hydrogen.

Throughout this specification and the claims that follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

Optional embodiments may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although preferred embodiments have been described in detail, it should be understood that many modifications, changes, substitutions or alterations will be apparent to those skilled in the art without departing from the scope of the present invention.

1. A gas pressure equalisation system for an electro-synthetic or electro-energy liquid-gas cell or cell stack, wherein the cell or cell stack is configured to keep separate a first gas in bulk form within the cell or cell stack, the gas pressure equalisation system comprising:
a first pressure equalisation tank for at least partially containing a first liquid having a liquid first level and for partially containing the first gas in bulk form, the first gas positioned above the liquid first level; and
a first gas conduit for transfer of the first gas in bulk form between the cell or cell stack and the first pressure equalisation tank.

2. The gas pressure equalisation system of claim 1, wherein the first pressure equalisation tank is positioned below the cell or cell stack.

3. The gas pressure equalisation system of claim 1, wherein the cell or cell stack is configured to keep separate the first gas in bulk form from a second gas in bulk form within the cell or cell stack, and further comprising:
a second pressure equalisation tank for at least partially containing a second liquid having a liquid second level and for partially containing the second gas in bulk form, the second gas positioned above the liquid second level; and
a second gas conduit for transfer of the second gas in bulk form between the cell or cell stack and the second pressure equalisation tank.

4. The gas pressure equalisation system of claim 3, wherein the second liquid is the same as the first liquid.

5. The gas pressure equalisation system of claim 3, wherein the first pressure equalisation tank and the second pressure equalisation tank are positioned below the cell or cell stack.

6. The gas pressure equalisation system of claim 4, further comprising:
a connecting pipe for transfer of the first liquid or the second liquid between the first pressure equalisation tank and the second pressure equalisation tank.

7. The gas pressure equalisation system of claim 6, wherein the connecting pipe is positioned below the liquid first level and the liquid second level.

8. (canceled)

9. (canceled)

10. The gas pressure equalisation system of claim 1, wherein the first gas is partially held in a first headspace above the liquid first level of the first liquid in the first pressure equalisation tank.

11-15. (canceled)

16. The gas pressure equalisation system of claim 3, wherein the second gas is partially held in a second headspace above the liquid second level of the second liquid in the second pressure equalisation tank.

17-21. (canceled)

22. The gas pressure equalisation system of claim 1, wherein the cell or cell stack is configured to produce or consume the first gas.

23-25. (canceled)

26. The gas pressure equalisation system of claim 1, wherein a pressure vessel surrounds the cell or cell stack.

27. The gas pressure equalisation system of claim 26, wherein the pressure vessel includes an annular gas.

28. (canceled)

29. The gas pressure equalisation system of claim 27, wherein the annular gas exits the pressure vessel and the exiting annular gas is monitored to detect a presence of one or more contaminant gases.

30. The gas pressure equalisation system of claim 26, wherein the pressure vessel includes an annular liquid.

31. The gas pressure equalisation system of claim 1, wherein a liquid outlet pipe of the cell or cell stack is connected to a liquid circulation tank and a liquid is drawn out of the cell or cell stack via the liquid outlet pipe by an ejector or a pump.

32-35. (canceled)

36. A method of operating a gas pressure equalisation system for an electro-synthetic or electro-energy liquid-gas cell or cell stack, the method comprising:
operating the cell or cell stack to produce or consume a first gas, wherein the cell or cell stack is configured to keep separate the first gas in bulk form within the cell or cell stack; and
the first gas flowing, in bulk form, into or out of a first pressure equalisation tank via a first gas conduit, the first pressure equalisation tank at least partially containing a first liquid having a liquid first level, the first gas positioned above the liquid first level.

37. The method of claim 36, wherein the first liquid has a substantially constant density during operation.

38. The method of claim 36, wherein the first liquid is free of gas bubbles during operation.

39. The method of claim 36, wherein the first liquid does not enter the cell or cell stack during operation.

40-48. (canceled)

49. A method of operating the gas pressure equalisation system of claim 6, the method comprising:
operating the electro-synthetic or electro-energy liquid-gas cell or cell stack to produce or consume the first gas or the second gas, wherein the first gas and the second gas are each in bulk form; and,
if a pressure of the first gas exceeds a pressure of the second gas:
allowing the first liquid to flow out of the first pressure equalisation tank and into the second pressure equalisation tank via the connecting pipe;
allowing the liquid first level in the first pressure equalisation tank to decline, thereby decreasing the pressure of the first gas;
allowing the liquid second level in the second pressure equalisation tank to rise, thereby increasing the pressure of the second gas; and,
allowing the first liquid to flow until the pressure of the first gas and the pressure of the second gas are equal, after when the first liquid ceases to flow.

50-62. (canceled)
